(19) United States
(12) Patent Application Publication
(10) Pub. No.: US 2025/0005594 A1
(43) Pub. Date: Jan. 2, 2025

(54) Systems, Methods, and Media for Automatic Facility Compliance Document Generation

(71) Applicant: Direct Supply, Inc., Milwaukee, WI (US)

(72) Inventors: Suzanne Lieven, Cedarburg, WI (US); Charles W. Fastner, Pewaukee, WI (US); Eric Arndt, Milwaukee, WI (US); Sarthak Dabas, Jr., Milwaukee, WI (US)

(21) Appl. No.: 18/217,283

(22) Filed: Jun. 30, 2023

(51) Int. Cl. G06Q 30/018; G06Q 10/0631; G06Q 10/0639; G06Q 10/067; G06Q 10/20

(52) U.S. Cl. CPC G06Q 30/018; G06Q 10/063114; G06Q 10/06393; G06Q 10/06395; G06Q 10/067; G06Q 10/20

(57) ABSTRACT

Systems, methods, and media for providing compliance functionality for facilities such as senior living facilities. The systems, methods, and media can securely aggregate data from multiple separate sources and process the data to automatically identify compliance gaps for a facility, generate tasks and recommendation to address the compliance gaps, and automatically generate compliance documentation in different formats for the facility. The systems, methods, and media can simplify the complex and changing regulatory procedures in place for facilities and make compliance easier not only for facilities, but also for inspecting entities such as surveyors.

### BACKGROUND

Operators of different facilities, such as healthcare facilities and senior living facilities, often operate multiple facilities over a large geographic area. Performing maintenance and repair of assets at each facility is often delegated to a maintenance director or other local employee that can be on site at the facility. However, a maintenance director may not be able to perform all of the service tasks that are needed and can be responsible for hiring contractors to perform at least some services. In a senior living setting, or other setting in which health and safety are of paramount importance, properly maintaining facilities is an important task, which can result in lost revenue, fines, and other adverse consequences if not facilities are not adequately maintained.

Moreover, compliance with various regulations and safety inspections that are required of certain facilities becomes a highly difficult task as the network of managed facilities grows across a large geographic area. Facility maintenance teams often struggle to maintain compliance with various complex and changing requirements, while also trying to balance providing quality service to residents and other personnel associated with different facilities. Thus, facility maintenance can become a costly endeavor, especially when an operator operating many facilities does not have efficient systems and methods for controlling costs and ensuring safe and compliant facility operations. Accordingly, new systems, methods, and media that can provide improved efficiencies in terms of facility management and operational compliance are desirable.

### BRIEF DESCRIPTION OF THE DRAWINGS

FIG. 1 shows an example of a geographically distributed network of facilities at which a service is managed by an operator, in accordance with some aspects of the disclosure.

FIG. 2A shows a block diagram illustrating an example system for automatically generating compliance documentation for facilities associated with various operators and property owners, in accordance with some aspects of the disclosure.

FIG. 2B shows another block diagram illustrating additional components of the system for automatically generating compliance documentation for facilities associated with various operators and property owners of FIG. 2A, in accordance with some aspects of the disclosure.

FIG. 2C shows another block diagram illustrating further components of the system for automatically generating compliance documentation for facilities associated with various operators and property owners of FIG. 2A, in accordance with some aspects of the disclosure.

FIG. 3 shows a block diagram illustrating another example system for automatically generating compliance documentation for facilities associated with various operators and property owners, in accordance with some aspects of the disclosure.

FIG. 4 shows a block diagram illustrating example hardware that can be used to implement the system of FIG. 3, in accordance with some aspects of the disclosure.

FIG. 5 shows a flow diagram illustrating an example process for evaluating compliance of a facility, in accordance with some aspects of the disclosure.

FIG. 6 shows a flow diagram illustrating an example process for generating a simulated (mock) survey report for a facility, in accordance with some aspects of the disclosure.

FIG. 7 shows a flow diagram illustrating an example process for generating compliance documentation and assigning tasks to address compliance gaps, in accordance with some aspects of the disclosure.

FIG. 8 shows a flow diagram illustrating an example process for updating compliance documentation templates and compliance logic, in accordance with some aspects of the disclosure.

FIG. 9 shows a flow diagram illustrating an example process for generating an audit template used for a compliance audit, in accordance with some aspects of the disclosure.

FIG. 10 shows a flow diagram illustrating an example process for assigning tasks for performing to address compliance gaps, in accordance with some aspects of the disclosure.

FIG. 11 shows example user interfaces for submitting a work order via an electronic medical records (EMR) system, in accordance with some aspects of the disclosure.

FIG. 12 shows an example work order entry user interface that can be used by facility personnel to submit a work order, in accordance with some aspects of the disclosure.

FIG. 13 shows an example work order report that details work orders specific to life safety incidents for a facility, in accordance with some aspects of the disclosure.

FIG. 14 shows an example resident system user interface that can be used to submit maintenance requests via a resident engagement system, in accordance with some aspects of the disclosure.

FIG. 15 shows another example resident system user interface that can be used to submit maintenance requests via a resident engagement system, in accordance with some aspects of the disclosure.

FIG. 16 shows an example work order report that details work orders associated with maintenance requests submitted via a resident engagement system for a facility, in accordance with some aspects of the disclosure.

FIG. 17 shows an example work order that is created in accordance with an example nurse call device, in accordance with some aspects of the disclosure.

FIG. 18 shows an example work order report that details work orders associated with a nurse call system for a facility, in accordance with some aspects of the disclosure.

FIG. 19 shows an illustration of an example work history report associated with connected equipment for a facility, in accordance with some aspects of the disclosure.

FIG. 20 shows an example service request user interface for requesting maintenance and requesting quotes for maintenance service for a facility, in accordance with some aspects of the disclosure.

FIG. 21 shows an example planned maintenance user interface for managing testing, inspections, and maintenance for a facility, in accordance with some aspects of the disclosure.

FIG. 22 shows an example interactive reporting dashboard user interface for one or more facilities, in accordance with some aspects of the disclosure.

FIG. 23 shows an example administrative tools user interface that can be used by facility personnel to manage templates for compliance document generation, in accordance with some aspects of the disclosure.

FIG. 24 shows an example of a mock survey checklist user interface that can be used by facility personnel to gauge facility compliance, in accordance with some aspects of the disclosure.

FIG. 25 shows an example mock survey notes user interface that can be used by facility personnel to record various details about a facility for compliance purposes, in accordance with some aspects of the disclosure.

FIG. 26 shows an example mock survey work order user interface that can be used by facility personnel to manage work orders and/or service requests associated with a mock survey, in accordance with some aspects of the disclosure.

FIG. 27 shows an example task explanation user interface that can be used by facility personnel to complete tasks for a facility, in accordance with some aspects of the disclosure.

FIG. 28 shows an example best practice task explanation user interface that can be used by facility personnel to complete tasks for a facility, in accordance with some aspects of the disclosure.

FIG. 29 shows an example best practice task logging user interface that can be used by facility personnel to document the results of performing a best practice task, in accordance with some aspects of the disclosure.

FIG. 30 shows an example paper document that can be maintained for facility compliance purposes, in accordance with some aspects of the disclosure.

FIG. 31 shows an example task list user interface that can be used by facility personnel or surveyors to assess compliance gaps for a facility, in accordance with some aspects of the disclosure.

FIG. 32 shows an example citation report that details different citations issued by a regulatory entity, in accordance with some aspects of the disclosure.

FIG. 33 shows another example citation report that details a specific citation issued by a regulatory entity, in accordance with some aspects of the disclosure.

FIG. 34 shows an example best practice categories user interface that can be used by facility personnel to view best practices, in accordance with some aspects of the disclosure.

FIG. 35 shows another example best practice categories user interface that can be used by facility personnel to configure best practice categories, in accordance with some aspects of the disclosure.

FIG. 36 shows an example compliance documentation overview user interface that can be used by facility personnel to view and manage compliance documents, in accordance with some aspects of the disclosure.

FIG. 37 shows another example compliance documentation overview user interface that can be used by facility personnel to view and manage compliance documents, in accordance with some aspects of the disclosure.

FIG. 38 shows an example mega pull user interface that can be used by facility personnel to grab all documentation and other inputs related to compliance parameters specified by the user, in accordance with some aspects of the disclosure.

FIG. 39 shows an example severity matrix that can be used to determine the severity of compliance gaps for a facility or organization, in accordance with some aspects of the disclosure.

### DETAILED DESCRIPTION

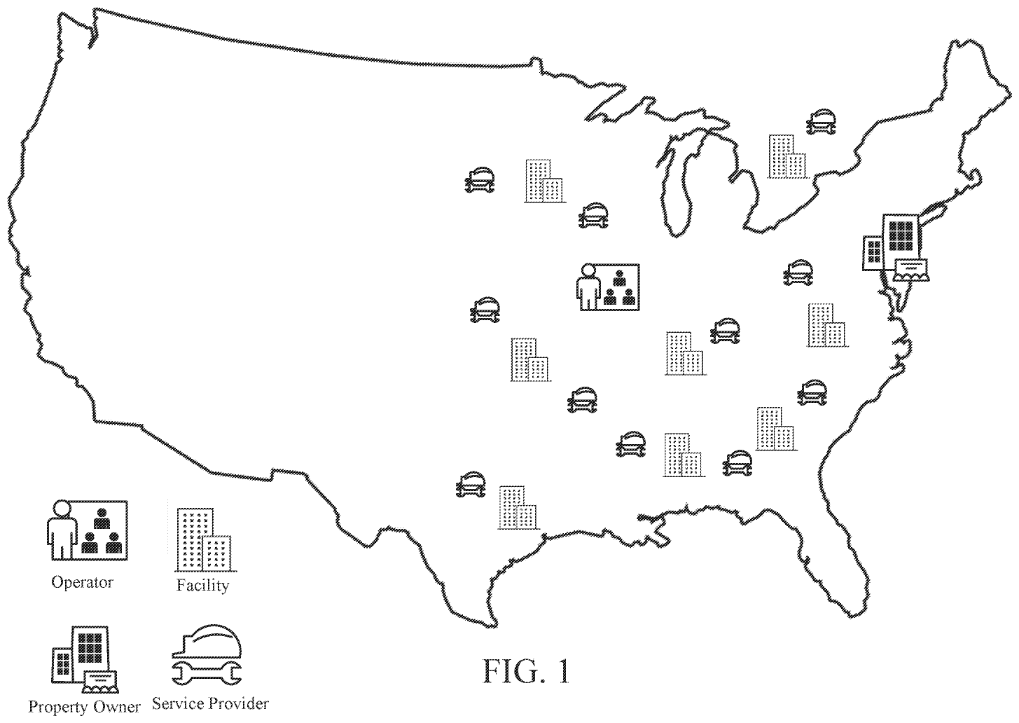

FIG. 1 shows an example of a geographically distributed network of facilities at which a service is managed by an operator. As shown in FIG. 1, an operator located in a particular geographic location can operate facilities in many different geographical locations. For example, the operator can provide access to living space (e.g., via leased units) and/or provide a service (e.g., assistance with various tasks, healthcare services, etc.) at the various facilities. In the context of senior living, an operator may operate many different facilities in different locations, and may provide multiple different types of services, sometimes within the same facility. The operator of the facilities may or may not own the property associated with the facilities. For example, one or more property owners may own the real property and/or structures associated with the facility, and may contract with an operator to operate a senior living facility providing one or more services at the property. The property owner may be any type of organization, such as a real estate investment trust (REIT) or other type of organization.

As part of a facility, the operator may be responsible for maintenance of facilities. The operator may hire one or more employees (sometimes referred to as a maintenance director) to supervise maintenance at a particular facility, or a group of closely located facilities. The maintenance director may be responsible for resolving requests for maintenance and/or repair to occupied units, ensuring that various assets, such as systems (e.g., heat, air conditioning, plumbing, electrical, etc.) are maintained in working order, and that other assets (e.g., carpet, doors, trim, countertops, appliances, etc.) are maintained in good repair. While a maintenance director may be capable of performing some maintenance, repair, and/or replacement, the maintenance director may need to hire outside contractors to perform certain tasks. Often, contractors operate in relatively small areas, and thus different facilities may not be able to use the same contractors. This can make it difficult for the operator to ensure that contractors that are retained are charging appropriately for services and performing satisfactorily.

Moreover, compliance with various inspection, testing, and documentation requirements (e.g., for compliance with the National Fire Protection Association (NFPA) 101 Life Safety Code, etc.) presents a difficult challenge for facility operators, including maintenance directors, that involves management of multiple different parties, paperwork, and changing regulations. Various survey processes are designed to identify gaps during building walk-throughs and documentation audits position surveyors to frequently grant citations in highly regulated facility spaces such as senior living facilities. The compliance documentation provided to the surveyor typically needs to be in a specified format that varies based on which agency the surveyor represents.

Senior living facilities, for example, may choose to maintain a life safety binder including paperwork that discloses proof that all required instances of inspections and testing have been completed on time and according to regulatory code. However, the manual tracking of compliance paperwork in a binder such as this can cause facility maintenance teams to struggle to maintain compliance with complex and changing regulatory requirements while also balancing serving the needs of senior living residents. Additionally, facility personnel may often be required to spend significant amounts of time and effort piecing together documentation one document at a time. Facility managers need systems that not only collect input and produce documentation needed for various different types of surveys and inspections, but they also need systems that can proactively identify compliance gaps and provide different types of proactive recommendations that can be followed by facility managers to improve the likelihood of compliance and reduce the risk of potential fines and other penalties. Moreover, facility managers need systems that can provide gains in terms of operational efficiency such that facility personnel can provide better overall care to facility residents while also achieving overall cost savings.

The systems, methods, and media described herein can provide single click functionality for performing a compliance audit and generating appropriate documentation in the correct format for various different types of surveys and inspections that may be required for a given facility. The format of the compliance documentation can be associated with a specific authority having jurisdiction (AHJ), for example. While most authorities having jurisdiction base their inspection, testing, and documentation requirements around common templates such as the NFPA 101 Life Safety Code standards, different authorities having jurisdiction may use different versions of the NFPA standards during surveying such that unique formatting requirements may be imposed. The compliance and audit functionality described herein can apply logic and risk scoring to provide a list of recommendations and/or tasks for completion to address different compliance gaps in prioritized order. The prioritization of tasks for completion can be based on several factors, including risk of citation, potential gains in efficiency, maintaining appropriate levels of care, and cost savings.

The systems, methods, and media described herein can further support integrations and act as a mechanism to collect specific data sets from different types of systems and compile the information to produce compliance documentation in the proper format for survey compliance for multiple regulating and accrediting bodies. For example, skilled nursing home facilities typically need to produce documentation in 2657 format to comply with the Centers for Medicare & Medicaid Services (CMS) Life Safety Code in order to qualify for Medicaid funding, and also need to create another set of documentation using Joint Commission standards and formatting to receive accreditation. Each regulating and accrediting body publishes complex requirements that are difficult to follow and often changing. Regulations are also so complex that organizations often see large variations in the interpretation of the code across different facilities, states, and surveyors. For example, one facility might receive a citation for a document that would be deemed compliant by a different surveyor. Adding to the complexity, surveyors typically are encouraged to issue a minimum number of citations over certain time periods, thereby making it even more difficult for facilities to maintain 100% compliance. Surveyors can pick and choose the areas of the code to be audited based on historical facility performance and personal preferences.

The systems, methods, and media described herein can further track citations that are published by regulating bodies to identify geographical and surveyor specific trends. Then, using these trends, tasks can be prioritized in areas of the code that are most at risk for audit. Moreover, mock surveys can be generated to perform test audits to not only gauge current compliance with documentation standards overall, but also gain insights into areas that are most likely to be reviewed by the surveyor. Additionally, recommendations can be provided regarding steps for addressing gaps in prioritized order, and aids can be provided throughout the process such as training, testing, and inspection resources as well as qualified technicians that can be automatically dispatched via interactions with a user interface.

The systems, methods, and media described herein can utilize various databases to analyze changes in code, data inputs, internal audit results, compliance measures, and instances where citations were granted to produce a feedback loop to continue to improve recommendation, compliance document formatting, and future survey results. The documentation pulls can be aligned with specific authority having jurisdiction preferences, thereby making it easy for the surveyor to gauge compliance of a facility such that citations can be minimized. Also, built-in logic for considering house factors when providing recommendations on addressing gaps identified in an audit can be provided. The prioritization of recommendations can include current staffing, time since the last survey, weather conditions, and costs to complete various tasks. For example, the system can recommend that a technician should be dispatched to address a compliance gap that is at high risk for citation with an approaching survey window and a lack of staff to complete an appropriate task internally. At the same time, the system can recommend that the internal maintenance team at a facility should complete another task internally to save cost. Meanwhile, the audit can draw immediate attention to a lack of emergency plans being in place a month before a facility enters a hurricane season by alerting the executive director to bring leadership teams together to conduct a tabletop exercise in preparation. Recommendations can be provided based on most current datasets, thereby optimizing the use of time, money, and resources.

In addition to collecting needed datasets, the systems, methods, and media described herein can further empower personnel such as administrators, regulators, regional power users, corporate power users, and others with oversight of maintenance and environmental services performance with quality inputs and required timelines. Weekly reports and real-time alerts can be generated to proactively identify at risk facility teams that need coaching with poor inputs or gaps in compliance documentation. While documentation pull can be created by inspection, testing, and document uploads into the system, the system can also provide functionality for supporting several integrations that automate inputs to make it easier for facilities to comply with requirements from different authorities having jurisdiction.

Accordingly, the systems, methods, and media described herein can provide significant time savings by eliminating several steps involved with creating records by pulling and organizing documentation in various formats. Integrations can be implemented to streamline the input process to improve response times, produce staff efficiencies, and drive compliance with faster corrective actions. Organizations can rely on this functionality to keep up with changing regulatory environments by receiving systematic alerts and training on updates to regulatory code. The ecosystem and applied logic used in the auditing functionality can position facilities with the best possible use of internal and external staff resources while also considering risk and potential costs associated with different decisions.

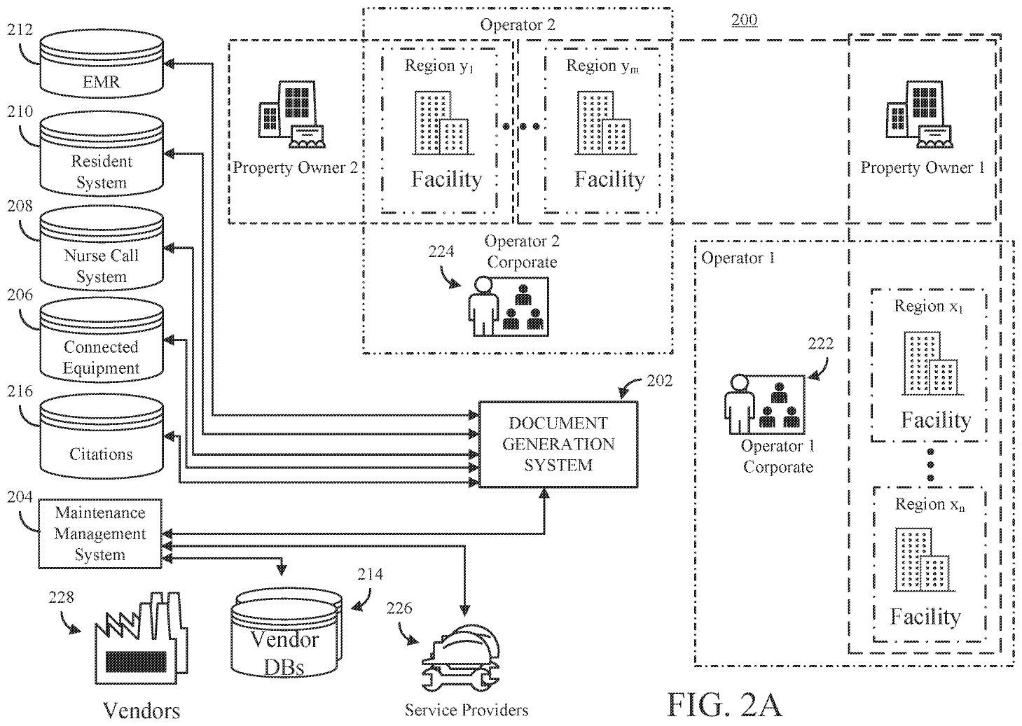

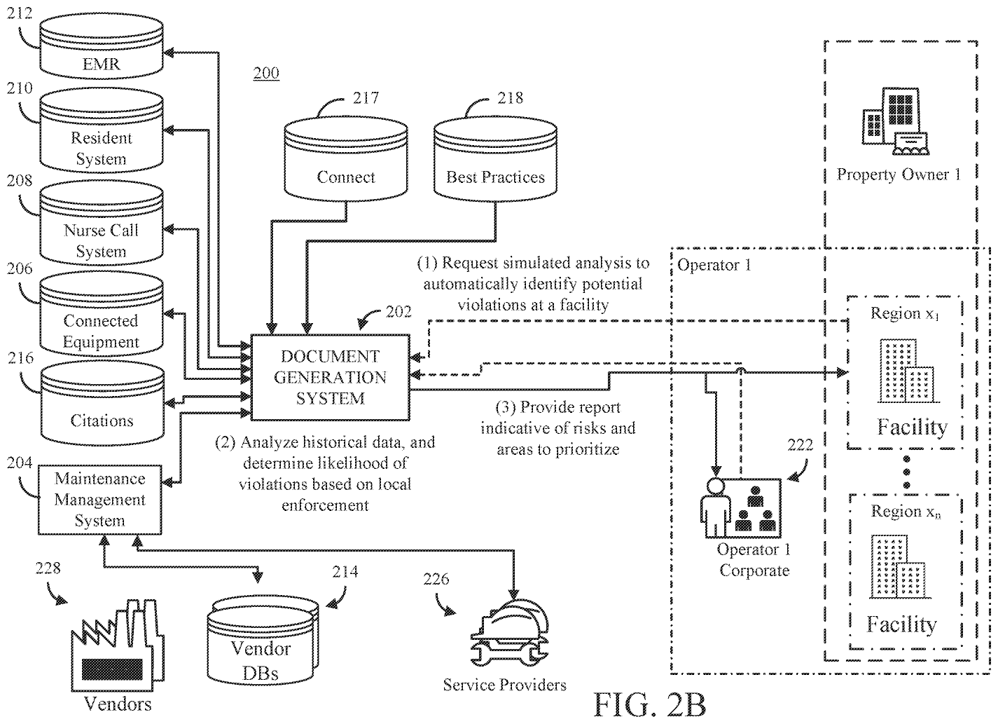

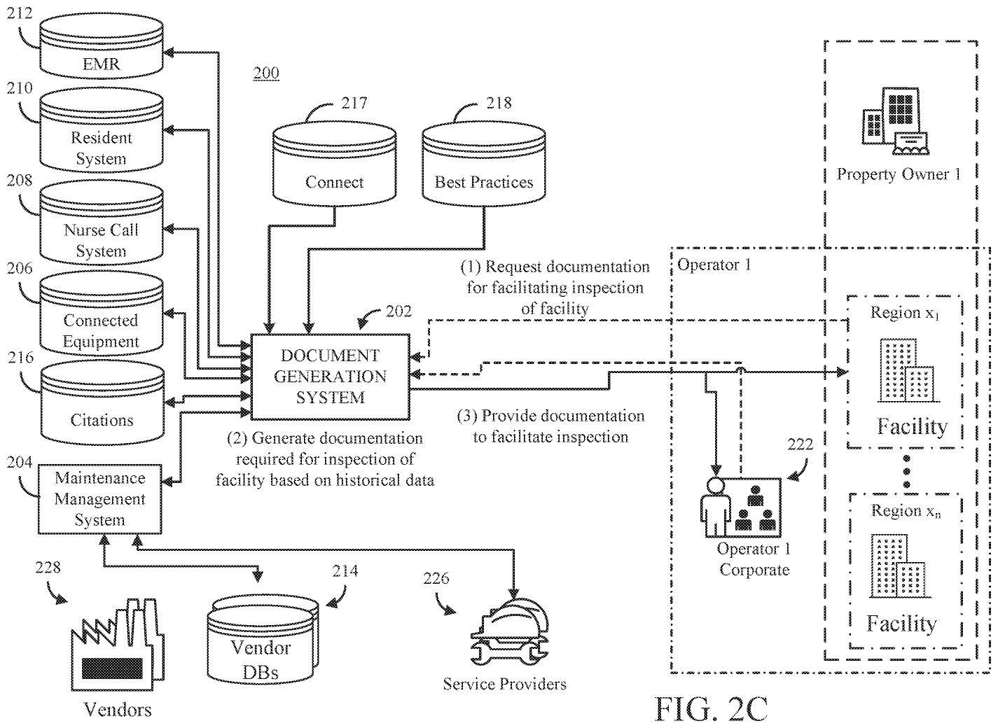

FIG. 2A shows a block diagram illustrating an example system 200 for automatically generating compliance documentation for facilities associated with various operators and property owners. As shown in FIG. 2A, a document generation system 202 can communicate with and/or maintain a collection of various databases, including a connected equipment database 206, a nurse call system database 208, a resident system database 210, an electronic medical record (EMR) system database 212, and a citations database 216. Moreover, the document generation system 202 can communicate with a maintenance management system 204 and one or more vendor databases 214. The maintenance management system 204 can be provided with the document generation system 202 (e.g., as part of the same platform service offering) or can be provided separate from the document generation system 202. The maintenance management system 204 can communicate with and/or maintain a maintenance database that stores work order data for one or more facilities. The maintenance management system 204 can generate, prioritize, and schedule work orders based at least in part on data received from other systems and databases. It will be appreciated that each of the databases described can be implemented in various ways, including using various different types and configurations of databases.

It is important to note that the maintenance management system 204, the connected equipment database 206, the nurse call system database 208, the resident system database 210, the EMR system database 212, and the one or more vendor databases 214 can all represent separate data sources that can be associated with different entities (e.g., managed by and/or maintained by different entities, etc.). For example, the connected equipment database 206 can be maintained by one or more vendors of facility equipment and also the nurse call system database 208 can be maintained by one or more vendors of nurse call devices used in a facility. Accordingly, the integration of all the different data from these separate sources presents a technical challenge for facility stakeholders to address. In many existing systems, this data is not integrated into a single system such as the document generation system 202. Instead, facility stakeholders are often required to piece together disparate information from each of these separate sources and attempt to efficiently evaluate all of the separate data sources with respect to changing and complex regulatory environments.

Advantageously, the document generation system 202 and/or the maintenance management system 204 can pull in data from all of these separate sources in order to efficiently drive facility compliance. The document generation system 202 and/or the maintenance management system 204 can securely achieve this data integration through the use of separate application programming interfaces (APIs) for each separate data source. This may also be accomplished with periodic or scheduled file or data transfers using various protocols over a network. Also, it should be noted that one or more of the separate data sources can be combined and/or can be managed by the same entity, such that each of the data sources described with respect to the system 200 are not necessarily separate. In addition, data may be received from various sources through other methods. For example, documents may be manually uploaded by a user (e.g., scanning physical documents) or gathered from public sources, such as the Internet, using data scraping techniques that can then be similarly ingested using optical character recognition (OCR) techniques and stored in a database. Many different methods may be used, especially when gathering data from various sources using different types of systems. As an example, local and state level AHJs may not have open reporting systems and simply publish the documents online.

The maintenance management system 204 can maintain asset history data associated with various facilities, such as assets associated with a first operator 222 (e.g., operator 1), and/or a second operator 224 (e.g., operator 2). The maintenance management system 204 can include information about any suitable type of asset, such as assets that can be associated with a unit, such as walls, ceiling, trim, paint (e.g., wall paint), doors, windows, window treatments, floors, carpets, plumbing, electrical wiring, electrical outlets, a heating system, a cooling system, other heating, ventilation, and air conditioning (HVAC) equipment, detectors (e.g., smoke detectors, carbon monoxide detectors, etc.), fire extinguishers, appliances, cabinets, counter tops, sinks, toilets, shower, bath tub, garbage disposal, furniture, etc. The maintenance management system 204 can maintain information organized using any suitable technique or combination of techniques, for example using a relational database or a non-relational database.

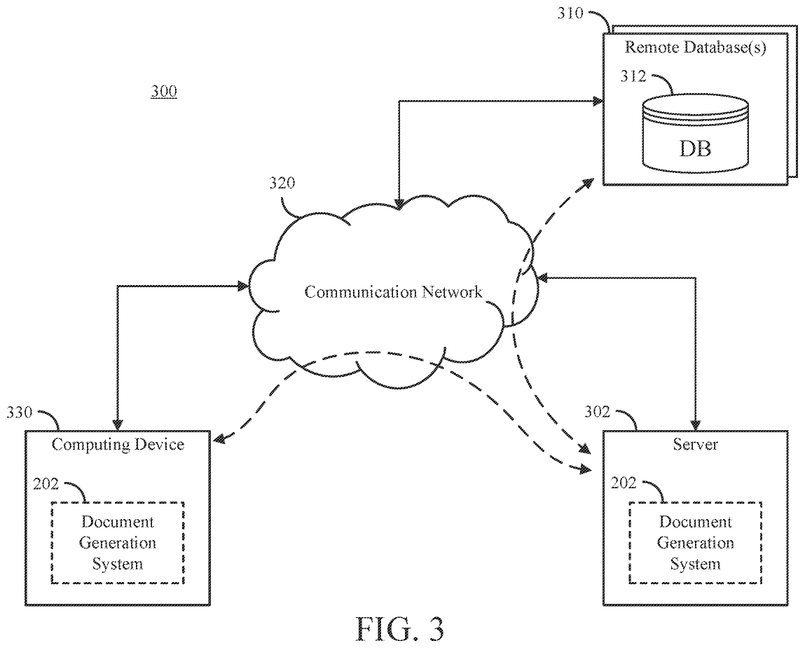

The maintenance management system 204 can receive identifying information associated with an asset, and can store the identifying information in connection with metadata related to the asset in one or more databases. For example, a mobile device (e.g., computing device 330 described below in connection with FIG. 3) can scan a symbol (e.g., a barcode, a QR code, etc.) encoded with identifying information (e.g., an alphanumeric code), and can transmit the identifying information to the maintenance management system 204. In such an example, the mobile device can transmit information about the asset (e.g., an asset type, a semantically meaningful name, a location of the object, an indication of when the asset was installed, etc.). The maintenance management system 204 can also store information about assets that have been installed at a facility, and metadata related to the asset. Additionally, the maintenance management system 204 can store information about repairs and/or other maintenance performed in connection with an asset. For example, the maintenance management system 204 can store identifying information associated with various assets, such as unique identifying information, semantically meaningful name, an identification number associated with a type of asset (e.g., types of assets can be associated with a unique alphanumeric code), model information, serial number, lot information, manufacturer, etc.

Moreover, the maintenance management system 204 can store identifying information associated with a location of an asset, such as an address, a facility name, a room number, an apartment number, a corridor number, a type of facility (e.g., assisted living, independent living, memory care, skilled nursing, acute care, hospitality, etc.), etc. As yet another example, the maintenance management system 204 can store information associated with installation, maintenance, and/or repair of an asset, such as an installation time, a time in service (e.g., a time since the asset was installed). As still another example, the maintenance management system 204 can store information about a condition of the asset at a particular time (e.g., documented by an employee, documented by a contractor, etc.). In a more particular example, the condition of the asset can be based on one or more objective criteria, such as “new” when the asset is first installed, and/or one or more subjective criteria (e.g., based on input from a user). As a further example, the maintenance management system 204 can store information associated with a resident of a room, such as whether one or more residents uses any mobility assistance devices (e.g., a wheelchair, a motorized wheelchair, etc.), an age of the resident, a number of residents, etc. As another further example, the maintenance management system 204 can store information indicative of attributes of an asset, such as color, size, voltage, gas type (e.g., natural gas, propane, etc.), etc.

When an asset is serviced (e.g., installed, repaired, or replaced, and/or when maintenance is performed), a computing device (e.g., a mobile device) can provide information associated with the service to the maintenance management system 204. Additionally, maintenance personnel at a facility can submit new work orders to the maintenance management system 204. Maintenance personnel can submit any data with a work order, such as contractor documents, images, etc. to complete a work order. Then, the maintenance management system 204 can maintain historical work order data for a facility, such as maintaining data associated with each work order submitted and/or completed at a facility including where the incident occurred, what action was taken to address the incident, time to resolve the incident, cost associated with resolving the incident, etc. The maintenance management system 204 can access vendor databases 214 to order products and/or assess the availability of products for ordering (e.g., products from vendors 228) as well as to schedule service and/or assess the availability of service (e.g., services provided by service providers 226). The maintenance management system 204 can also automatically schedule maintenance personnel and/or service providers to receive delivery of the order and/or perform service (e.g., installation) or other tasks associated with the ordered products and components after delivery. The maintenance management system 204 can cause a notification to be provided to the service provider (or maintenance personnel) indicating that one or more items associated with the service have been procured, and an indication of where, when, how, etc., to obtain the items for use in performing the service.

The maintenance management system 204 can use stored information to predict a useful life of a particular asset. For example, the maintenance management system 204 can determine an average useful life of a particular asset and/or type of asset based on a condition of similar assets over time in similar situations (e.g., in similar facilities, with residents having similar characteristics, etc.). The maintenance management system 204 can further include a purchasing system (or a separate purchasing system can be provided and integrated into the same platform as the maintenance management system 204 and the document generation system 202) for handling purchase orders for different products and components that may be required for maintenance and/or for addressing compliance gaps identifying by the document generation system 202.

The connected equipment database 206 can store a variety of different sensor data associated with equipment in a facility for real-time equipment management functionality (e.g., Internet of Things (IoT) sensor data). For example, the connected equipment database 206 can store live sensor data associated with HVAC equipment, refrigerators, water heaters, vital sign monitors, and other types of connected equipment in a facility. The sensor integration can be used to incorporate maintenance alerts and documentation of inspections for connected equipment. For example, the live sensor data can be used by the maintenance management system 204 to automatically generate work orders for maintenance personnel (e.g., when a sensor reading exceeds or falls below a certain threshold). The real time sensor data from the connected equipment database 206 not only helps maintenance personnel prioritize work for a facility, but it also helps the document generation system 202 generate appropriate documentation that may be required for equipment inspection and/or testing to meet certain requirements and regulations. The connected equipment database 206, using the real time sensor data, can accordingly facilitate the addressing of potential issues before they happen.

The document generation system 202 can leverage data from the various data sources shown as part of system 200, as well as additional data sources, to provide single click functionality for performing a compliance audit and generating appropriate documentation in the correct format for various different types of surveys and inspections that may be required for a given facility. The format of the compliance documentation generated by the document generation system 202 can be associated with a specific authority having jurisdiction. The document generation system 202 can apply logic and risk scoring to provide a list of recommendations and/or tasks for completion to address different identified compliance gaps in prioritized order. The document generation system 202 can prioritize tasks for completion based on several factors, including risk of citation, potential gains in efficiency, maintaining appropriate levels of care, and cost savings. The document generation system 202 can also perform additional functionality as described throughout the disclosure.

The connected equipment database 206 can be used to suggest changes to preventative maintenance schedules in order to extend the life of equipment and avoid failures. As more and more sensor data accumulates in the connected equipment database 206, the connected equipment database 206 can be used to drive even more powerful analysis and predictions. The data in the connected equipment database 206 can drive efficiencies with maintenance teams in identifying the most effective preventative maintenance schedules and recommendations for replacements. When sensors generate alerts, they can push data to the connected equipment database 206 and work records can be created. The data can include the specific system, the alert, the location, the data, appropriate levels for the sensor data, current levels of the sensor data, and cause of the alert. Various compliance documentation including for a Joint Commission survey, a CMS Life Safety survey, and Requirements of Participation can include testing records that show how various parameters associated with connected equipment are being monitored at a facility. For example, the connected equipment database 206 can be used to monitor water temperatures to prevent scolding, air temperatures to prevent food from spoiling, and air quality as part of infection prevention and control.

The nurse call system database 208 can store a variety of different data associated with nurse call devices installed in a facility, such as a senior living facility. The nurse call devices can include, for example, pendants, pull cord stations, call cord stations, universal transmitters, smoke detectors, temperature detectors, humidity detectors, water bugs, keypads, and fall pads, among other types of nurse call devices. The data from nurse call system database 208 can be used to provide a wireless system with a rules engine for alerting and reporting. For example, alerts and reports can be generated based on low battery signals, tamper detection signals, missing devices (e.g., left 900 MHz zone), threshold violations, abnormal frequency fluctuations patterns (e.g., any unusual frequency deviations in any machine, machines have certain defined frequencies within certain ranges, similar to how the human body has heartbeat, and any unusual deviation from the natural rhythm/frequency can indicate that there is a problem in the system/machine somewhere that needs assessment/repair), and other types of alerts and reports. The data from the nurse call system database 208 can be used by the maintenance management system 204 to automatically generate work orders in response to alerts such that maintenance personnel for a facility addresses the alerts as soon as possible. This functionality can help ensure that the proper messages get to the proper maintenance teams that may spend most of their time interacting with the maintenance management system 204 to manage work order queues as opposed to interacting with a nurse call system. The work orders and various data associated with the completion of the work orders can be maintained by the document generation system 202 and/or the maintenance management system 204. The data of work orders associated with a request can be used by the document generation system 202 for preparing documentation for compliance inspection purposes.

Accordingly, the integration of the data from the nurse call system database 208 into the document generation system 202 and/or the maintenance management system 204 can provide convenience to maintenance teams that would typically be required to access a separate nurse call system to address alerts, run reports, identify errors, and proceed to take appropriate action (e.g., in resident rooms that require attention). The integration of the nurse call system database 208 thereby eliminates several steps in this process and allows maintenance teams to receive alerts from nurse call devices automatically without having to pull reports from another system. As a result, the nurse call alerts can be added to the maintenance team's everyday workflow for managing work orders and non-scheduled tasks, thereby allowing for more efficient maintenance operations where issues are properly prioritized based on urgency and location within the facility. Additionally, the integration of the data from the nurse call system database 208 provides a mechanism for managing nurse call devices reactively as opposed to forcing a set schedule to replace components such as batteries. Instead of replacing all nurse call device batteries every six months, for example, the integration of the data from the nurse call system database 208 can allow maintenance teams to save time and money by only replacing batteries when failures occur or before they are predicted to occur.

Moreover, the integration of the data from the nurse call system database 208 can drive maintenance teams to replace components more quickly and, in cases where replacement components are needed, maintenance teams can simply click a button within the document generation system 202 and/or the maintenance management system 204 immediately initiate an order (and document the order) for the parts instead of having to contact one or more vendors and spend significant time and effort to place one or more orders for the replacement components. Certain compliance inspections can require preparation and review of documents specific to the inspection of nurse call system devices in a facility. For example, the CMS Requirements of Participation currently include rules related to nurse call system inspection as part of F-Tag 919. Integration of the data from the nurse call system database 208 can allow the document generation system 202 to automatically create documentation showing inspections and testing performed at a facility such that maintenance teams can save significant time and effort on logging details every month. The integration of the data from the nurse call system database 208 can also add a level of accountability to the management of the nurse call system alerts and the responsiveness of the maintenance team to addressing the nurse call system alerts.

The resident system database 210 can store a variety of data associated with maintenance requests submitted by residents and/or by family members of residents. For example, at a senior living facility, a family member (e.g., a child of an elderly person) can submit a maintenance request (e.g., for the air conditioning, television, etc.) for a resident of the senior living facility, and the maintenance request can be stored in the resident system database 210. Maintenance requests can be submitted by residents and/or by family members of residents through a mobile application, through a web application, or through various devices/systems in the resident's unit, for example. The resident system associated with the resident system database 210 can provide residents with integrated in-unit technology to provide self-service capabilities. For example, the resident system can allow residents to view community calendars (e.g., social events, meals, etc.), view food menus, view activities, view special events, etc.). The resident system can also provide family members of residents with better efficiency by assuring family members that services will be completed for residents based on interactions with the resident system without requiring the family members to call the facility. The resident system can provide updates via a resident portal interface such that residents and family members can get status updates and see when requests (and/or associated work orders) have been completed.

Additionally, the resident system can provide improved efficiency for maintenance teams because several steps (e.g., communication with an intermediary) can be eliminated from various maintenance processes to address resident concerns. The maintenance teams can gain immediate visibility into maintenance requests via notifications. Also, various data associated with the resident portal can be stored in the resident system database 210 such that it can be used by the document generation system 210 including the name of the resident, the date, the location where work is needed, and any other descriptive data associated with a maintenance request. Examples of maintenance requests that can be submitted and stored via the resident system database can include problems with nurse call devices, HVAC systems, door hazards, trip hazards, and television problems to name just a few examples. The integration of the data from the resident system database 210 can be used by the maintenance management system 204 to automatically generate work orders based on the requests for the maintenance team to complete, and various data associated with the completion of the work orders can be maintained by the document generation system 202 and/or the maintenance management system 204. Data for work orders associated with a request can be used by the document generation system 202 for preparing documentation for compliance inspection purposes.

The EMR system database 212 can be associated with an EMR platform and can store data associated with maintenance requests submitted by facility staff responsible for handling medical procedures associated with facility residents. The integration of the data from the EMR system database 212 can then be used by the maintenance management system 204 in order to automatically generate work orders for the maintenance team to complete, and various data associated with the completion of the work orders can be maintained by the document generation system 202 and/or the maintenance management system 204. The integration of the EMR system database 212 provides convenience for clinical teams that spend most of their time updating medical records within an EMR system and eliminates the need for them to transition to a different system to create a work order. Similarly, the integration of the EMR system database 212 provides improved efficiency for maintenance teams in that maintenance teams do not have to navigate to a separate system to evaluate potential maintenance issues associated with medical records but instead have immediate visibility into the work that is needed. Data can be pushed back to the EMR system database 212 such that clinical teams can assess the status of work orders and view progress.

The citations database 216 can store a variety of data associated with citations issued by various entities. The integration of citation data from the citations database 216 can allow the document generation system 202 and the maintenance management system 204 to provide recommendations and generate tasks based on identified compliance gaps that are at high risk of leading to a citation being issued to a given facility. The citations database 216 can store historical citation data (e.g., publicly available data) from different locations (e.g., different states, counties, countries, etc.) and from different entities (e.g., different surveyors, government agencies, etc.). The citations database 216 can be leveraged to analyze zones, locations, dates, citation comments, and other citation-related data to gauge probability of areas of surveyor focus. The citations database 216 can also be leveraged to indicate current surveyor interpretation of regulatory code and to make changes to logic, input requirements, recommendation, etc. for user interactions.

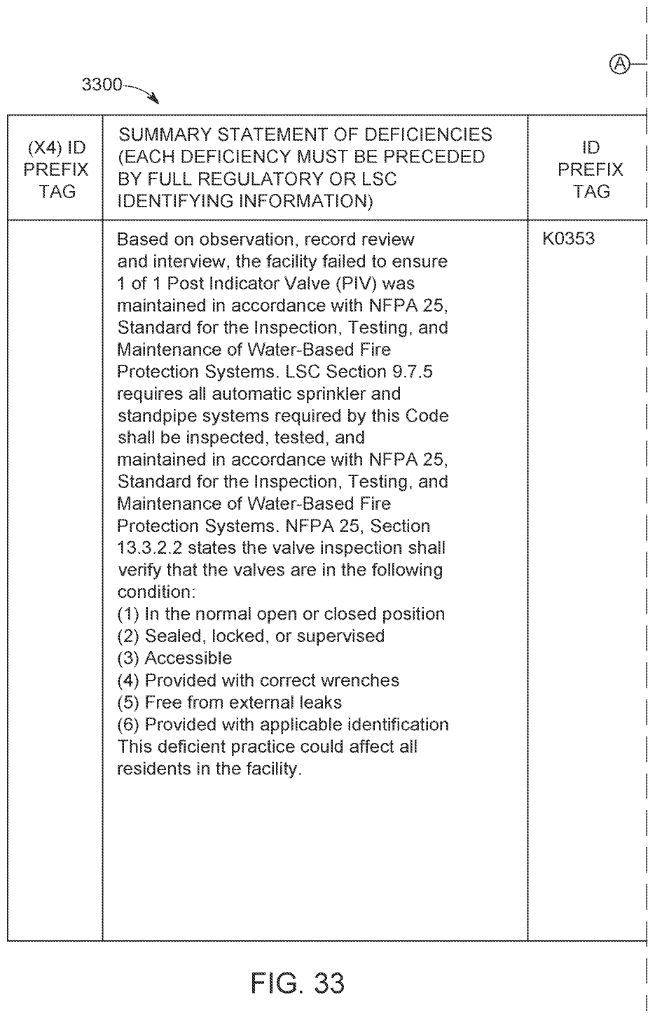

Various approaches to identifying citation trends can be implemented, such as using various types and combinations of machine learning and artificial intelligence models. The identified trends can be leveraged to highlight areas for review based on citations being issued in real time. In some cases, the data in the citations database 216 can be limited by the public release of citation data, such that there may be approximately a 3-month delay period. Alternatively, citation data can be manually entered by facility staff members and/or other personnel such that the citation data leveraged using the citations database 216 is more current. Manual entry of data into the citations database 216 may also provide further context to the citation data, such as various metadata including surveyor notes (e.g., as shown in FIG. 33) covering various details about each citation. This metadata may not be available when gathering data from public sources and other integrations. Manual entry of citation data may be accomplished by user input via a computing device into a form, or semi-automated entry of citation data recognized from a scanned citation document.

With interdepartmental communication being a significant challenge in terms of facility management, the integration of the EMR system database 212 can provide automation with real time updates that eliminates the need for in-person, email, and phone call updates regarding the status of work orders. The resulting gains in efficiency can improve the average time to address work requests and ultimately position clinical teams to provide better care to residents. When the clinical staff submits a request for maintenance, the EMR platform can capture a variety of data including the name of the requestor, the data, the location where the work is needed (e.g., building, area, room, etc.), and a description of the request (e.g., problem, equipment information, etc.). The EMR system in some examples can receive a severity/priority associated with the request and store this data in the EMR system database 212 as well. In some examples, the EMR system can also automatically determine the severity/priority associated with the request based on the request data and description. Then, the document generation system 202 and/or the maintenance management system 204 can maintain various data associated with the handling of the request, such as time to complete, work order closing date, cost associated with any parts needed, etc. Examples of requests that can be submitted through the EMR system and accessed via the integration with the EMR system database 212 can include problems with exit lights, operation of doors, fire extinguishers, detectors, blockage in hallways, etc. Certain inspections such as CMS requirements can focus heavily on these types of life safety and fire protection work records showing that problems identified were resolved properly and within a reasonable amount of time.

FIG. 2B shows another illustration of the example system 200 including data flow for requesting a simulated compliance analysis. Also shown in FIG. 2B are two additional data sources containing data that can be integrated with the document generation system 202 and/or the maintenance management system 204: a maintenance management database 217 and a best practices database 218. As shown, a request for a simulated analysis can be submitted by the first operator 222 for a facility located in a first region to the document generation system 202. Upon receiving the request for the simulated analysis (e.g., a simulated compliance inspection) from the first operator 222, the document generation system 202 can analyze historical data (e.g., from the various integrated sources described herein) to determine the likelihood of potential compliance violation based on local enforcement of regulations. Then, the document generation system 202 can provide a report indicative of risks and areas to prioritize to better comply with regulations back to the first operator 222. Further details regarding simulated analysis are described below.

The integration of the maintenance management database 217 can allow for the management of testing, inspection, maintenance, and repairs. In cases where compliance gaps are identified by the document generation system 202, maintenance teams can immediately dispatch a technician via a user interface (e.g., a user interface provided by a software platform including the document generation system 202 and/or the maintenance management system 204) to perform work to close the compliance gap and eliminate the compliance gap that is at risk for citation. The maintenance management database 217 can store various data associated with connecting facility needs and available capabilities within a service provider network (e.g., service providers 226) to streamline the process of reaching out to vendors (e.g., vendors 228) to provide services and/or products. The user interface can provide management functionality across all types of service events, thereby giving maintenance teams a single platform to request service, monitor inspections, and secure needed documentation (e.g., CMS-compliant compliance documentation of testing, inspection, maintenance, and repairs of equipment). Service records can be created within the maintenance management database 217 that detail various aspects of services performed for a facility.

Further, the maintenance management database 217 can store various data related to the managing, scheduling, and fulfillment of testing and maintenance inspections being performed by outside contractors. The maintenance management database 217 can store tasks on the facility work schedule that provide visibility into scheduled dates and completed work information including time to completion, equipment services (e.g., type of equipment, specific unit identifier), tests done, maintenance done, replacement part information, and other information. Additionally, all documentation related to the work done can be stored in the maintenance management database 217 and made visible within the task history, thereby eliminating the need for maintenance to track down and physically store documentation that may ultimately be needed for compliance inspection purposes.

The maintenance management database 217 can further store data related to different service dispatching recommendations that are generated and provided to facilities (e.g., by maintenance management system 204). The recommendations for service can be provided based on price, performance, rating, arrival times, and other possible factors. Recommendations can be vetted such that only the highest quality providers are recommended to facilities. Moreover, service providers (e.g., service providers 226) can access the maintenance management database 217 to view their own performance metrics in real time via live dashboards presented via a user interface. Repairs can differ from testing, inspection, and maintenance in that there can be different requirements for documenting any equipment failures and corrective actions taken to resolve equipment failures.

The maintenance management system 204 can use the data in the maintenance management database 217 to evaluate requests for service that are submitted by users to align the needs of the facility with the most qualified technician. The maintenance management system 204 can then allow the dispatcher and the technician to actively engage in the scheduling and routing of work, which can include the triggering of automated technician links. Upon receiving a request for service, the maintenance management system 204 can present an open event on a user interface and proceed to generate notifications that automatically alert facility teams with estimated time of arrival of the technician along with displaying the detailed updates as progress on the work is made. The real time notifications can keep maintenance teams informed throughout the process, including when work is completed, and invoicing is generated. As events change in the field, updates can be made visible via the user interface on a service request timeline.

The maintenance management system 204 can offer customizable not-to-exceed dollar amounts (NTEs) that allow companies to designate when approval is needed if service requests hit a certain threshold dollar amount. The maintenance management system 204 can send automated notifications to the maintenance team to inform them of the NTE allowing them to either approve or decline the service request. At the same time, the maintenance management system 204 can send notifications to regional approvers allowing them to stop the work and request a quote based on the circumstances of the work as it progresses, thereby providing additional controls around the service being performed. As service requests are initiated and completed, the maintenance management system 204 can automatically capture a detailed description of the work completed. The description can cover requirements that include a full list of assets with unique identifiers that were tested, as well as failures and corrective actions taken to address failures. Contractor inspections in some applications can contribute to 25% or more of the documentation required for various compliance inspections, and the data associated with contractor inspections and other outside services performed for a facility can be maintained in the maintenance management database 217. The data in the maintenance management database 217 can be provided to the document generation system 202 and/or the maintenance management system 204 for preparing documentation for compliance inspection purposes.

The integration of the best practices database 218 can allow facility staff to identify and check off best practice tasks as they are performing simulations (e.g., mock surveys), inspections, testing, and other miscellaneous tasks related to compliance. The best practices database 218 can store a variety of data associated with best practices for complying with various standards and regulations for different types of facilities and different locations. Once best practice tasks are completed by facility personnel, datasets can be stored in the best practices database 218 to help log work history records and meet compliance documentation requirements. The data stored in the best practices database 218 can include the name of the person or the names of the people that completed the work, the date the work was completed, pass/fail records, the location where the work was performed, and a detailed summary of the work that was done that is formatted to align with various specifications as defined by different regulations. The best practices database 218 can be used to maintain a best practices library including one or more tasks for each testing, inspection, and maintenance requirement associated with different compliance inspections such as CMS surveys and Joint Commission surveys.

The best practices database 218 can include knowledge built up from industry experts and state surveyors that can be used to create a library of life safety tasks and materials that can be tailored to different facility compliance standards. Tasks can be structured with the best practices database 218 to drive compliance with NFPA 101 standards, for example. Users can rely on the best practices database 218 to manage changing regulations and complex life safety code with expertise delivered in simplified explanations and checklists (e.g., from different entities such as the Joint Commission, CMS, the American Health Care Association (AHCA), the Occupational Safety and Health Administration (OSHA), etc.). As more and more facilities input data into the document generation system 202 and/or the maintenance management system 204, the data for a variety of facilities (e.g., tens of thousands of facilities) can be used such that best practices database 218 can provide more and more accurate recommendations regarding how long certain tasks should take, how tasks should be prioritized based on trends with citations, surveyors, risk, continuum of care, etc. The best practices database 218 can be used to track changes in public code as well as changes in citations and surveyor interpretation of code in order to modify the feedback loop for users and place higher priority and specific tasks and instructions that need adjustments.

The best practices database 218 can be leveraged to provide an interactive reporting dashboard user interface that provides regional and corporate oversight into facility performance on tasks and recommended training courses. The dashboard can highlight overdue and missed instances and weekly scorecards can be automatically sent (e.g., emailed) to supervisors, among other possible reporting functionality. The best practices can be presented in various forms to different users via user interfaces, such as a prioritized task list user interface presented to maintenance personnel to follow and enter designated inputs that can then be logged and used in the generation of compliance documentation. The user interface can also present instructions for explaining how to follow best practice tasks (e.g., including a video explanation, text explanation, etc.). The instructions can be tailored to the specific equipment and standards for a given facility. Moreover, the best practices database 218 can be leveraged to generate logbook documentation that can be included in compliance documentation. Additional best practice tasks can be added to the best practices database 218 and changes can be made to existing best practice tasks in the best practices database 218 responsive to changing regulations.

An example of a best practice task is the weekly exercise of a generator with no load, where routine checks on the generator should be performed and entries should be created in the best practices database 218 that comply with CMS K-Tag 918 and E-Tag 0041. The data logged in this example can include the make, model, serial number, and location or the generator, as well as generator readings specific to a start time, end time, main fuel level, dry tank fuel level, water temperature, radiator water level, battery water level, lubricating oil level, oil pressure, belts/hoses, and battery powered lighting. Another example of a best practice task is the weekly testing of the operation of doors, locks, gates, and alarms complying with CMS K-Tag 222. In this example, the data logged can include the date, location, a pass/fail record, and a corrective action taken in response to a failure. Yet another example of a best practice task is the annual inspection of fire doors in a facility. In this example, the best practice can include qualifying users to perform the annual inspection responsive to watching a training video. After completing the training video, a training certificate can be generated and included in the data logged for the task. The training certificate can include a date the training was completed and the name of the trained staff member. The best practice task may also provide for a digital signature entry (e.g., via a touch screen interface) or uploading of a signed document (e.g., captured with a camera integrated with a mobile computing device, such as a smartphone or tablet).

Still a further example of a best practice task is the monthly performance of a fire drill with an uploaded copy of a drill signature sheet that complies with CMS K-Tag 712. The data logged in this example can include a date, a start time, an end time, a location, a person that initiated the drill, participants of the drill, response time, details regarding a 911 follow-up call, resident headcount, staff headcount, visitor headcount, equipment functional statuses, visible audio device statuses, fire panel performance, fire/smoke damper performance, ventilation system shut down status, corrective actions, external weather conditions, remarks/comments provided by the person that initiated the drill, etc. In this example, users can upload signed sheets or provide digital signatures (e.g., via a touch screen interface) after completing the drill to meet requirements.

FIG. 2C shows yet another illustration of the example system 200 including data flow for requesting compliance documentation. As shown, a request for documentation for facilitating inspection of a facility (e.g., a compliance inspection) can be submitted by the first operator 222 to the document generation system 202. Then, the document generation system 202 can generate documentation (e.g., compliance documentation) that is required for inspection of the facility based on historical data from the various data sources described herein. Finally, the document generation system 202 can provide the generated compliance documentation back to the first operator 222 such that the first operator 222 can use the compliance documentation to facilitate the inspection of the facility.

The outputs generated by the document generation system 202 and/or the maintenance management system 204 based on the data retrieved from the various data sources including the connected equipment database 206, the nurse call system database 208, the resident system database 210, the EMR system database 212, the citations database 216, the maintenance management database 217, the best practices database 218, the one or more vendor databases 214, one or more databases maintained by the document generation system 202 and/or the maintenance management system 204 (including a purchasing system database), and/or other types of databases containing data generated by different systems can take various forms. For example, the outputs can include a mock (simulated) survey and associated report, automatic optimization of maintenance tasks and other types of tasks, automatic document generation (e.g., compliance documentation), citation data feedback, automatic generation of plans of correction, purchasing system actions, enhancement of quality input recognition functionality and document recognition functionality, reduction of insurance premiums, and other potential outputs such as described throughout the disclosure.

Users can perform mock survey exercises using the document generation system 202 and/or the maintenance management system 204 designed to mimic an actual compliance inspection (survey). The mock survey can be used to gauge the compliance with different standards (e.g., NFPA standards) and in turn address different areas at risk for citation. Users of a certain level (e.g., facility administrator or regional) can have access to such functionality allowing them to run an analysis or a report at any time, thereby providing an easy way to spot check performance with or without providing any notice to the maintenance team. The document generation system 202 can use a rules engine (e.g., compliance logic) including rules developed based on one or more standards to generate documentation in a format that draws attention to non-compliant sections. For example, a mock survey report can identify potential compliance gaps that could result in CMS citation tags (e.g., K-Tags) that need action, similar to a report card. The document generation system 202 can provide recommendations on how to address compliance gaps in prioritized order based on factors such as the risk of citation, cost, continuum of care, and other factors. The user can receive several prioritized options to address different conflicts including internal training and performance of inspection activities, quick replacement parts or products, and dispatching of technicians.

As facility personnel and/or the service providers 226 take action to address identified compliance gaps, the document generation system 202 can automatically document the actions to fill in compliance gaps and bring the facility closer to compliance. Different types of users (e.g., executive directors, regional users, corporate users, maintenance director, etc.) can subscribe to receive notifications on compliance gaps, including notifications indicating when gaps have been resolved, thereby enabling proactive monitoring of compliance activities. Different user interfaces provided by the document generation system 202, such as detailed below, can provide visibility into facility performance with respect to addressing compliance gaps and results of an actual compliance inspection. The user interfaces can include, for example, a dashboard that displays counts or percentages of the current identified unaddressed gaps or the identified unaddressed gaps over a specified time period.

The document generation system 202 can store historical recommendations and measure success over time based on actual citations received by the facility. Tasks can be prioritized and assigned based on a variety of different factors. For example, the document generation system 202 can use associated citation(s), survey windows, citation trends, surveyor trends, geographical trends, current staffing levels, staffing certifications, staffing expertise, effect on levels of care, potential for evacuation, preparedness, cost of using internal staff compares to external service providers, number of issues identified, ability to address issues simultaneously, corporate standards and approvals, effort to address compliance gaps, and/or other data and factors. The document generation system 202 can also generate purchase orders that can be placed with the vendors 228 to address identified compliance gaps. The maintenance management system 204 can offer customizable NTEs that allow companies to designate when approval is needed if a purchase order hits a certain threshold dollar amount. The maintenance management system 204 can send automated notifications to the maintenance team (or a separate designated approval user) to inform them of the NTE allowing them to either approve or decline the purchase.

The document generation system 202 can perform pattern recognition on various inputs provided by different users (e.g., inputs typed into tasks and logs by staff) to determine whether inputs fall inside or outside of an expected range. If an output falls outside of an expected range, the document generation system 202 can determine that staff might be “pencil whipping” or otherwise not performing tasks in an appropriate manner. The document generation system 202 can also look for repeat inputs that may have been copy and pasted and may not be accurate. Different users such as administrators, regional users, and corporate users can subscribe to notification such that they are notified when poor input quality is detected by the document generation system 202 so the issue can be addressed at the facility level to reduce the risk of compliance violations for the facility. Similarly, the document generation system 202 can perform quality recognition on physical documents that are uploaded to the document generation system 202 to identify incorrect or improper document uploads, flag unrecognizable documents, and recognize and pull key data from documents. The notification can include a report displaying the count or percentage of detected incorrect, improper, or unexpected inputs, and/or uploaded documents by user or facility. The report can also be displayed in a dashboard, for example.

Moreover, the document generation system 202 can be used to reduce insurance premiums for facilities. The output documentation provided by the document generation system 202 can be provided to insurers to demonstrate compliance with various regulations and therefore lower insurance risk for facilities. Insurance companies can use risk score modeling to determine insurance premiums for facilitates and, if facilities cannot properly document various activities related to maintenance and general facility operation, the end result may be higher insurance premiums. For example, the document generation system 202 can be used to document things like type and age of roofing, parking lot, and windows, risk hazard assessments (e.g., likelihood of a flood, hurricane, wildfire, etc.), maintenance and repair activities, and other operational parameters of facilities.

FIG. 3 shows a block diagram illustrating an example system 300 for automatically generating compliance documentation for facilities associated with various operators and property owners. The system 300 provides an example hardware and networking implementation of the document generation system 202 described above, however it will be appreciated that the systems described herein, including the document generation system 202 and the maintenance management system 204, can be implemented using a variety of different hardware and networking implementations. As shown in FIG. 3, the system 300 includes a server (or other processing unit) 302 that can execute one or more applications to provide access to the document generation system 202. As noted, the document generation system 202 can be used by facility personnel to automatically generate various types of documents, recommendations, tasks, etc. for assisting facility personnel with compliance with various different regulations and other requirements. The server 302 is shown to be connected to a computing device 330 and one or more remote databases 310 via a communication network 320.

Communication network 320 can be implemented using any suitable communication network or combination of communication networks. For example, communication network 320 can include a Wi-Fi network (which can include one or more wireless routers, one or more switches, and the like), a peer-to-peer network (e.g., a Bluetooth network), a cellular network (e.g., a 3G network, a 4G network, a 5G network, etc., complying with any suitable standard(s), such as CDMA, GSM, LTE, LTE Advanced, WiMAX, 5G NR, etc.), a wired network, etc.

Communication network 320 can be a local area network (LAN), a wide area network (WAN), a public network (e.g., the Internet, which may be part of a WAN and/or LAN), a private or semi-private network (e.g., a corporate or university intranet), any other suitable type of network, or any suitable combination of networks. Communications links shown in FIG. 3 can each be any suitable communications link or combination of communications links, such as wired links, fiber optic links, Wi-Fi links, Bluetooth links, cellular links, and the like.

Server 302 and/or computing device 330 can be any suitable computing device or combination of devices, such as a desktop computer, a laptop computer, a smartphone, a tablet computer, a wearable computing device, one or more server computers (e.g., in a data center), a virtual machine being executed by a physical computing device, one or more containers executed by a computing device (e.g., a virtual machine, a physical computing device, etc.), etc. The server 302 and/or the computing device 330 can communicate with the database server 310 via the communication network 320. The database server 310 can be configured to manage a database 312 that can include various different information. For example, the database 312 can be the connected equipment database 206, the nurse call system database 208, the resident system database 210, etc. as discussed above. In accessing the document generation system 202, the computing device 330 and/or the server 302 can present different user interfaces associated with the document generation system 202 (and/or the maintenance management system 204) to different users.

Communications transmitted over communication network 320 and/or communication links shown in FIG. 3 can be secured using any suitable technique or combination of techniques. For example, communications transmitted to and/or from server 302, computing device 330, and/or database server 310 can be encrypted using any suitable technique or combination of techniques. For example, communication between two or more computing devices associated with communication network 320 (e.g., server 302, computing device 330, database server 310, Domain Name System (DNS) servers, one or more intermediate nodes that serve as links between two or more other devices, such as switches, bridges, routers, modems, wireless access points, and the like) computing devices can be carried out based on Hypertext Transfer Protocol Secure (HTTPS). As another example, communications can be carried out based on Transport Layer Security (TLS) protocols and/or Secure Sockets Layer (SSL) protocols. As yet another example, communications can be carried out based on Internet Protocol Security (IPsec) protocols. As still another example, a virtual private network (VPN) connection can be established between one or more computing devices associated with computing network 320.

One or more techniques can be used to limit access to communication network 320 and/or a portion of communication network 320. For example, computing devices attempting to connect to the network and/or transmit communications using the network can be required to provide credentials (e.g., a username, a password, a hardware-based security token, a software-based security token, a one-time code, any other suitable credentials, or any suitable combination of credentials). Security techniques can be applied to any suitable portion of a communication network that interacts with computing devices. For example, security techniques can be used to implement a secure Wi-Fi network (which can include one or more wireless routers, one or more switches, and the like), a secure peer-to-peer network (e.g., a Bluetooth network), a secure cellular network (e.g., a 3G network, a 4G network, a 5G network, and the like, complying with any suitable standard(s), such as CDMA, GSM, LTE, LTE Advanced, WiMAX, 5G NR, and the like), and the like.

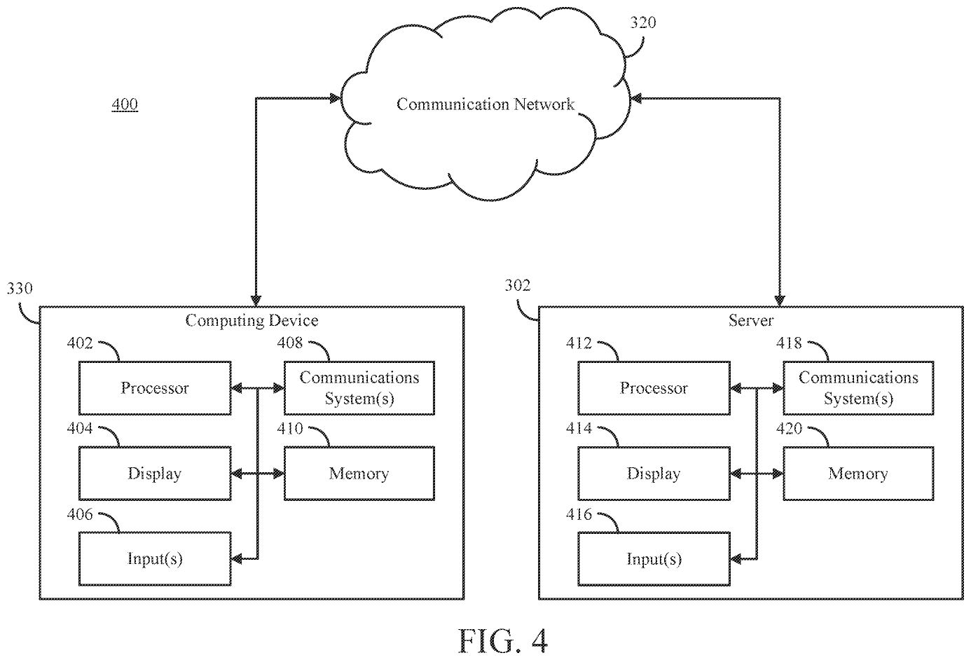

FIG. 4 shows an example of additional hardware that can be used to implement the server 302 and the computing device 330. As shown in FIG. 4, computing device 330 can include a processor 402, a display 404, one or more inputs 406, one or more communication systems 408, and/or memory 410. The processor 402 can be any suitable hardware processor or combination of processors, such as a central processing unit (CPU), a graphics processing unit (GPU), etc. The display 404 can include any suitable display devices, such as a computer monitor, a touchscreen, a television, and the like. The inputs 406 can include any suitable input devices and/or sensors that can be used to receive user input, such as a keyboard, a mouse, a touchscreen, a microphone, a camera, etc.

The communications systems 408 can include any suitable hardware, firmware, and/or software for communicating information over communication network 320 and/or any other suitable communication networks. For example, the communications systems 408 can include one or more transceivers, one or more communication chips and/or chip sets, and the like. In a more particular example, communications systems 408 can include hardware, firmware and/or software that can be used to establish a Wi-Fi connection, a Bluetooth connection, a cellular connection, an Ethernet connection, and the like.

The memory 410 can include any suitable storage device or devices that can be used to store instructions, values, and the like, that can be used, for example, by processor 402 to present content using display 404, to communicate with server 302 via communications system(s) 408, etc. Memory 410 can include any suitable volatile memory, non-volatile memory, storage, or any suitable combination thereof. For example, memory 410 can include random-access memory (RAM), read-only memory (ROM), electrically erasable programmable read-only memory (EEPROM), one or more flash drives, one or more hard disks, one or more solid state drives, one or more optical drives, and the like. The memory 410 can have encoded thereon a computer program for controlling operation of computing device 330. The processor 402 can execute at least a portion of the computer program to present content (e.g., user interfaces, tables, graphics, and the like), receive content from server 302, transmit information to server 302, etc.

The 302 can be implemented using one or more servers 302 (e.g., functions described as being performed by server 302 can be performed by multiple servers acting in concert) that can include a processor 412, a display 414, one or more inputs 416, one or more communications systems 418, and/or memory 420. The processor 412 can be any suitable hardware processor or combination of processors, such as a CPU, a GPU, etc. The display 414 can include any suitable display devices, such as a computer monitor, a touchscreen, a television, etc. The inputs 416 can include any suitable input devices and/or sensors that can be used to receive user input, such as a keyboard, a mouse, a touchscreen, a microphone, and the like.

The communications systems 418 can include any suitable hardware, firmware, and/or software for communicating information over communication network 320 and/or any other suitable communication networks. For example, the communications systems 418 can include one or more transceivers, one or more communication chips and/or chip sets, etc. In a more particular example, the communications systems 418 can include hardware, firmware and/or software that can be used to establish a Wi-Fi connection, a Bluetooth connection, a cellular connection, an Ethernet connection, etc.

The memory 420 can include any suitable storage device or devices that can be used to store instructions, values, and the like, that can be used, for example, by processor 412 to present content using display 414, to communicate with one or more computing devices 330, etc. The memory 420 can include any suitable volatile memory, non-volatile memory, storage, or any suitable combination thereof. For example, memory 420 can include RAM, ROM, EEPROM, one or more flash drives, one or more hard disks, one or more solid state drives, one or more optical drives, and the like. The memory 420 can have encoded thereon a server program for controlling operation of server 302. The processor 412 can execute at least a portion of the server program to transmit information and/or content (e.g., results of a database query, a portion of a user interface, textual information, graphics, etc.) to one or more computing 330, receive information and/or content from one or more computing devices 330, receive instructions from one or more devices (e.g., a personal computer, a laptop computer, a tablet computer, a smartphone, etc.), and the like.

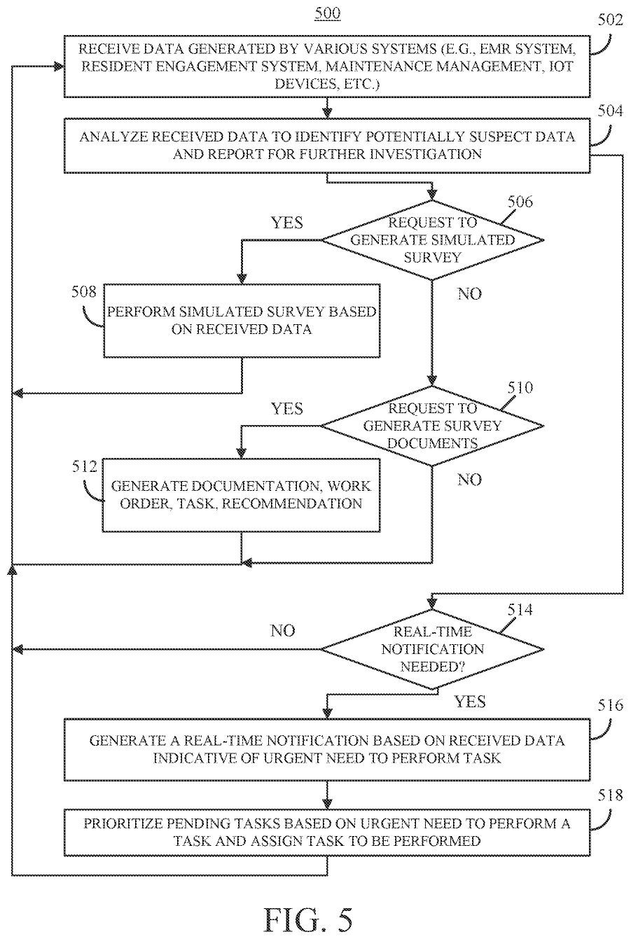

FIG. 5 shows a flow diagram illustrating an example process 500 for evaluating compliance of a facility. Process 500 can be performed by the document generation system 202 and/or the maintenance management system 204 to improve efficiency for a variety of different compliance-related procedures. For example, process 500 can generate a simulated (mock) survey for a facility, generate compliance documentation, work orders, tasks, and recommendations for a facility, generate notifications for providing to facility personnel, and prioritize different tasks for performing to reduce facility citation risk. Process 500 can advantageously integrate data from a variety of different data sources to provide an integrated solution that encompasses important information for facilitating compliance of one or more facilities with different regulatory requirements. As a result, efficiency can be provided for facility personnel and management, and conditions for residents, occupants, users, etc. of the facilities can be improved.

At 502, process 500 can receive data from different, separate data sources that are generated by various systems. For example, process 500 can receive data from the connected equipment database 206, the nurse call system database 208, the resident system database 210, the EMR system database 212, the citations database 216, the maintenance management database 217, the best practices database 218, the one or more vendor databases 214, one or more databases maintained by the document generation system 202 and/or the maintenance management system 204 (including a purchasing system database), and/or other types of databases containing data generated by different systems. Process 500 can securely integrate data from the separate data sources at 502 using separate application programming interfaces (APIs) for each separate data source. The integration of all the data sources at 502 can allow process 500 to securely evaluate a variety of different information relevant to the compliance of one or more facilities.

At 504, process 500 can analyze the received data to identify potentially suspect data and report for further investigation. For example, process 500 can analyze all the data from the separate sources relative to one or more compliance documentation templates and/or relative to compliance logic (e.g., a set of rules, a model, etc.) to identify one or more compliance gaps for one or more facilities. The compliance document templates and/or the compliance logic can be based on different regulations such as the NFPA 101 Life Safety Code, CMS Life Safety Code, and other requirements such as instituted by the Joint Commission, insurance companies, and other AHJs. The templates and logic can use different data received at 502 as inputs to identify compliance gaps and generate compliance documentation. The compliance documentation can be printed for inclusion at a facility (e.g., in a life safety binder) to be reviewed by a surveyor.

At 508, if a request to generate a simulated (mock) survey has been received (506), process 500 can perform a simulated survey based on the data received at 502. For example, process 500 can generate a mock survey report that draws attention to non-compliant sections and/or gaps, and includes recommendations and/or tasks for completion to improve compliance. The mock survey report can be designed to mimic an actual compliance inspection (survey). The mock survey report can include a list of identified compliance gaps and the corresponding recommendations and tasks for completion to address the compliance gaps. The mock survey report can also rank, group, and otherwise prioritize tasks for completion to address the compliance gaps, as well as provide detailed explanations for completing various tasks.

At 508, process 500 can further generate appropriate compliance documentation in accordance with the request, as well as generate work orders, tasks, and/or recommendations in accordance with one or more compliance gaps identified during the compliance document generation process. For example, process 500 can generate various documents needed for different compliance inspections such as a Joint Commission survey, a state surveyor survey, an insurance broker survey, or a Centers for Medicare and Medicaid Services survey. Process 500 can generate the compliance documentation by populating one or more documentation templates associated with one or more authorities having jurisdiction over the compliance inspection using the data received at 502. At 512, if a real-time notification is needed (510), process 500 can generate a real-time notification based on the data received at 502 to indicate an urgent need to perform a task to address one or more compliance gaps. The notification can be provided to facility personnel and/or to the service providers 226 in a variety of manners. For example, the notification can be provided as a text message, a push notification, an e-mail message, a phone call, or another similar type of notification. The ability to provide a notification in real-time can help reduce the risk of citation and reduce the risk of various types of problems that can occur for one or more facilities. The notification can also cause the maintenance management system 204 to generate a work order and/or a task.

At 514, process 500 can prioritize pending tasks and/or work orders based on the urgency of the tasks and assign tasks to be performed. For example, process 500 can generate a score for each task and/or work order based on a variety of factors. A base score can first be associated with each task, where the base score can be representative of the general importance of the task. For example, tasks that have a higher importance in terms of life safety (e.g., replacing batteries in nurse call devices, moving potential walking hazards, etc.) can be associated with a higher base score than tasks with a lower importance in terms of life safety. The base scores can be configured in a variety of manners depending on the type of facility, type of survey, and other factors. Then, and adjusted score can be calculated for each task by incrementing or decrementing the base score. The adjusted score can be calculated based on a variety of factors such as citation data trends, regional factors, type of facility, etc. The adjusted scores can be calculated automatically and/or can be calculated based on manual user adjustments, for example. Other possible approaches to prioritizing tasks based on the urgency of the tasks can be implemented. Then, the tasks can be assigned (e.g., to facility personnel and/or to the service providers 226) for completion. Process 500 can assign the tasks by sending a notification to personnel assigned to the task, creating a work order, etc.

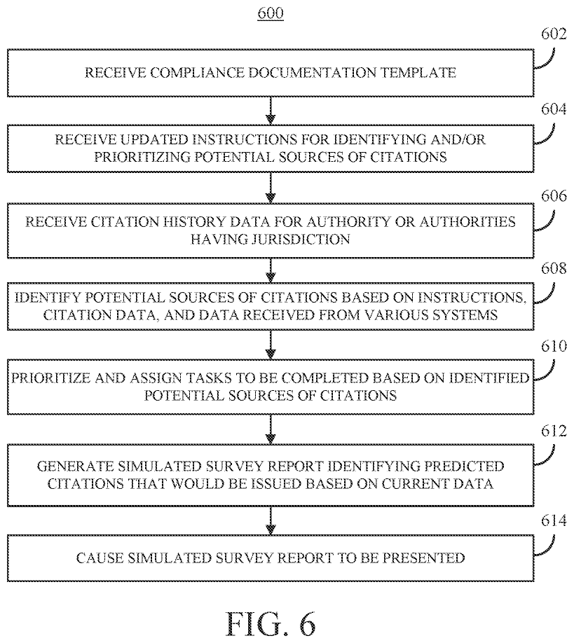

FIG. 6 shows a flow diagram illustrating an example process 600 for generating a simulated (mock) survey report for a facility. Process 600 can be performed by the document generation system 202 and/or the maintenance management system 204 to simulate an actual survey (compliance inspection) that may be performed at a given facility. By simulating the actual survey, facility personnel can prepare for the actual survey and identify potential areas of concern that need to be addressed before the actual survey occurs. This functionality provided by process 600 can not only help facility personnel and management comply with various complex and changing regulations, but it can also help residents and other users of the facility by providing better facility services and maintenance of equipment in the facility.

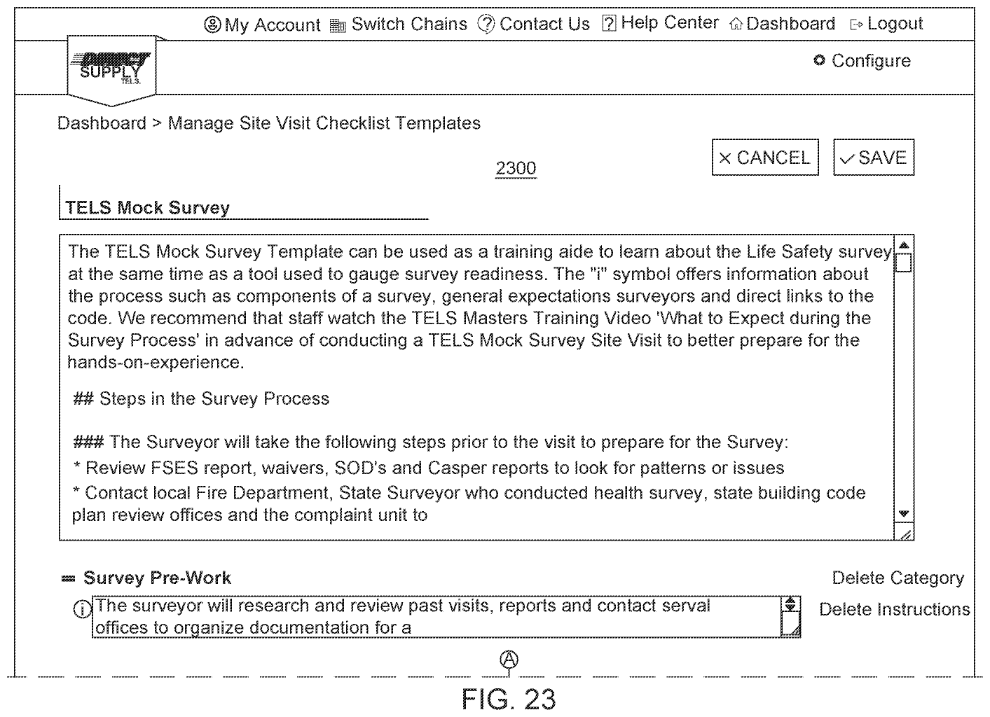

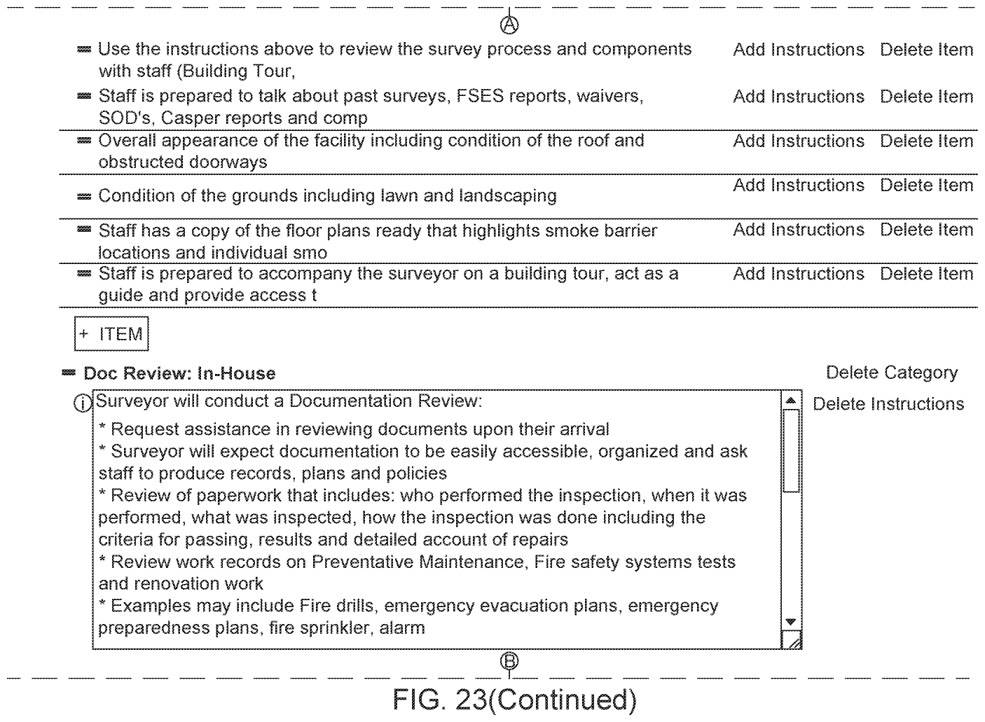

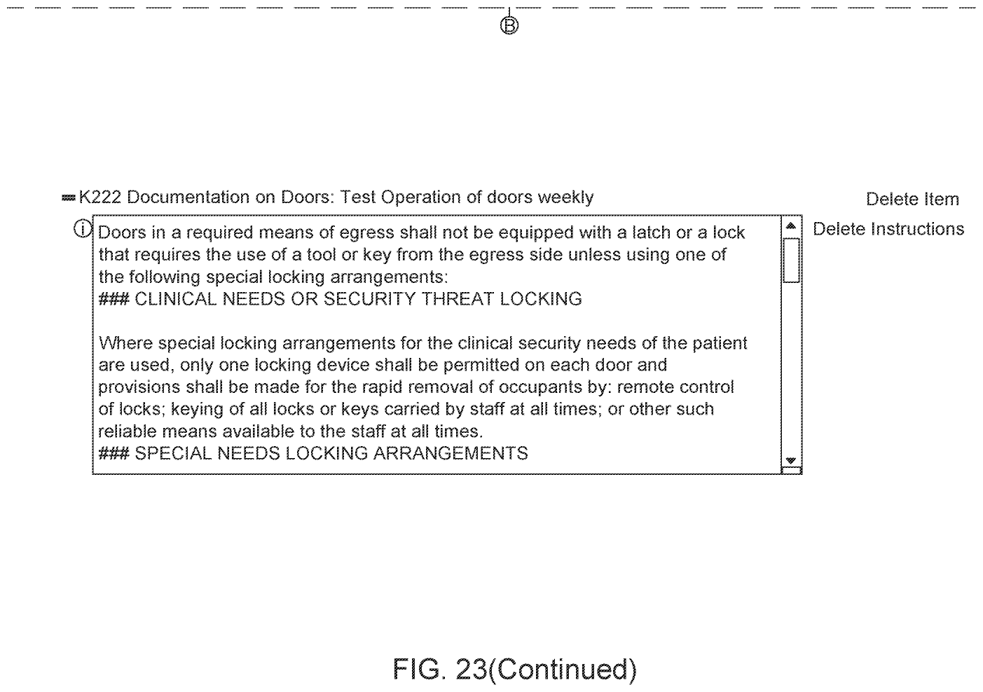

At 602, process 600 can receive a compliance documentation template. For example, process 600 can receive a compliance documentation template associated with a specific AHJ and/or a specific type of survey selected by a user. At 604, process 600 can receive updated instructions for identifying and/or prioritizing potential sources of citations. For example, process 600 can receive user inputs provided via an administrative tools user interface such as described below with respect to FIG. 23. At 606, process 600 can receive citation history data for one or more authorities having jurisdiction associated with the mock survey report. For example, process 600 can receive citation data from the citations database 216.

At 608, process 600 can identify potential sources of citation based on the instructions received at 604, the citation data received at 606, and other input data received from various input data sources. For example, process 600 can evaluate the instructions received at 604, the citation data received at 606, and data retrieved from one or more of the connected equipment database 206, the nurse call system database 208, the resident system database 210, the EMR system database 212, the citations database 216, the maintenance management database 217, the best practices database 218, the one or more vendor databases 214, and/or one or more databases maintained by the document generation system 202 and/or the maintenance management system 204 (including a purchasing system database) to identify potential sources of citation.

At 610, process 600 can prioritize and assign tasks to be completed based on the identified potential sources of citation at 608. For example, process 500 can generate a score for each identified potential source of citation based on the potential scope and severity of the citation. For example, potential sources of citation associated with life safety risks (e.g., restoring loss of communication in nurse call devices, moving potential walking hazards, etc.) can be associated with a higher score (e.g., in part based on an associated citation, such as CMS citation tag with a corresponding scope and severity). The scores can be calculated based on a variety of factors such as citation data trends, regional factors, facility factors such as the facilities prior citations (e.g., prioritizing prior citations by increasing the associated potential source's score), and other possible factors. Then, tasks can be assigned (e.g., to facility personnel and/or to the service providers 226) for completion to address the potential sources of citation by sending notifications to personnel assigned to the task, creating work orders, submitting maintenance requests, etc.

At 612, process 600 can generate a simulated survey report identifying predicted citations that would be issued based on the current data. For example, the simulated survey report can identify one or more citation likely to be issued to the facility if a real survey were to take place at the facility. At 614, process 600 can cause the simulated survey report to be presented to a user (e.g., facility manger, etc.) via a user interface on a user device (e.g., the computing device 330). The user can then view the simulated survey report via the user interface, download the simulated survey report via the user interface, send the simulated survey report via the user interface, print the simulated survey report via the user interface, etc. The facility can use the simulated survey report to prepare for an actual survey and to facilitate compliance with various complex and changing regulations.

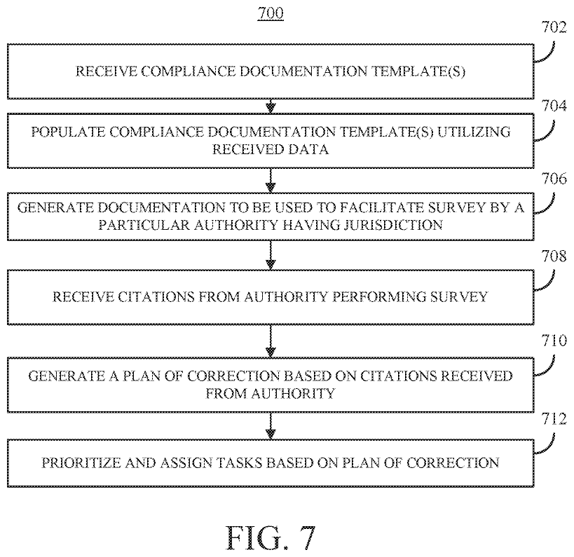

FIG. 7 shows a flow diagram illustrating an example process 700 for generating compliance documentation and assigning tasks to address compliance gaps. Process 700 can be performed by the document generation system 202 and/or the maintenance management system 204 to generate appropriate compliance documentation for a facility. The types of compliance documentation can not only include various documents needed for an actual compliance inspection (survey), but it can also include various documents needed after an actual compliance inspection is performed, such as plan of correction documents. The functionality provided by process 700 can provide improvements in efficiency for facilities that need to comply various complex and changing regulations by automatically integrating data from various sources and automatically generating appropriate compliance documentation needed by the facility.

At 702, process 700 can receive one or more compliance documentation templates for generating appropriate compliance documentation. For example, process 700 can identify one or more appropriate compliance documentation templates based on a request received from a user for the compliance documentation. The request can identify a specific AHJ and/or a specific type of survey selected by the user. At 704, process 700 can populate the compliance documentation templates using data received from multiple sources. For example, process 700 can populate the one or more compliance documentation templates using data retrieved from one or more of the connected equipment database 206, the nurse call system database 208, the resident system database 210, the EMR system database 212, the citations database 216, the maintenance management database 217, the best practices database 218, the one or more vendor databases 214, and/or one or more databases maintained by the document generation system 202 and/or the maintenance management system 204 (including a purchasing system database). At 706, process 700 can generate compliance documentation that can be used to facilitate a compliance inspection (e.g., a survey) by a particular AHJ based on the populated compliance documentation templates.

At 708, process 700 can receive one or more citations from an AHJ that performs a compliance inspection using the compliance documentation generated at 706. For example, a surveyor can use the compliance documentation generated at 706 to perform a compliance inspection and identify one or more compliance gaps for the facility. Based on the compliance gaps, the surveyor can issue citations for the facility. At 710, process 700 can generate a plan of correction based on the one or more citations received from the AHJ that performs the compliance inspection. The plan of correction can include one or more tasks for performing by facility personnel and/or by the service providers 226 to address any identified compliance gaps. In some cases, the plan of correction may be required to be submitted to the one or more AHJs after a certain time period elapses after a compliance inspection is completed (e.g., 10 days). Process 700 can automatically generate appropriately formatted plan of correction documents including detailed plans to address each deficiency in the citations, measures in place at the one or more facilities to ensure the deficiencies are not recurring, monitoring procedures being used to ensure the deficiencies are not recurring, and other potential information that may be required to be included in the plan of correction. As tasks are completed, the information associated with the formatted plan of correction documents can be updated accordingly (e.g., description of task done, date of completion, etc.).

At 712, process 700 can automatically prioritize the tasks included in the plan of correction (e.g., based on priority scoring of tasks). Process 700 can also automatically assign different tasks included in the plan of correction to appropriate personnel (e.g., based on capabilities associated with personnel) at 712. For example, process 700 can prioritize different tasks in the plan of correction to address the deficiencies (e.g., by scoring and ranking tasks based on the scores), and assign the tasks to facility personnel and/or to the service providers 226 for completion within a certain time period outlined in the plan of correction. Process 700 can further notify different individuals (e.g., via push notification, text message, e-mail, etc.) of any tasks they have been assigned. Tasks can be automatically assigned to internal personnel or external contractors depending at least in part on capabilities, skills, priority, schedule, etc. of internal personnel.

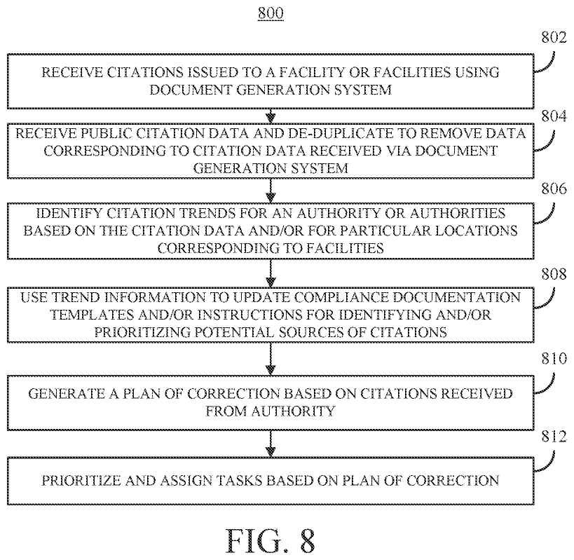

FIG. 8 shows a flow diagram illustrating an example process 800 for updating compliance documentation templates and compliance logic. Process 800 can be performed by the document generation system 202 and/or the maintenance management system 204 to update various compliance documentation templates, audit templates, and compliance documentation logic based on a variety of factors. For example, changes to regulatory code may require changes to be made to compliance documentation templates that are populated by the document generation system 202 to automatically generate different types of compliance documentation logic for a compliance inspection. Additionally, changes in public citation data trends and other types of trends may create certain weightings for different factors for different facilities that can lead to adjustments in logic (e.g., rules) and/or templates. The functionality provided by process 800 allows the document generation system 202 and/or the maintenance management system 204 to adapt to changing regulatory environments and provide improved efficiency for facility personnel and inspecting entities alike.

At 802, process 800 can receive citations issued to one or more facilities (e.g., all connected facilities) using the document generation system 202. For example, citations issued to facilities can be uploaded to the document generation system 202 by facility personnel or citations can be issued electronically to facilities by surveyors and accessed via the document generation system 202. The citations can be uploaded by a given facility shortly after the citations are issued such that the document generation system 202 has access to up-to-date information. At 804, process 800 can receive public citation data and de-duplicate the public citation data to remove data corresponding to the citations received at 802. For example, process 800 can receive public citation data from the citations database 216. At 806, process 800 can identify citation data trends for one or more AHJs based on the public citations data and/or for one or more locations corresponding to one or more facilities. For example, process 800 can identify citation data trends associated with a specific type of compliance inspection such as a Joint Commission survey, a state surveyor survey, an insurance broker survey, or a Centers for Medicare and Medicaid Services survey. Process 800 can also identify citation data trends for a specific facility or group of facilities, and/or for a specific region or grouping of regions, or citation data trends for a specific surveyor.

At 808, process 800 can use the citation data trend information to update compliance documentation templates and/or instructions for identifying and/or prioritizing potential sources of citations. For example, process 800 can update compliance documentation templates to make sure certain information associated with a given facility (e.g., documentation of certain maintenance activities related to fire safety, life safety, etc.) is included automatically in the compliance documentation generated for the facility. Process 800 can also make changes to compliance documentation logic (e.g., to change rules, thresholds, etc.) and scoring logic to place added emphasis on identifying and correcting certain compliance gaps that may be at high risk for citation based on the citation data trends.

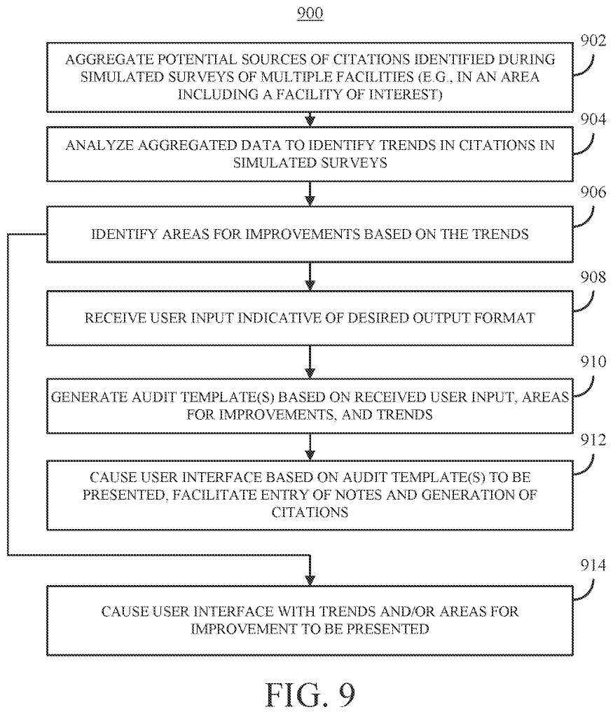

FIG. 9 shows a flow diagram illustrating an example process 900 for generating an audit template used for a compliance audit. Process 900 can be performed by the document generation system 202 and/or the maintenance management system 204 such that inspecting entities including surveyors and insurers can use the document generation system 202 and/or the maintenance management system 204 to facilitate compliance inspections. Process 900 can generally analyze aggregate facility data to identify trends, generate different recommendations based on the trends, and generate compliance documentation including audit templates that can then be used by the inspecting entities to complete compliance audits. The functionality provided by the document generation system 202 and/or the maintenance management system 204 via process 900 can provide improved efficiency for inspecting entities.

At 902, process 900 can aggregate potential sources of citations that are identified during simulated (mock) surveys of multiple facilities. For example, process 900 can aggregate potential sources of citations identified during simulated surveys of multiple facilities in a region of interest or of multiple facilities that share a common characteristic. At 904, process 900 can analyze the aggregated data indicative of the potential sources of citations to identify trends in the potential sources of citations identified during the simulated surveys. For example, process 900 can determine that certain violations related to fire safety, life safety, equipment maintenance, etc. are common in a certain region or among a certain type of (or similar) facility. At 906, process 900 can identify areas for improvement based on the trends. For example, process 900 can identify life safety risks stemming from nurse call device functionality as an area for improvement based on the trends in the potential sources of citations identified during the simulated surveys.

At 914, process 900 can cause a user interface to be presented to a user via a user device (e.g., the computing device 330) that identities the trends and/or areas for improvement. The user interface can also present to the user via the user interface different recommendations associated with the trends and/or areas for improvement. For example, responsive to identifying life safety risks stemming from nurse call device functionality as an area for improvement based on the trends in the potential sources of citations identified during the simulated surveys, the user interface can recommend the user (e.g., a surveyor or an insurer) that greater emphasis should be placed on nurse call device functionality when inspecting facilities in a region of interest. As a result, the user may be more likely to issue citations related to nurse call device functionality which can lead to better compliance with nurse call device regulations in the region of interest.

At 908, process 900 can receive a user input from a user (e.g., a surveyor or an insurer) via a user interface presented on a user device (e.g., the computing device 330), where the user input is indicative of a desired output format for an audit template. For example, the user may be a surveyor working for the Joint Commission, and may provide a user input indicating a desired output format for the audit template that is in accordance with Joint Commission survey standards. At 910, process 900 can generate an appropriately formatted audit template (or generate multiple audit templates) based on the user input. Process 900 can also generate the appropriately formatted audit template(s) based on the identified areas for improvement and trends.

At 912, process 900 can present the audit template(s) to the user via the user interface. The user can then use the audit template(s) to complete a compliance audit for one or more facilities. The user can print the audit template, send the audit template, and otherwise manage the audit template generated and provided via the user interface at 912. The user interface can be the same user interface that presents the trend and the recommendation at 914. For example, the user can use the audit template by providing user inputs via the user interface to issue citations for different compliance violations. The user can also view a compliance checklist for a compliance audit including various compliance inspection tasks and perform various additional tasks using the audit template.

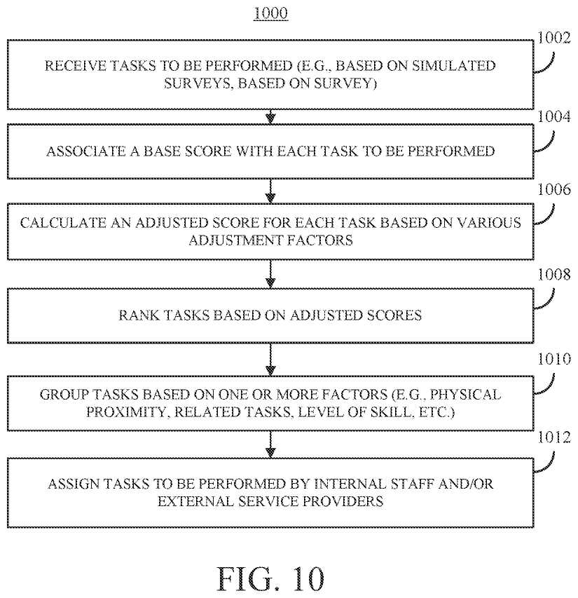

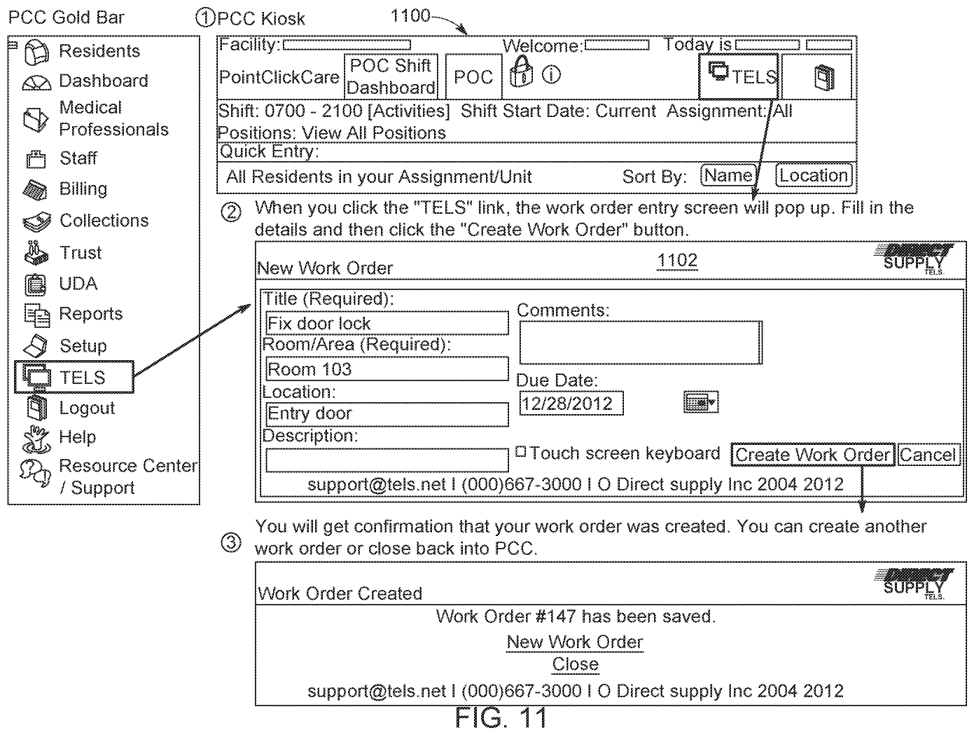

FIG. 10 shows a flow diagram illustrating an example process 1000 for automatically assigning tasks for performing to address compliance gaps. Process 1000 can be performed by the document generation system 202 and/or the maintenance management system 204 such that inspecting entities including surveyors and insurers can use the document generation system 202 and/or the maintenance management system 204 to assign tasks to be completed as a result of a compliance audit. Process 1000 can generally receive tasks to be performed based on either a real survey or a simulated (mock) survey, score the tasks, and then assign the tasks for performance. The functionality provided by the document generation system 202 and/or the maintenance management system 204 via process 1000 can provide improved efficiency for inspecting entities and quicker resolution of actual and potential compliance violations.

At 1002, process 1000 can receive one or more tasks to be performed. For example, process 1000 can receive tasks to be performed as a result of a real survey (e.g., a compliance audit) or a simulated (mock) survey. The tasks can be associated with identified compliance violations and/or identified compliance gaps, for example. At 1004, process 1000 can associate each of the received tasks with a base score. The base score can be representative of the general importance of the task. For example, tasks that have a higher importance in terms of life safety (e.g., replacing batteries in nurse call devices, moving or repairing potential walking hazards, etc.) can be associated with a higher base score than tasks with a lower importance in terms of life safety (e.g., in part based on an associated citation, such as CMS citation tag with a corresponding severity). The base scores can be configured in a variety of manners depending on the type of facility, type of survey, and other factors.

At 1006, process 1000 can calculate an adjusted score for each task based on various adjustment factors. For example, process 1000 can calculate an adjusted score for each task that positively or negatively affects (e.g., increments or decrements) the base score based on a variety of factors such as citation data trends, regional factors, seasonality factors, type of facility, priorities of the inspecting entity, (e.g., AHJ), whether “backups” exist at the facility (e.g., backup equipment or systems that can be used while primary equipment or systems are being repaired), staffing trends such as workforce turnover, levels (insufficient staffing, training, etc.), etc. The adjusted scores can be calculated in a variety of manners relative to the base scores, such as being calculated automatically and/or being calculated based on manual user adjustments. At 1008, process 1000 can rank the tasks based on the adjusted scores for each task. For example, the task with the highest adjusted score can be ranked first, followed by tasks with subsequently lower adjusted scores in order of adjusted score. Prioritization of tasks can also be accomplished using a variety of probabilistic models (i.e., statistical models such as Bayesian models, survival analysis, risk assessment models, or machine learning models such as a probabilistic neural network). For example, a model that determines a probability that a particular citation will occur based on various factors discussed above weighted by a severity level for that citation. In this manner, process 1000 can dynamically rank tasks based on various factors such that tasks can be flexibly prioritized for completion in the appropriate manner.

At 1010, process 1000 can group tasks based on one or more factors. For example, the tasks can be grouped based on factors including but not limited to physical proximity (e.g., grouped by area or building within a facility, grouped by facility, grouped by region, etc.), related tasks (e.g., same task type such as HVAC, fire safety, etc.), level of skill required to complete the task, and other factors. At 1012, process 1000 can assign the tasks to be performed by internal staff (e.g., facility employees) and/or by external service providers (e.g., the service providers 226). For example, tasks matching the capabilities of the internal staff at a facility can be grouped together, and tasks that are outside the capabilities of the internal staff can also be grouped together. Then, the tasks can be appropriately assigned to the internal staff and to the service providers 226. In assigning the tasks, process 1000 can send a notification to appropriate personnel detailing the assignment. Process 1000 can also assign tasks by generating work orders, service requests, etc.

FIG. 11 shows example user interfaces for submitting a work order via an electronic medical records (EMR) system. In the example shown in FIG. 11, the EMR system can present an EMR user interface 1100 with a selectable user interface element including a link that, upon selection by a user, causes a work order entry window 1102 to launch on the user interface. Via the work order entry window 1102, the user can then submit a work order that can be stored in the EMR system database 212 and accessed by the document generation system 202 and/or the maintenance management system 204. The work order can then be assigned to maintenance personnel, for example, and data associated with the work order can be stored for use in the generation of compliance documentation and identification of compliance gaps. The ability to enter work orders via an EMR system user interface such as the EMR user interface 1100 shown in FIG. 11 can provide convenience for clinical teams that spend most of their time updating medical records by eliminating the need for them to transition to a different system to create a work order.

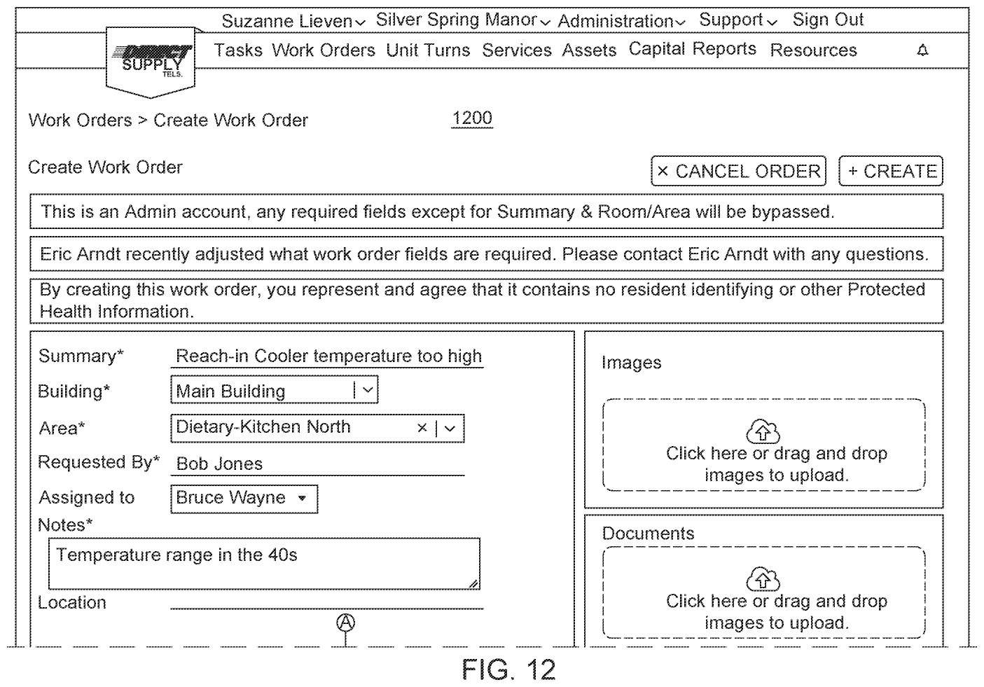

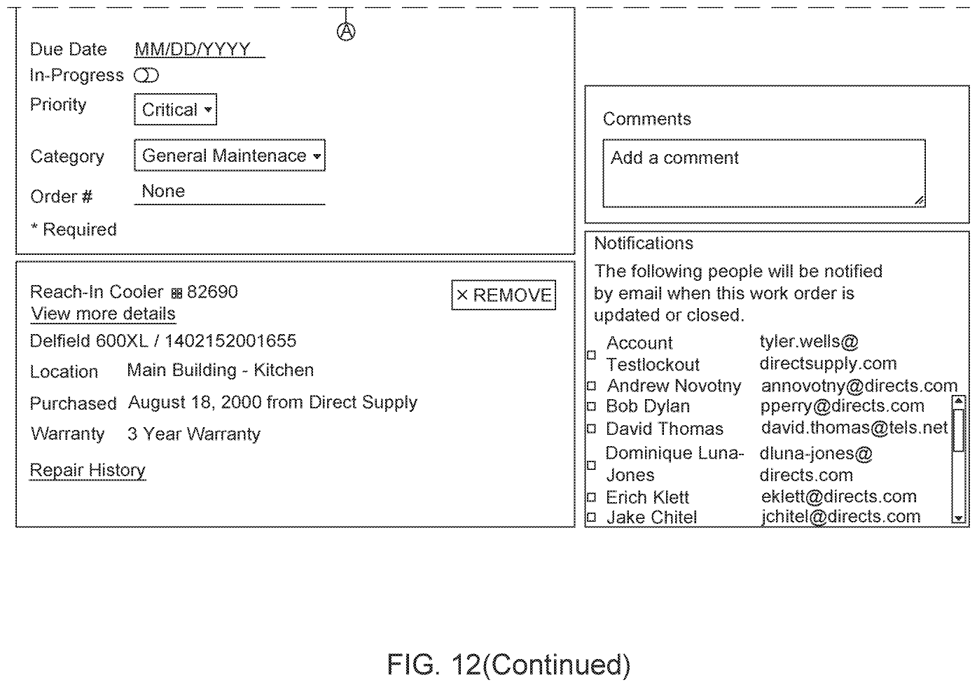

FIG. 12 shows an example work order entry user interface 1200 that can be used by facility personnel to submit a work order. The document generation system 202 and/or the maintenance management system 204 can cause the work order entry user interface 1200 to be presented to a user via the computing device 330, for example. The work order entry user interface 1200 includes a variety of fields, some of which may be required and some of which may not be required. A work order submitted via the work order entry user interface 1200 can identify a person assigned to complete the work order, a person that requested the work order, a building associated with the work order, an area in the building associated with the work order, a due date for the work order, a category for the work order, a priority level for the work order, equipment identification, and other information associated with the work order. Via the work order entry user interface 1200, the user can upload images and documents that can be associated with the work order, add any comments associated with the work order, and select one or more people to receive notifications about the work order. All of this data and other data can be stored in a database maintained by the maintenance management system 204, for example, such that it can be used by the document management system 202 for the generation of compliance documentation and identification of compliance gaps.

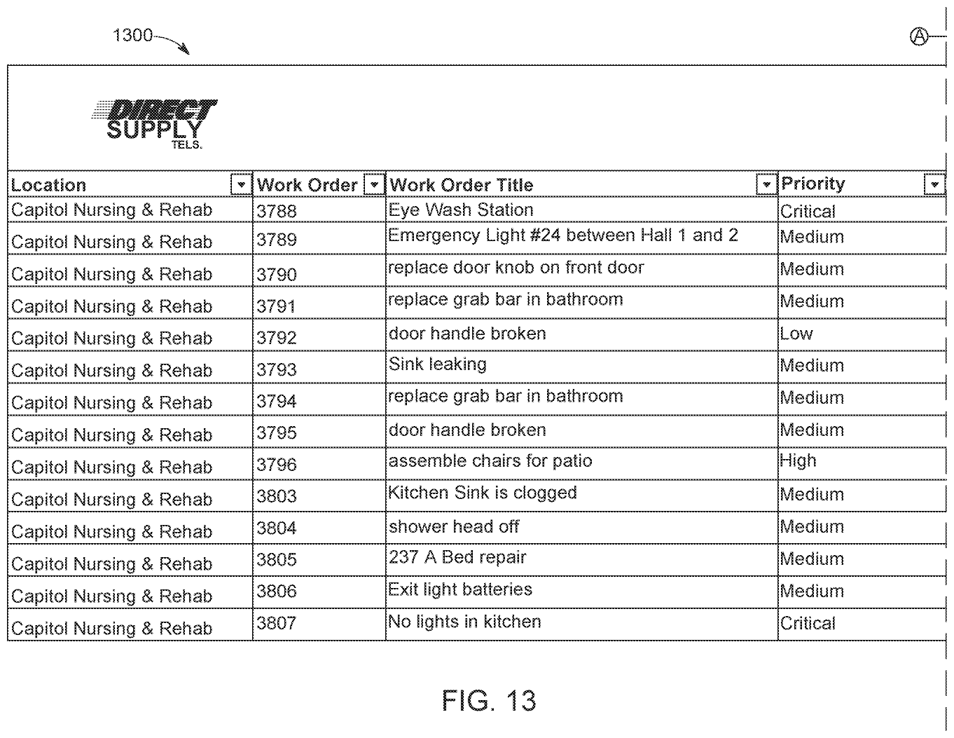

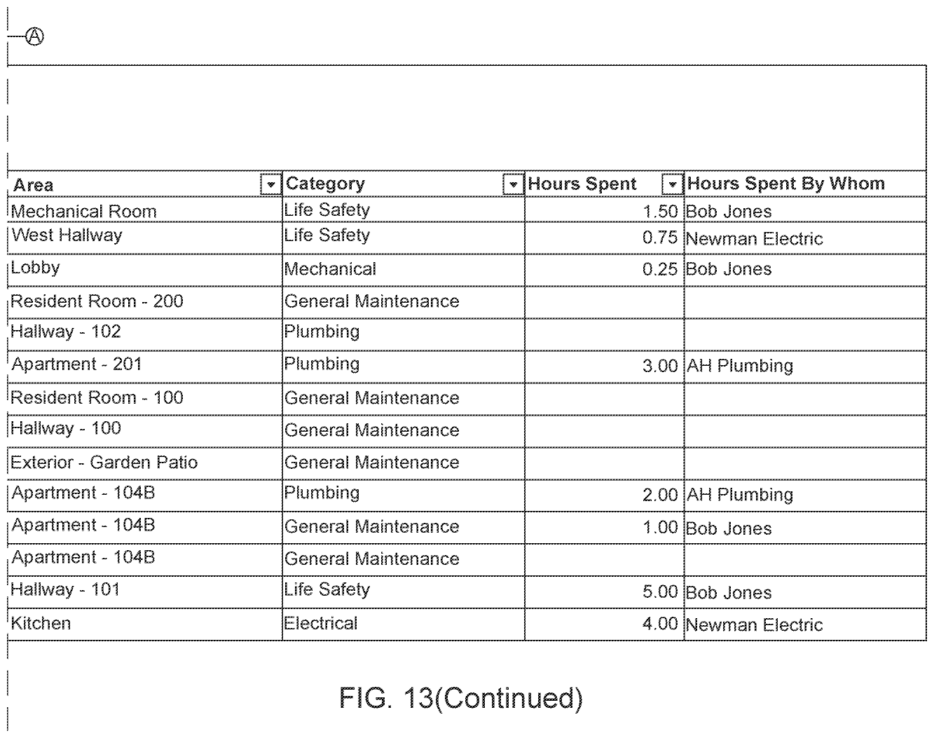

FIG. 13 shows an example work order report 1300 that details work orders specific to life safety incidents for a given facility. The document generation system 202 and/or the maintenance management system 204 can generate the work order report 1300 and cause the work order report 1300 to be presented on a user interface to a user via the computing device 330, for example. More specifically, the work order report 1300 identifies work orders specific to life safety incidents that were solved at a facility over a time period of one month. The work order report 1300 identifies, for each work order, a location, a work order identifier (e.g., a number), a work order title, a priority level, an area of the facility, a category, a time spent, and a person and/or entity that spent time on the work order. The work order report 1300 can be generated based on data accessed via one or more databases such as the resident system database 210, a database maintained by the maintenance management system 204, and other databases as detailed herein. Work order reports similar to the work order report 1300 shown in FIG. 13 can be used by the document generation system 202 to generate compliance documentation for a variety of different types of compliance inspections and identification of compliance gaps.

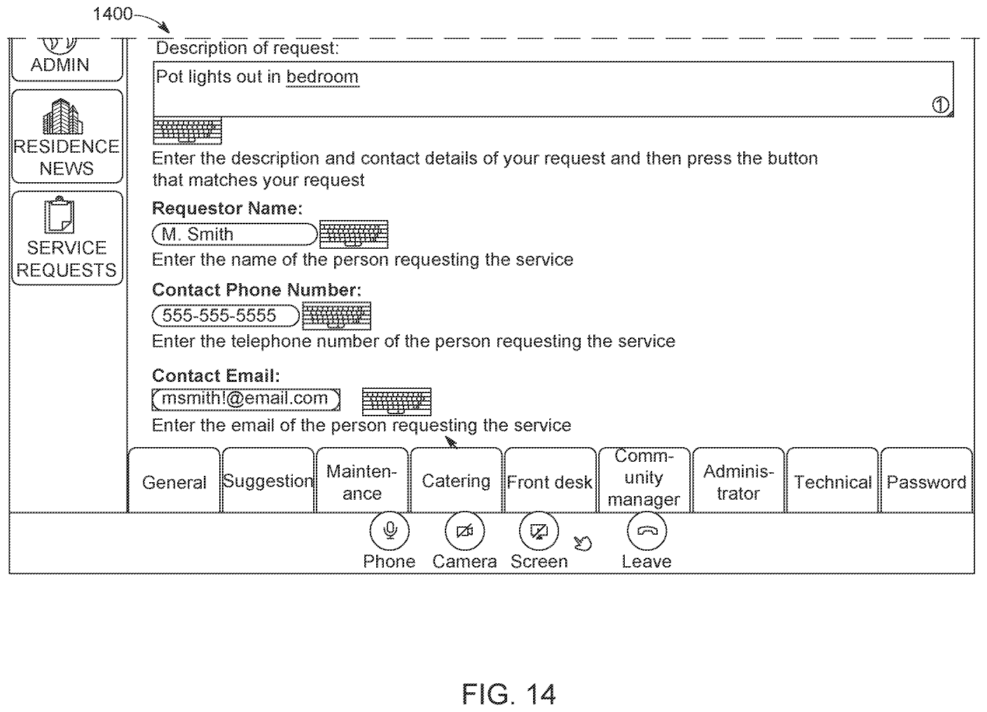

FIG. 14 shows an example resident system user interface 1400 that can be used to submit maintenance requests via a resident engagement system. For example, as discussed above, residents of a senior living facility, as well as family members of the residents of the senior living facility, can submit maintenance requests via a resident engagements system. Data associated with maintenance requests submitted via the resident engagement system can be stored in the resident system database. The resident system user interface 1400 shows an example of a user interface that can be presented to residents and/or family members of residents for submitting such maintenance requests. As shown in FIG. 14, the resident system user interface 1400 includes various fields and tabs, including fields for entering a description associated with the maintenance request, a requestor name associated with the maintenance request, a contact phone number for the maintenance request, and a contact email for the maintenance request.

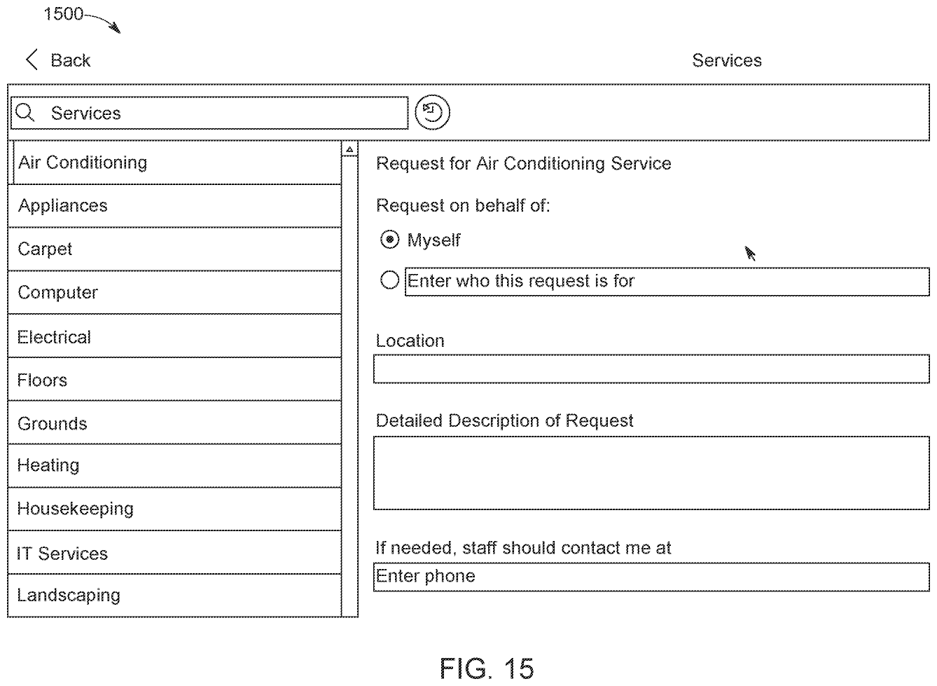

FIG. 15 shows another example resident system user interface 1500 that can be used to submit maintenance requests via a resident engagement system. For example, residents of a senior living facility, as well as family members of the residents of the senior living facility, can submit maintenance requests via a resident engagement system. Different information associated with maintenance requests submitted via the resident engagement system can be stored in the resident system database 210. The resident system user interface 1500, as shown in FIG. 15, includes various fields and tabs, including fields for entering a description associated with the maintenance request, an indicator of who the maintenance request is submitted on behalf of, and a contact phone number for the maintenance request. The tabs on the resident system user interface 1500 can be selected for different categories of service, such as air conditioning (shown as selected), appliances, carpet, computer, etc.

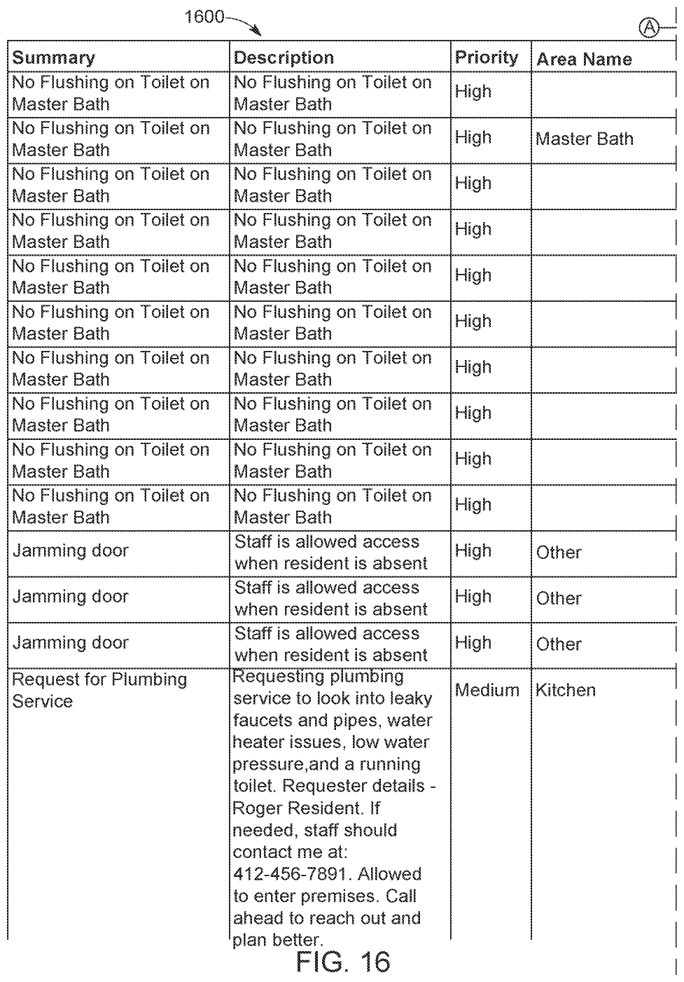

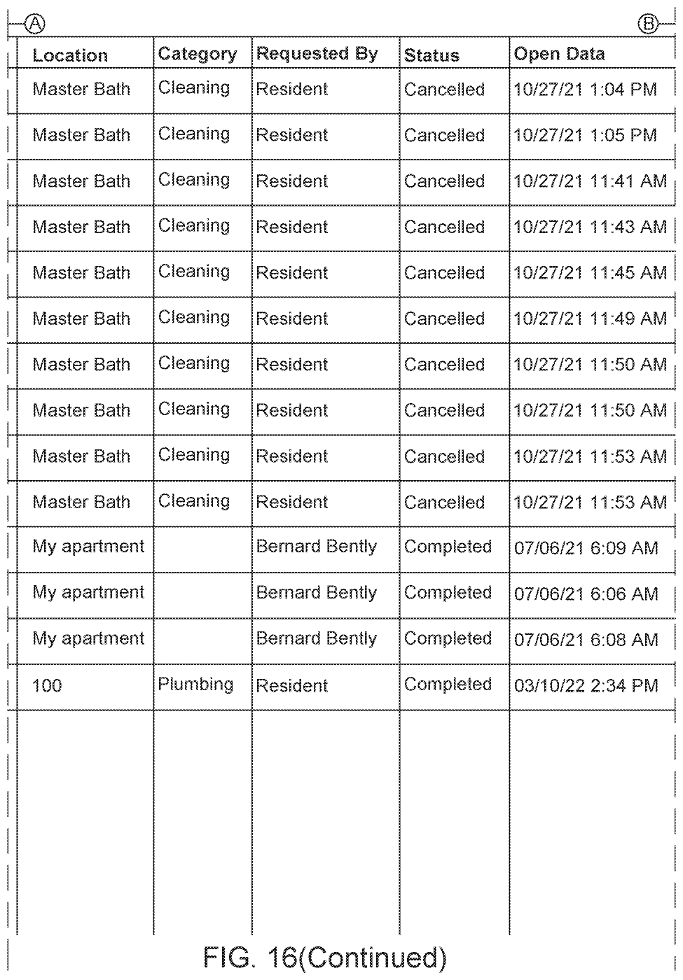

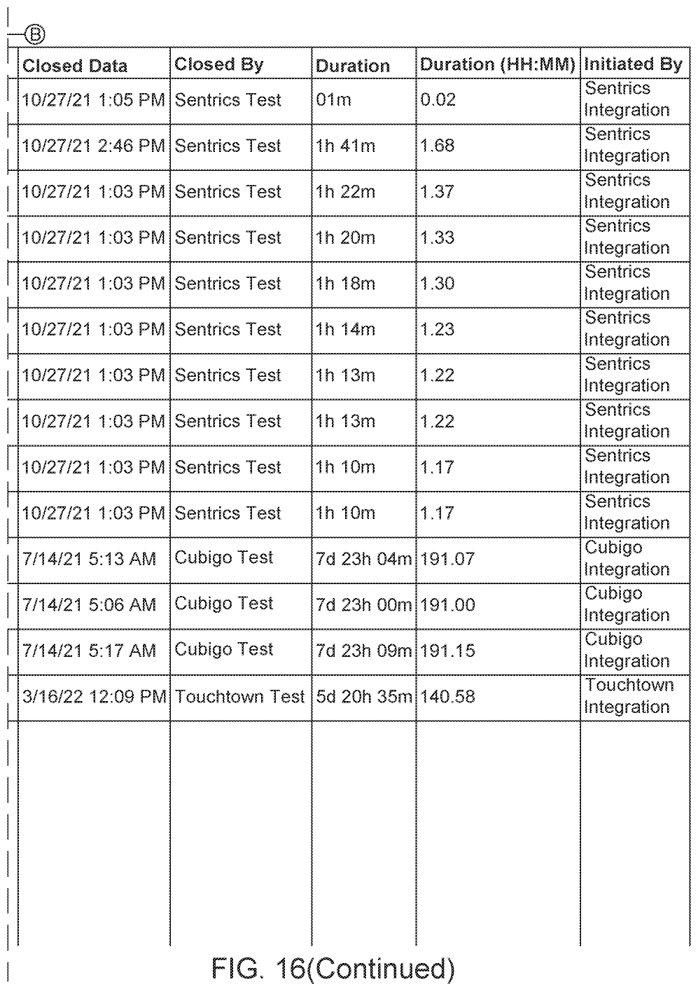

FIG. 16 shows an example work order report 1600 that details work orders associated with maintenance requests submitted via a resident engagement system for a given facility. The document generation system 202 and/or the maintenance management system 204 can generate the work order report 1600 and cause the work order report 1600 to be presented on a user interface to a user via the computing device 330, for example. The work order report 1600 shows work orders associated with resident requests over a time period of one month for the facility. For a senior living facility, via the resident engagement system, a family member (e.g., a child of an elderly person) can submit a maintenance request (e.g., for the air conditioning, television, etc.) for a resident of the senior living facility, and the maintenance request can be stored in the resident system database 210. In the work order report 1600, a variety of information associated with each work order resulting from a maintenance request can be included, such as s summary (e.g., no flushing on toilet in master bathroom), a description, a priority level, an area name (if applicable), a location, a category, a person/entity that submitted the maintenance request, a status, an open data and time, a closed data and time, a person/entity that closed the work order, a duration the work order was open for, and a person/entity that initiated the work order (e.g., based on the maintenance request submitted via the resident engagement system). The work order report 1600 can also include information related to costs of completing work. The document generation system 202 can use the work order report 1600 for various purposes in terms of compliance document generation and other compliance functionality as described herein.

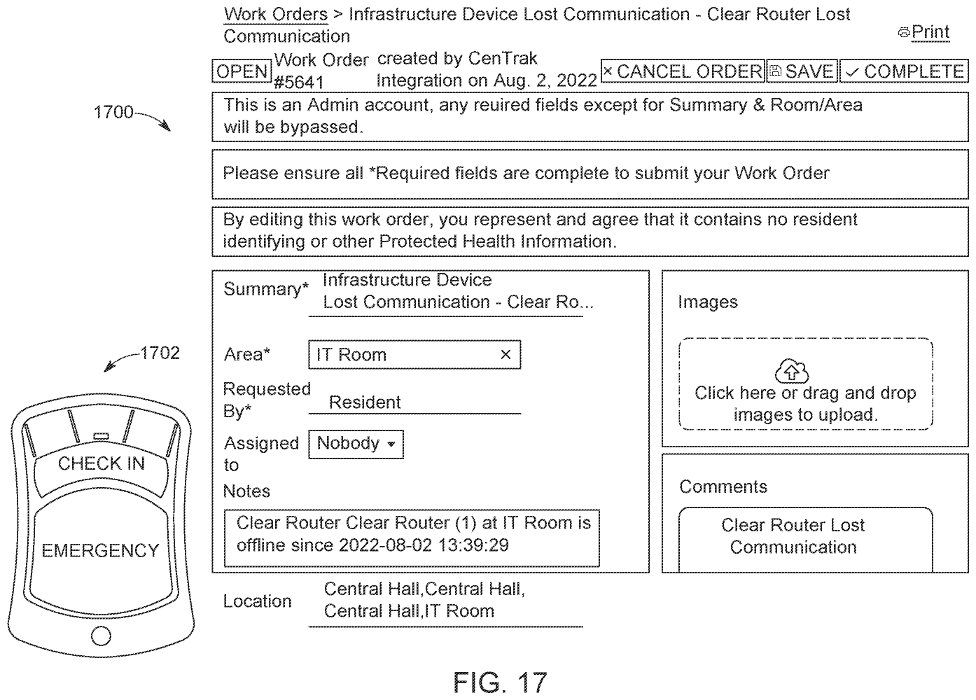

FIG. 17 shows an example work order 1700 that is created in accordance with an example nurse call device 1702. Data associated with the work order 1700 that is created based on the nurse call device 1702 can be accessed via the nurse call system database 208, for example. The work order 1700 as shown in FIG. 17 is generated responsive to detecting a loss in communication between a router and the nurse call device 1702. As a result of the loss in communication, signals generated by the nurse call device 1702 may not properly be received (e.g., by the maintenance management system 204), and therefore the resident associated with the nurse call device 1702 may be at risk. In response to detecting the loss in communication, the document generation system 202 and/or the maintenance management system 204 can send an alert to maintenance personnel such that maintenance personnel can access the work order 1700. As shown in FIG. 17, maintenance personnel may be required to fill in different fields associated with the work order 1700 (e.g., area, notes, images, comments, etc.), and some or all of the fields associated with the work order 1700 can be automatically filled in depending on the type of work order. The work order 1700 can then be accessed (e.g., via the nurse call system database 208) by the document generation system 202 for various purposes in terms of compliance document generation and other compliance functionality as described herein.

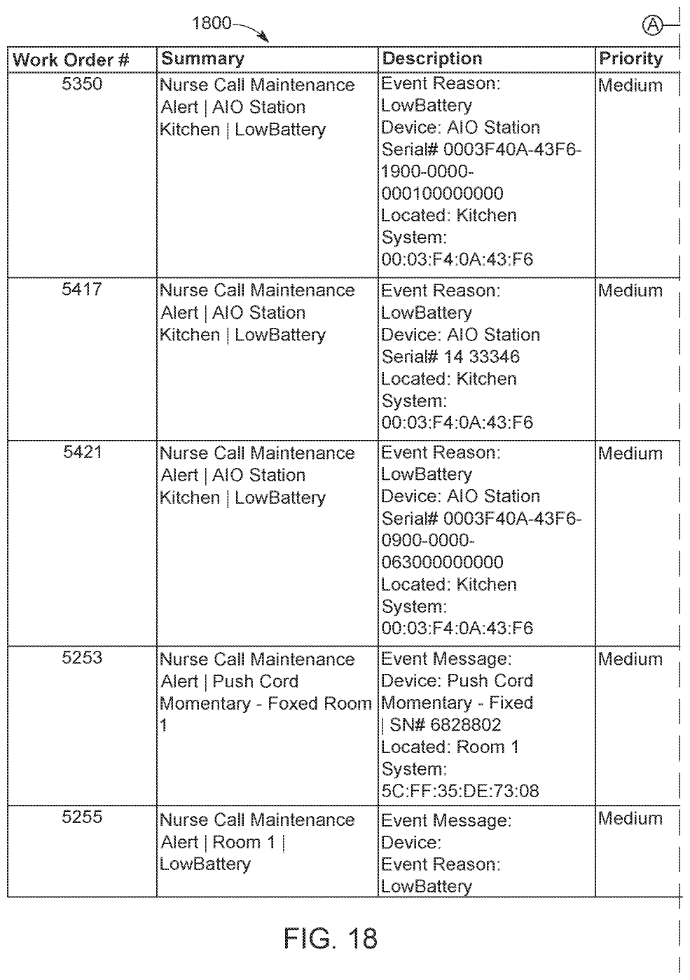

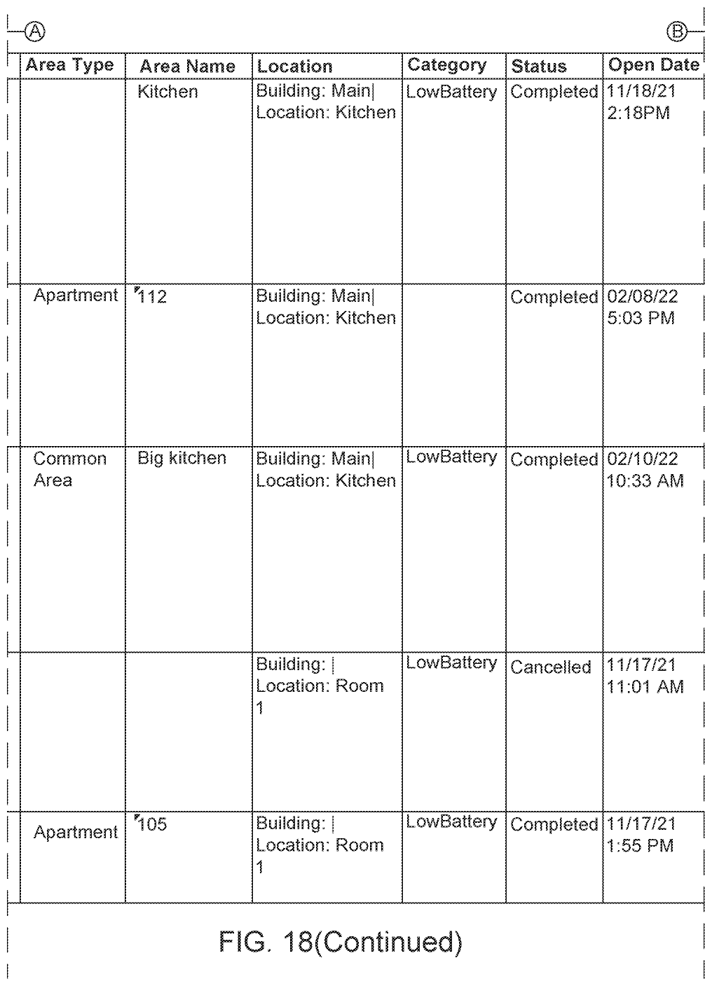

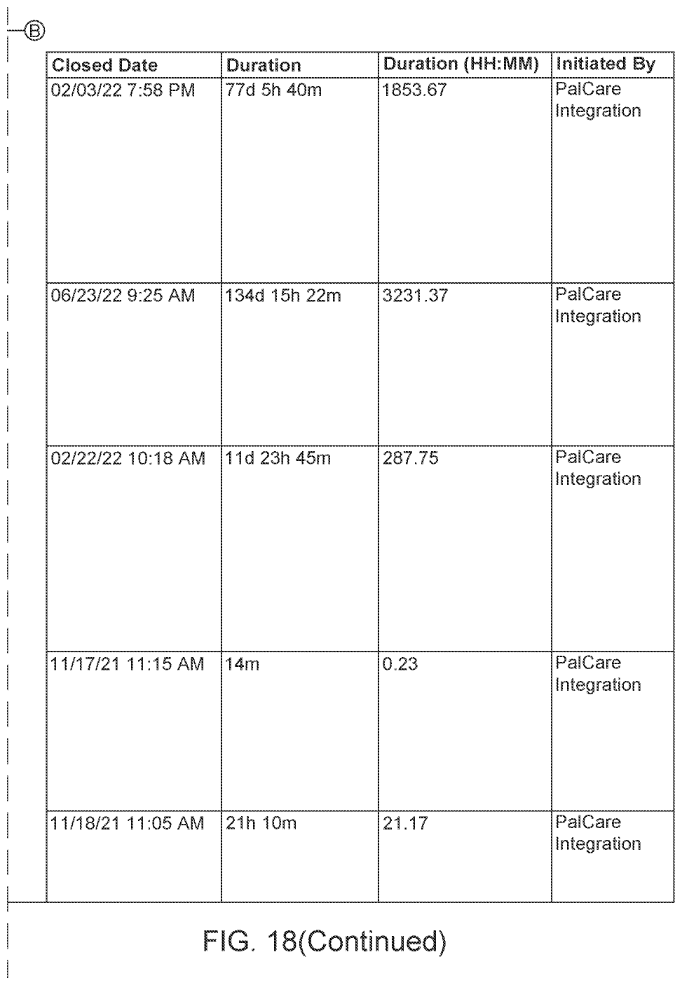

FIG. 18 shows an example work order report 1800 that details work orders associated with a nurse call system for a given facility. The document generation system 202 and/or the maintenance management system 204 can generate the work order report 1800 and cause the work order report 1800 to be presented on a user interface to a user via the computing device 330, for example. More specifically, the work order report 1800 details a variety of information about work orders specific to nurse call system errors that were resolved at the facility over a time period of one month. The document generation system 202 and/or the maintenance management system 204 can access the data needed to generate the work order report 1800 via the nurse call system database 208, for example. For each work order, the work order report 1800 details a work order identifier, a summary, a description, a priority level, an area type, an area name, a location, a category, a status, an open date and time, a closed date and time, a duration, and a person/entity that initiated the work order. The work order report 1800 can further provide details related to costs associated with resolving each work order. The document generation system 202 can use the work order report 1800 for various purposes in terms of compliance document generation and other compliance functionality as described herein.

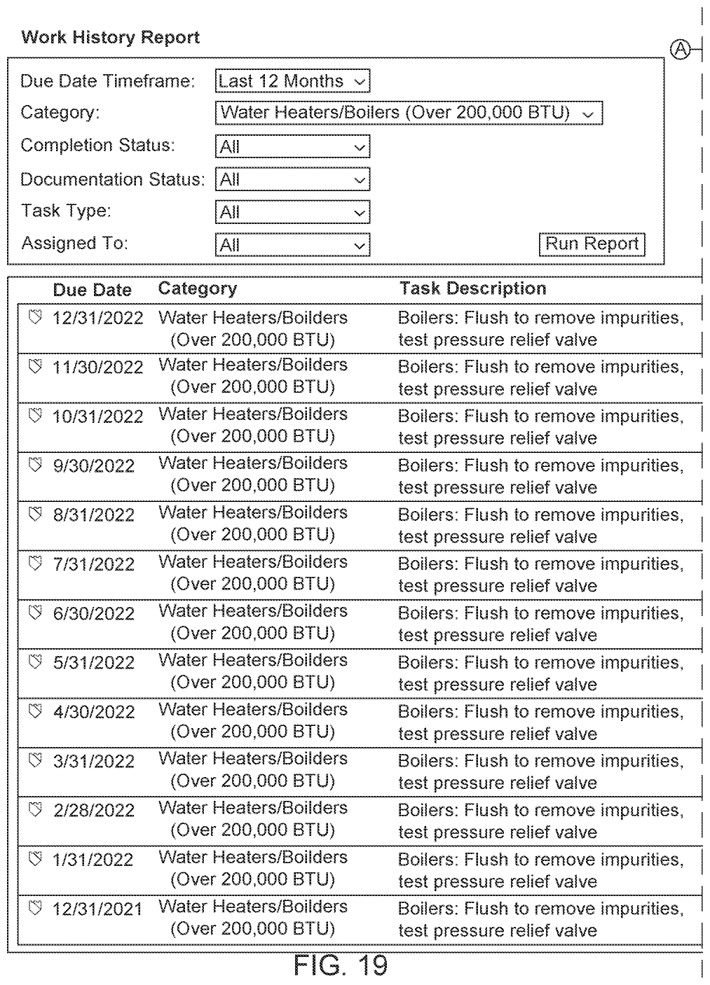

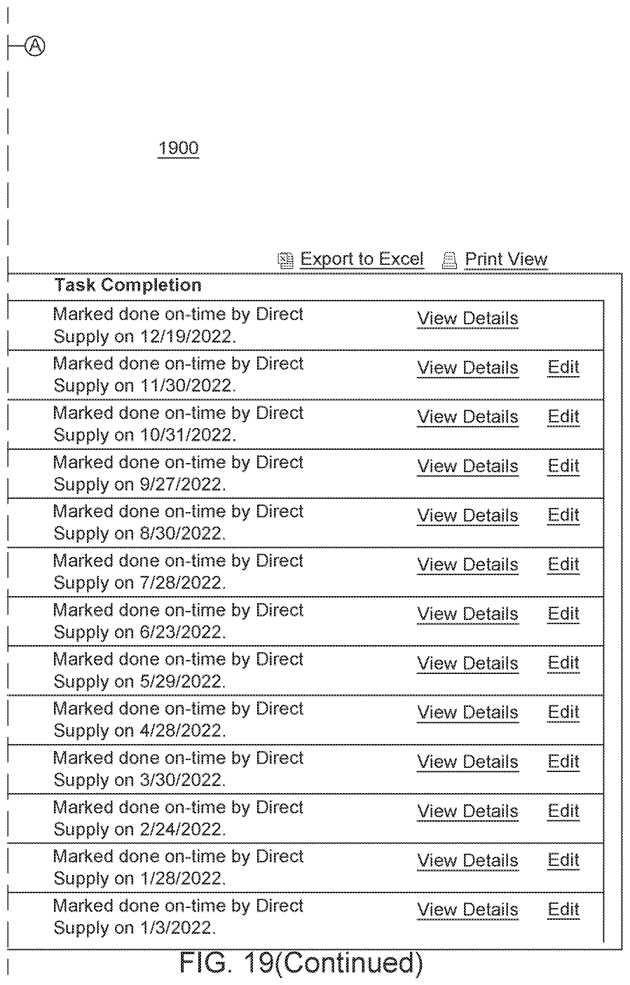

FIG. 19 shows an illustration of an example work history report 1900 associated with connected equipment for a given facility. The document generation system 202 and/or the maintenance management system 204 can generate the work history report 1900 and cause the work history report 1900 to be presented on a user interface to a user via the computing device 330, for example. More specifically, the work history report 1900 shows work history related to water heater inspections that have occurred at the facility within the past 12 months. The document generation system 202 and/or the maintenance management system 204 can access the data needed to generate the work history report 1900 via the connected equipment database 206, for example. For each entry in the work history report 1900, a variety of data associated with work performed can be included, such as a due date, a category, a task description, a task completion, and other details. The work history report 1900 as shown includes selectable user interface elements (e.g., links, etc.) that can be selected by the user to either edit the work history records or view additional details regarding the work history records. The work history report 1900 can be printed, exported to a specific file format, etc. for further viewing and digesting. Moreover, the document generation system 202 can use the work history report 1900 for various purposes in terms of compliance document generation and other compliance functionality as described herein.

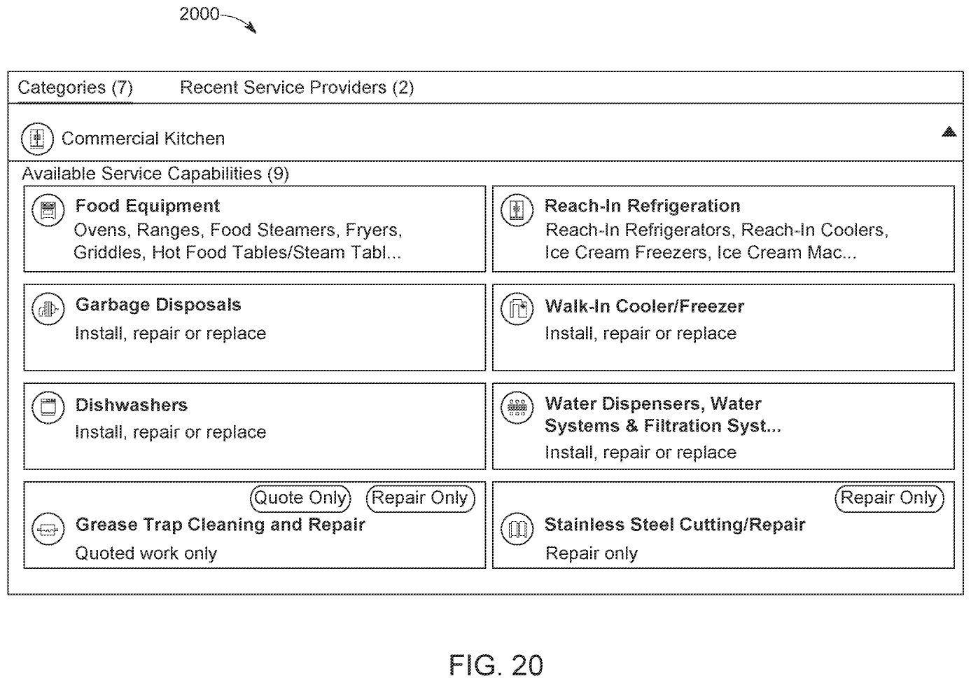

FIG. 20 shows an example service request user interface 2000 for requesting maintenance and requesting quotes for maintenance service for a facility. The maintenance management system 204 can cause the service request user interface 2000 to be presented to a user via the computing device 330, for example. As shown, the service request user interface 2000 includes a variety of selectable user interface elements associated with different categories of equipment. In the example service request user interface 2000 as shown in FIG. 20, the selected category is commercial kitchen equipment, and selectable user interface elements are presented for food equipment, reach-in refrigeration equipment, garbage disposal equipment, walk-in cooler and walk-in freezer equipment, dishwasher equipment, water equipment, grease trap equipment, and stainless-steel equipment. The service request user interface 2000 provides an example of a building services interface that can be presented by the maintenance management system 204. Various types of maintenance services that are scheduled via the service request user interface 2000 can be performed by maintenance personnel and documented in the maintenance management database 217, for example. Then, the document generation system 202 can use the data from the maintenance management database 217 for various purposes in terms of compliance document generation and other compliance functionality as described herein.

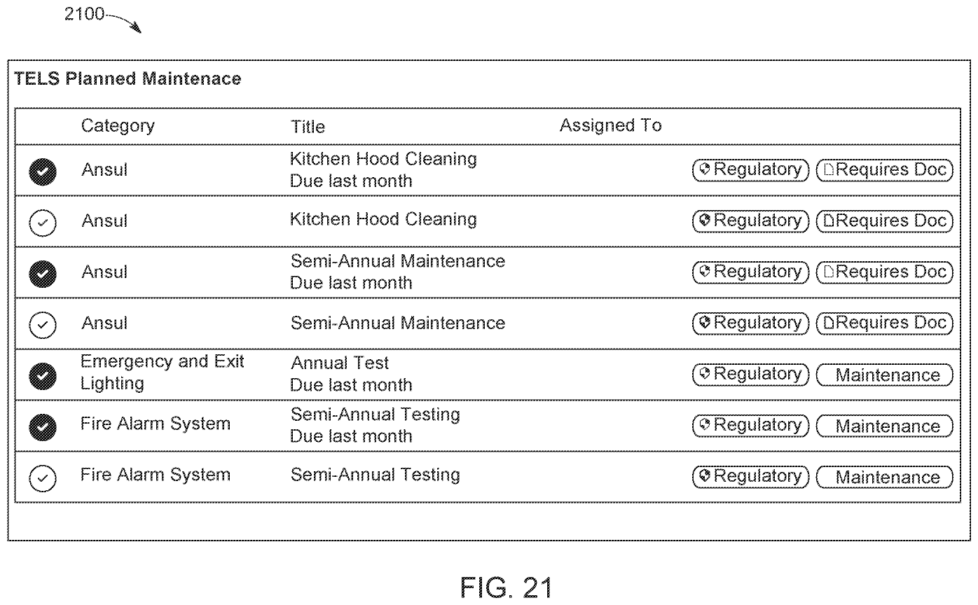

FIG. 21 shows an example planned maintenance user interface 2100 for managing testing, inspections, and maintenance for a facility. The maintenance management system 204 can cause the planned maintenance user interface 2100 to be presented to a user via the computing device 330, for example. For example, the planned maintenance user interface 2100 can be used to manage contracted services performed for the facility. As shown, the planned maintenance user interface 2100 documents various planned maintenance services for the facility, including kitchen hood clearing, fire alarm testing, and emergency and exit lighting testing services. The planned maintenance user interface 2100 shows a visual indication regarding the status of each maintenance service task (e.g., a green colored checkmark if completed, a white colored checkmark if not completed) so the user can easily identify maintenance tasks that need to be completed for various purposes.

The planned maintenance user interface 2100 also includes different visual indications showing whether planned maintenance tasks are required for regulatory purposes and whether documentation is required for regulatory purposes. These visual indicators can be interactive user interface elements that, in response to selection by a user, cause the planned maintenance user interface 2100 to display the relevant regulatory information and required documentation for a particular planned maintenance task, along with the steps being done to complete the maintenance task. The planned maintenance user interface 2100 can also present additional data related to planned maintenance tasks, such as a title, a description, personnel the task is assigned to, costs associated with the planned maintenance tasks, a due date (or indication that the task is past due), and other information. The planned maintenance user interface 2100 can be used by various facility personnel to facilitate handling of maintenance activities and documentation of maintenance activities for compliance document generation and other compliance functionality as described herein. The data associated with the planned maintenance activities can be stored in the maintenance management database 217, for example.

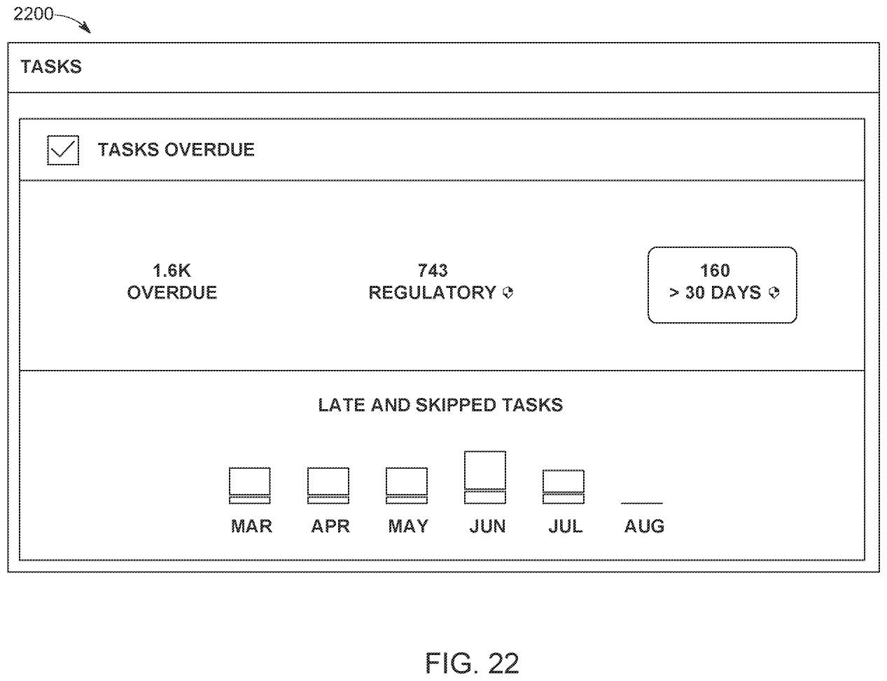

FIG. 22 shows an example interactive reporting dashboard user interface 2200 for one or more facilities. The maintenance management system 204 can cause the interactive reporting dashboard user interface 2200 to be presented to a user via the computing device 330, for example. The interactive reporting dashboard user interface 2200, as shown, provides regional and corporate oversight into facility performance on tasks and recommended training courses. The interactive reporting dashboard user interface 2200 highlights overdue and missed instances (e.g., late and skipped) that needed to be addressed for compliance and/or other purposes. The interactive reporting dashboard user interface 2200 can provide operators such as the first operator 222 and the second operator 224 with an overview of facility performance across a collection of facilities, for example. The interactive reporting dashboard user interface 2200 can include selectable user interface elements selectable by the user to view further details (e.g., specific to a given facility, specific to a task type, etc.) regarding overdue tasks and/or regulatory tasks that require attention. The interactive reporting dashboard user interface 2200, as shown, also provides an indicator of overdue tasks that are greater than 30 days overdue and a visual breakdown of late and skipped tasks by month. The interactive reporting dashboard user interface 2200 can help drive compliance for the one or more facilities by providing insight into facility performance on tasks at the regional and corporate levels, for example.

FIG. 23 shows an example administrative tools user interface 2300 that can be used by facility personnel to manage templates for compliance document generation. The document generation system 202 can cause the administrative tools user interface 2300 to be presented to a user via the computing device 330, for example. The administrative tools user interface 2300 can allow the user to update various compliance documentation templates as described herein for various purposes. For example, the administrative tools user interface 2300 can be used to update compliance documentation templates to account for changes in public citation data trends. Via the administrative tools user interface 2300, the user can add or edit instructions and explanations for completing different tasks, and the user can also insert various types of training materials (e.g., videos, etc.). The templates managed via the administrative tools user interface 2300 can then be populated using data from various sources (e.g., the different databases detailed above) to automatically generate compliance documentation for a facility and to perform other compliance-related functionality as described herein. In FIG. 23, the administrative tools user interface 2300 shows an example template for a mock survey, however it will be appreciated that various types of templates can be edited and managed in a similar manner.

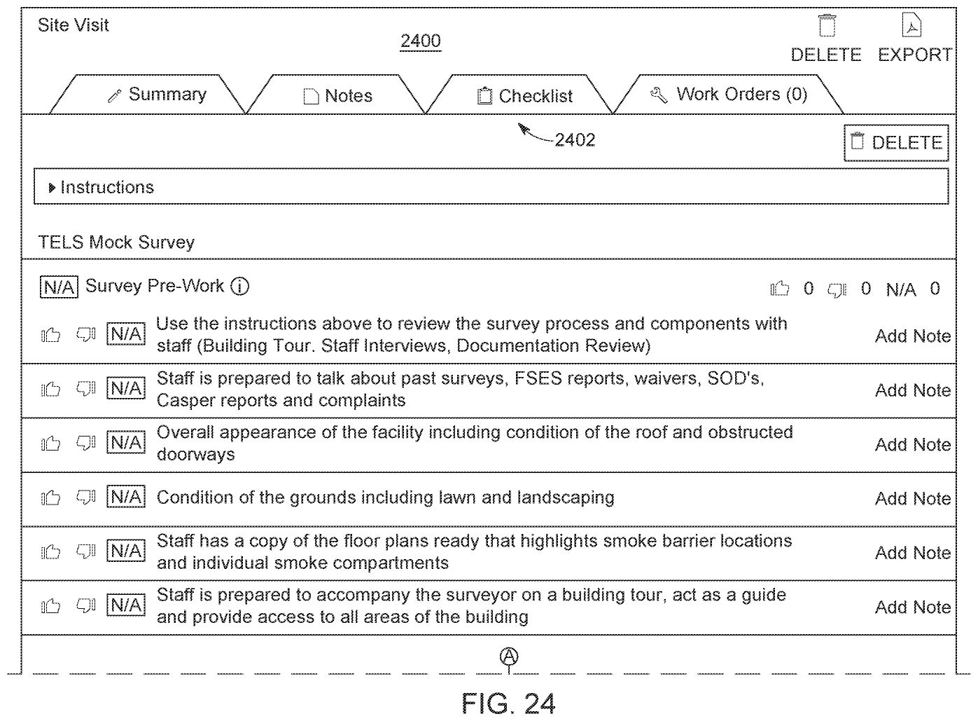

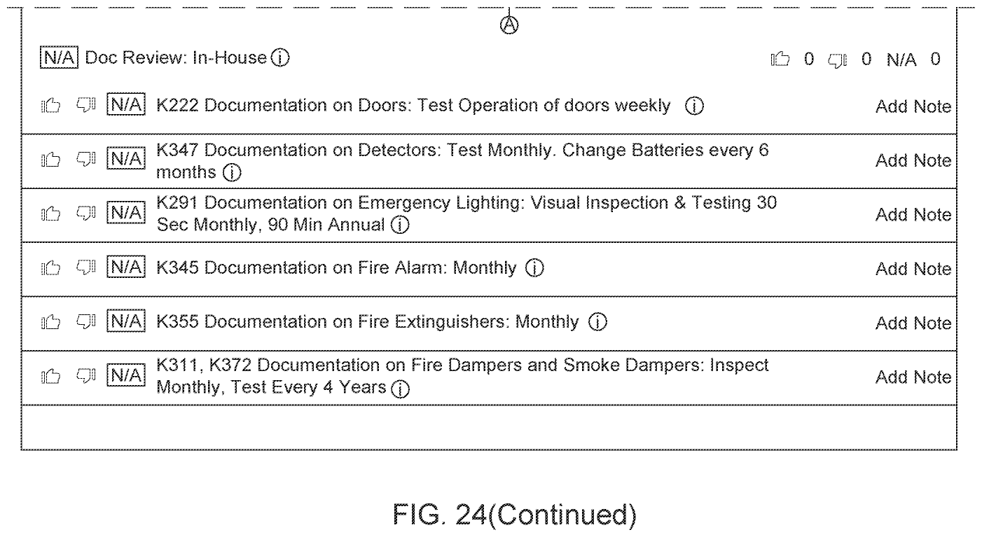

FIG. 24 shows an example of a mock survey checklist user interface 2400 that can be used by facility personnel to gauge facility compliance. The document generation system 202 can cause the mock survey checklist user interface 2400 to be presented to a user via the computing device 330, for example. The mock survey checklist user interface 2400 can be presented responsive to a selection of a checklist tab 2402 as shown near the top of the mock survey checklist user interface 2400. The mock survey checklist user interface 2400 includes a checklist of different tasks for performing by facility personnel to prepare for a compliance audit (survey). The checklist includes different tasks for survey pre-work as well as different tasks for document reviews. For example, the survey pre-work tasks are shown to include making sure the staff is prepared to talk about past events (e.g., surveys, reports, waivers, etc.), checking the overall appearance of the facility (including condition of the roof and obstructed doorways), and making sure the staff has a copy of the floor plans for the facility ready. The tasks for documents reviews include reviewing K222 documentation for operation of doors, reviewing K347 documentation on detectors, and reviewing K345 documentation on fire alarms, for example. The mock survey checklist user interface 2400 includes various selectable user interface elements for adding notes associated with different tasks and for viewing further details about different tasks in the checklist.

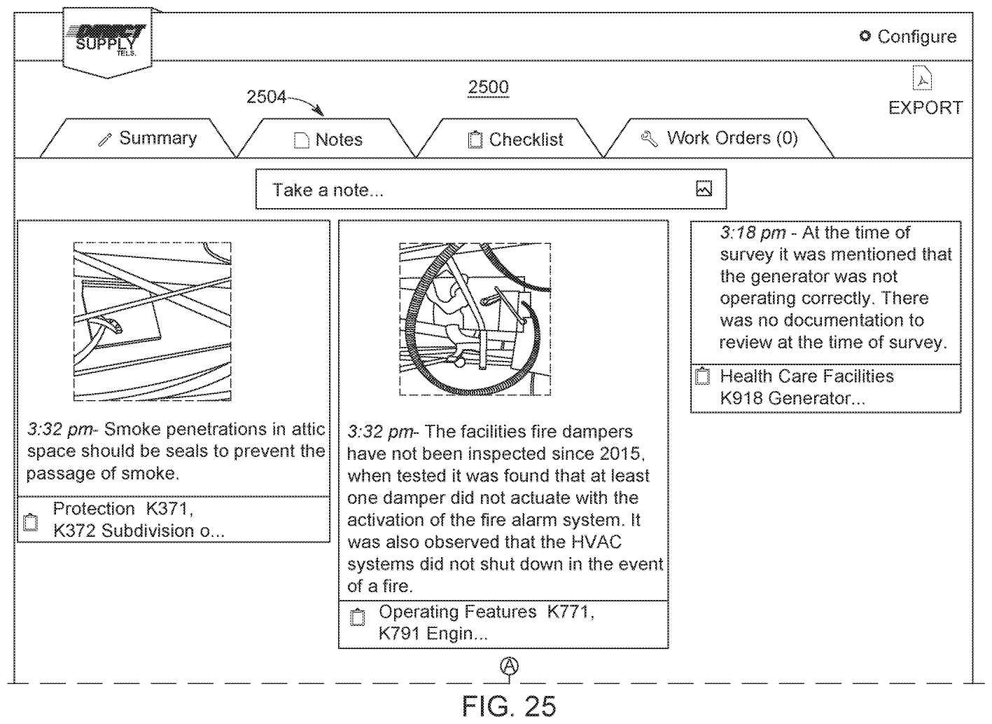

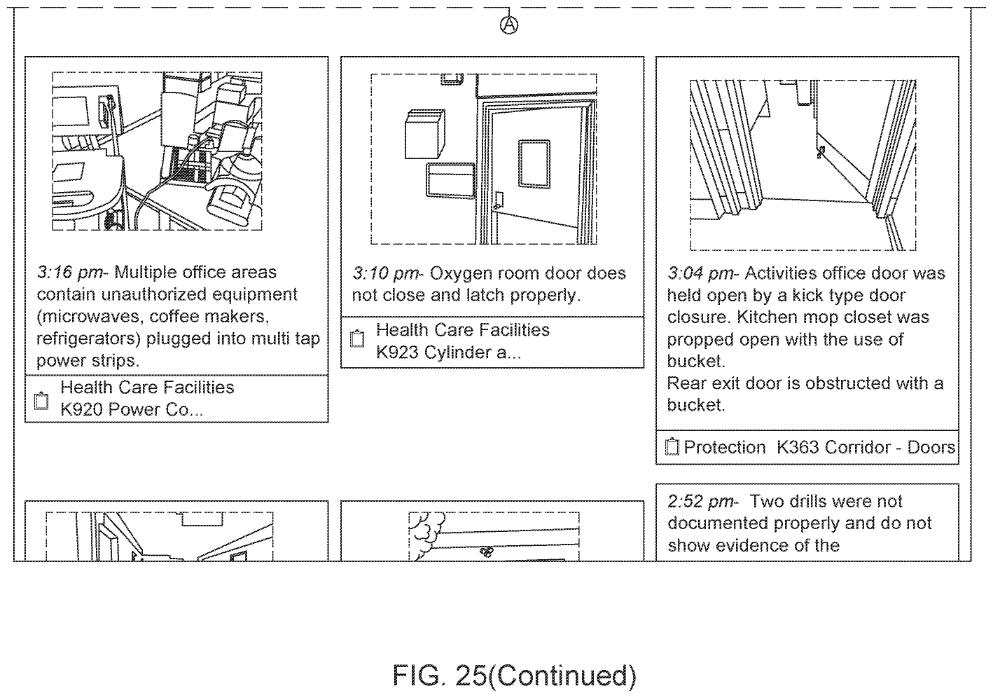

FIG. 25 shows an example mock survey notes user interface 2500 that can be used by facility personnel to record various details about a facility for compliance purposes. The document generation system 202 can cause the mock survey notes user interface 2500 to be presented to a user via the computing device 330, for example. The mock survey notes user interface 2500 can be presented responsive to a selection of a notes tab 2504 as shown near the top of the mock survey notes user interface 2500. Via the mock survey notes user interface 2500, the user can add a variety of different types of notes associated with a facility while performing a mock survey. As shown in FIG. 25, the notes can include captured photos with potential K-tags or other types of tags related to facility compliance. The notes entered via the mock survey notes user interface 2500 can serve as a potential data source when generating compliance documentation for various types of compliance inspections. The notes entered via the mock survey notes user interface 2500 can also be used to guide maintenance actions to resolve potential issues and help reduce citation risk in the event of a compliance inspection.

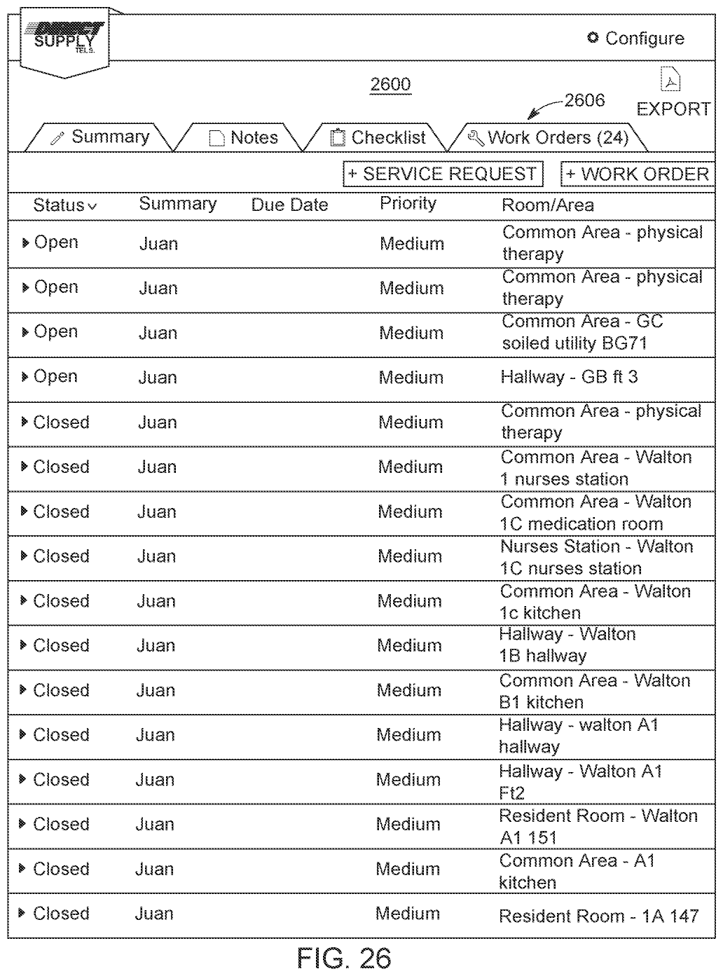

FIG. 26 shows an example mock survey work order user interface 2600 that can be used by facility personnel to manage work orders and/or service requests associated with a mock survey. The document generation system 202 can cause the mock survey work order user interface 2600 to be presented to a user via the computing device 330, for example. The mock survey work order user interface 2600 can be presented responsive to a selection of a work orders tab 2606 as shown near the top of the mock survey work order user interface 2600. Via the mock survey work order user interface 2600, the user can view a variety of information associated with different work orders and/or service requests associated with the mock survey, including the status, summary, due date, priority level, room/area, person assigned, and other information. Via the mock survey work order user interface 2600, the user can also easily create new work orders or service requests by selecting a selectable user interface element presented on the mock survey work order user interface 2600. For example, the user may find an issue with the facility when going through the checklist for the mock survey (e.g., via the mock survey checklist user interface 2400), and then the user may add a note associated with the issue via the mock survey notes user interface 2500 and/or create a work order to address the issue via the mock survey work order user interface 2600. The mock survey work order user interface 2600 can also present generated tasks, work orders, and recommendations for improved compliance based on a mock survey.

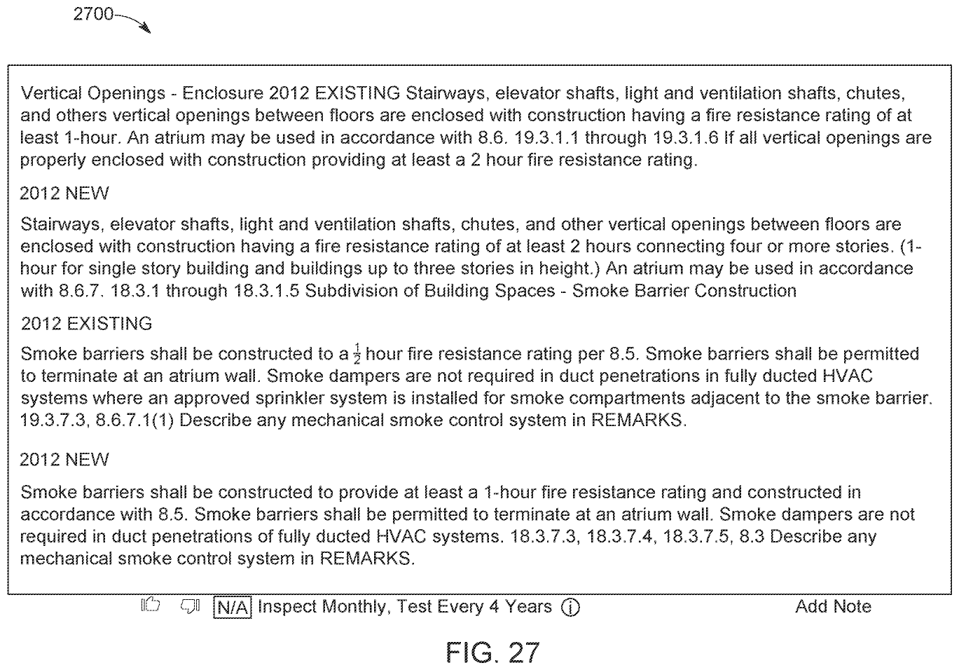

FIG. 27 shows an example task explanation user interface 2700 that can be used by facility personnel to complete tasks for a facility. The document generation system 202 can cause the task explanation user interface 2700 to be presented to a user via the computing device 330, for example. The task explanation user interface 2700 can be presented as part of a mock survey exercise responsive to the selection of a user interface element (e.g., a user interface element presented on the mock survey checklist user interface 2400). The example task explanation user interface 2700 as shown in FIG. 27 explains to the user how to complete tasks associated with different compliance requirements for fire safety. The task explanation user interface 2700 details both existing compliance requirements as well as new compliance requirements that capture recent changes in regulatory code, for example. The task explanation user interface 2700 identifies specific rules and regulations associated with different tasks and also provides a detailed explanation to the user such that the user does not need to be an expert in the regulatory code to complete the tasks.

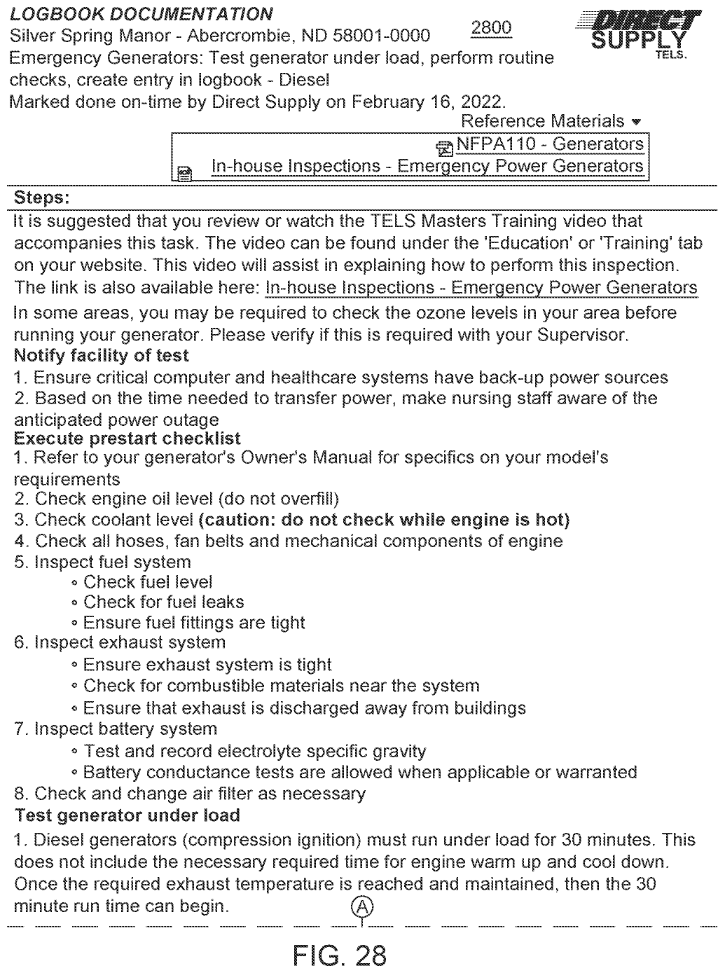

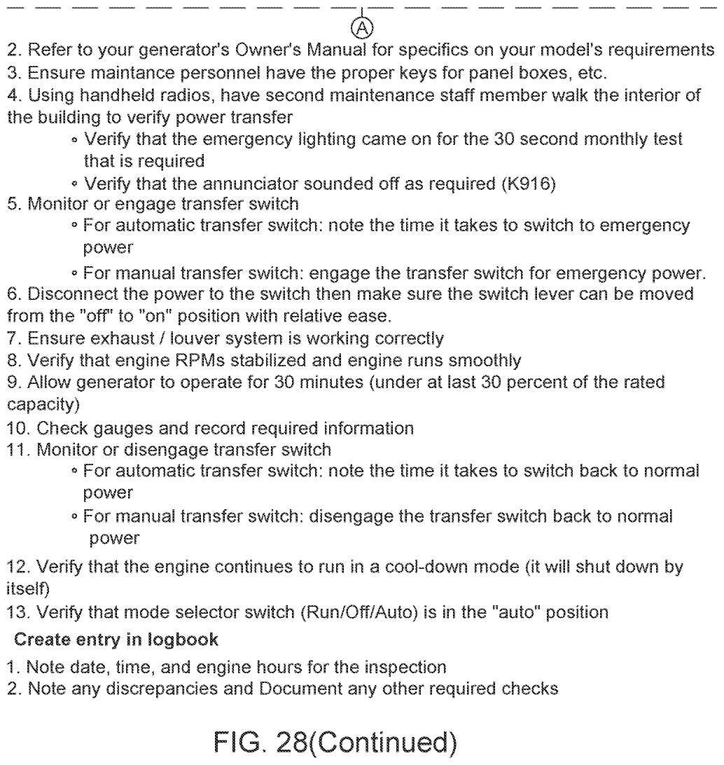

FIG. 28 shows an example best practice task explanation user interface 2800 that can be used by facility personnel to complete tasks for a facility. The document generation system 202 can cause the best practice task explanation user interface 2800 to be presented to a user via the computing device 330, for example. Via the best practice task explanation user interface 2800, the user can view a detailed explanation of how to complete a compliance-related task in accordance with best practices (e.g., as maintained via the best practices database 218). In the specific example shown in FIG. 28, the best practice task explanation user interface 2800 explains to the user how to test an emergency power generator for a facility. The best practice task explanation user interface 2800 includes a link to a video explanation as well as detailed steps that can be followed by the user to test the emergency power generator for the facility. The best practice task explanation user interface 2800 also provides reference materials (e.g., viewable and/or downloadable Portable Document Format (PDF) files, links, etc.) associated with the best practice task. The reference materials can include equipment specifications, details on the regulatory code, historical citation data associated with the best practice task, and other reference materials. The best practices database 218 can be used to maintain a best practices library including one or more tasks for each testing, inspection, and maintenance requirement associated with different compliance inspections. The best practice task explanation may also be automatically formatted properly for inclusion in generated compliance documentation to satisfy requirements.

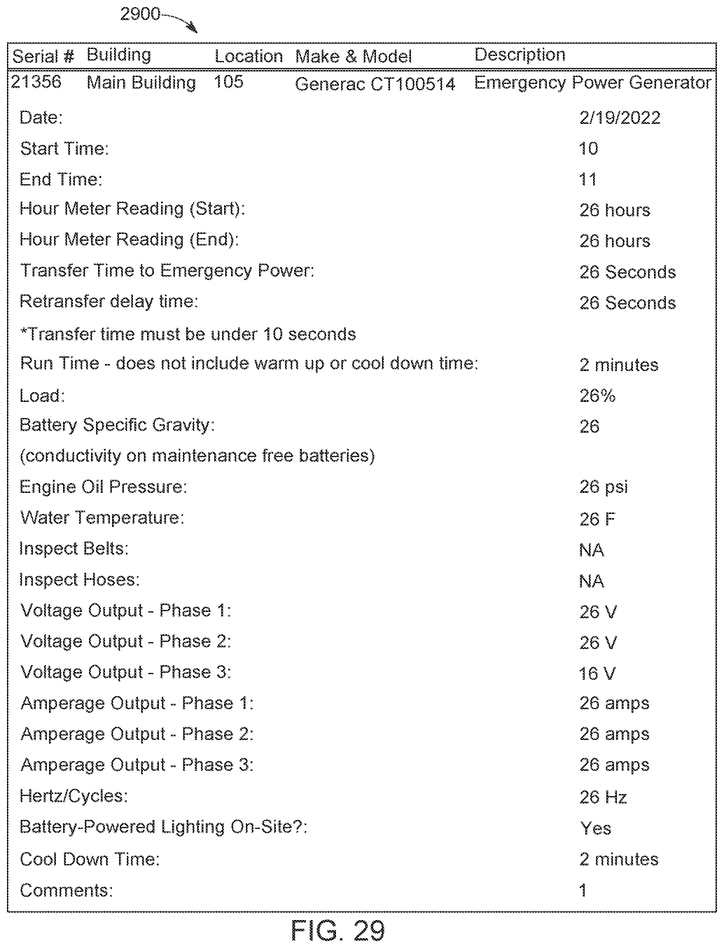

FIG. 29 shows an example best practice task logging user interface 2900 that can be used by facility personnel to document the results of performing a best practice task. The document generation system 202 can cause the best practice task logging user interface 2900 to be presented to a user via the computing device 330, for example. Via the best task logging user interface 2900, the user can enter and/or view data associated with a best practice task. In the specific example shown in FIG. 29, the best task logging user interface 2900 shows the results of testing an emergency power generator for a facility. As shown, the results presented via the best task logging user interface 2900 include a variety of parameters such as the load, the engine oil pressure, the water temperature, voltage and amperage outputs, and other information associated with the emergency power generator for the facility that can be used for logbook documentation. The results shown via the best task logging user interface 2900 can be used by the document generation system 202 to automatically generate properly formatted compliance documentation for a given compliance inspection and for other compliance functionality as described herein.

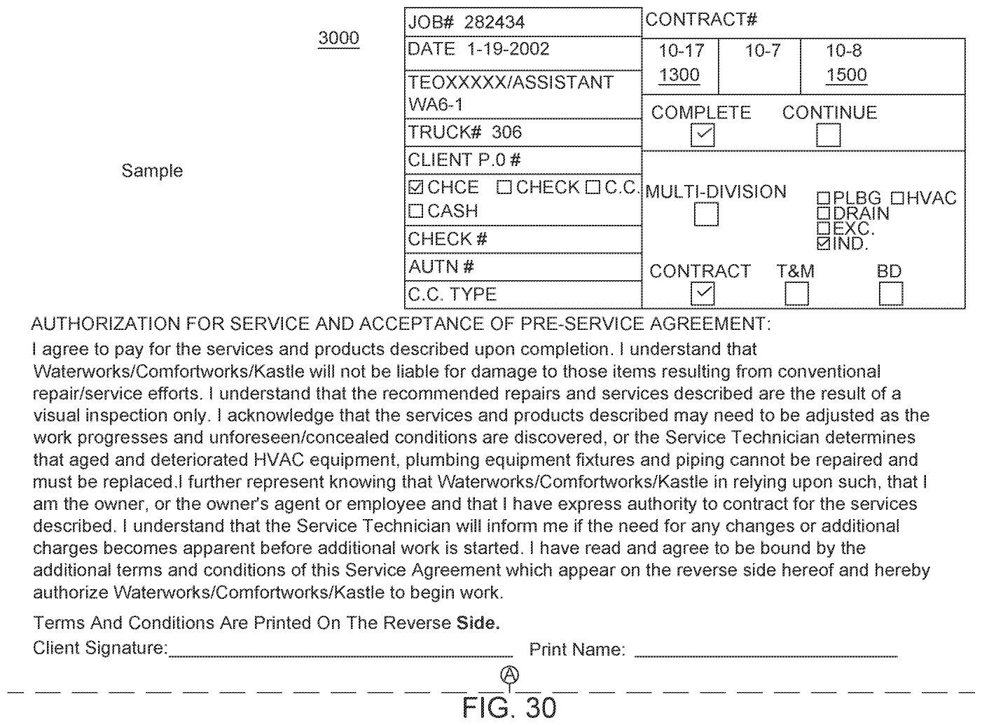

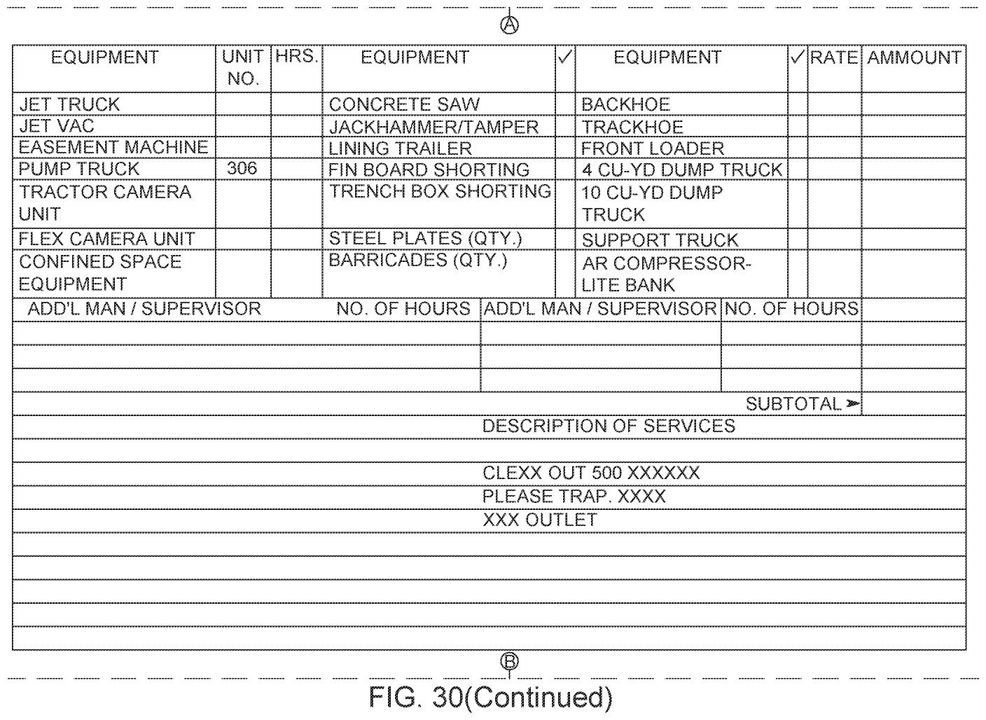

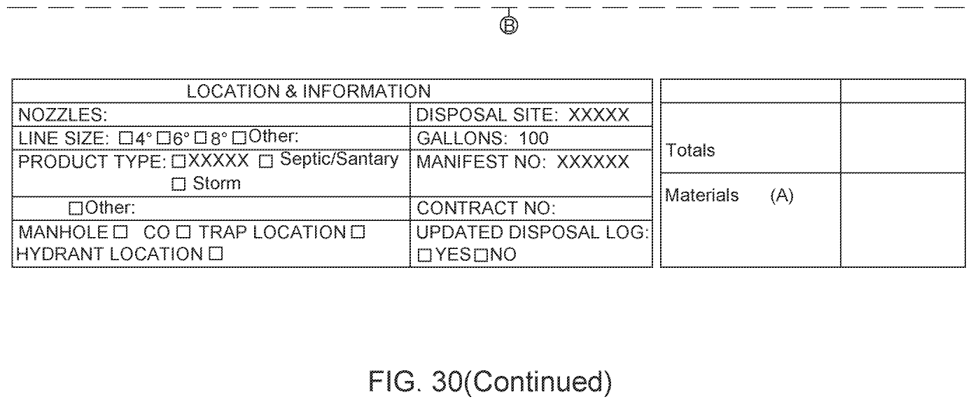

FIG. 30 shows an example paper document 3000 that can be maintained for facility compliance purposes. For example, the paper document 3000 can be uploaded to the document generation system 202, or the paper document 3000 can be stored on-site (e.g., in a binder) at a facility. The paper document 3000 generally details maintenance services performed by one or more of the service providers 226. In the specific example shown in FIG. 30, the paper document 3000 details services performed by an outside contractor to clean out a grease trap at a facility using a pump truck. The paper document 3000 details a date of service and other information associated with the work performed that may be required for various types of compliance inspections. In some examples, service providers 226 can alternatively enter the information from the paper document 3000 directly into the document generation system 202 and/or the maintenance management system 204 via a user interface. However, not all service providers 226 may use electronic documentation of work, and therefore the ability of the document generation system 202 to handle and maintain paper documents such as the paper document 3000 can be important for eliminating compliance gaps and also for generating appropriate compliance documentation for compliance inspections. In addition, some regulations require a “paper” copy including a signature from the technician as proof that the work was done. For example, for testing fire alarms, NFPA code requires a detailed report from the technician with date and signature, which can be uploaded into an electronic format for documentation purposes.

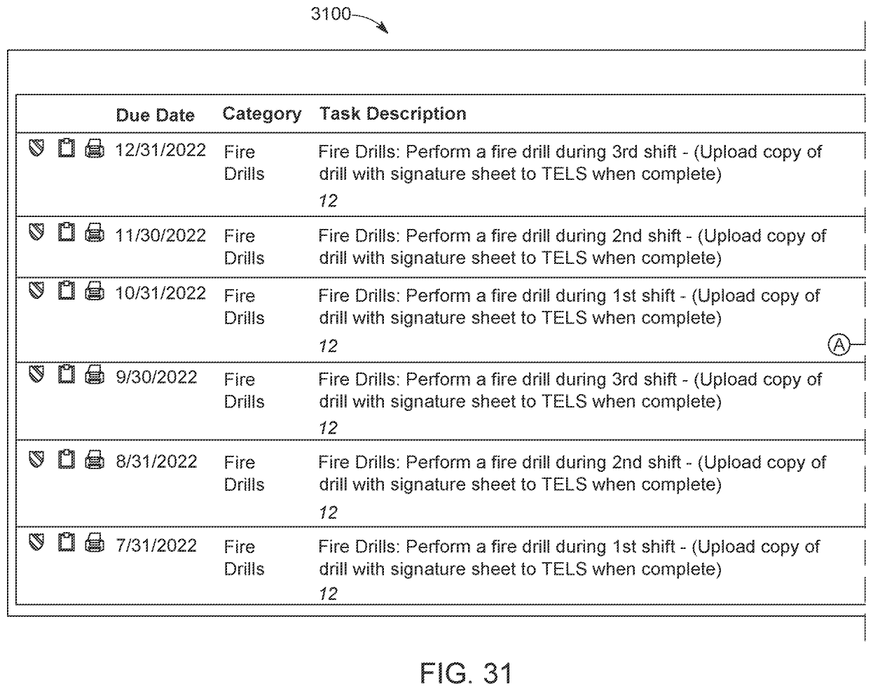

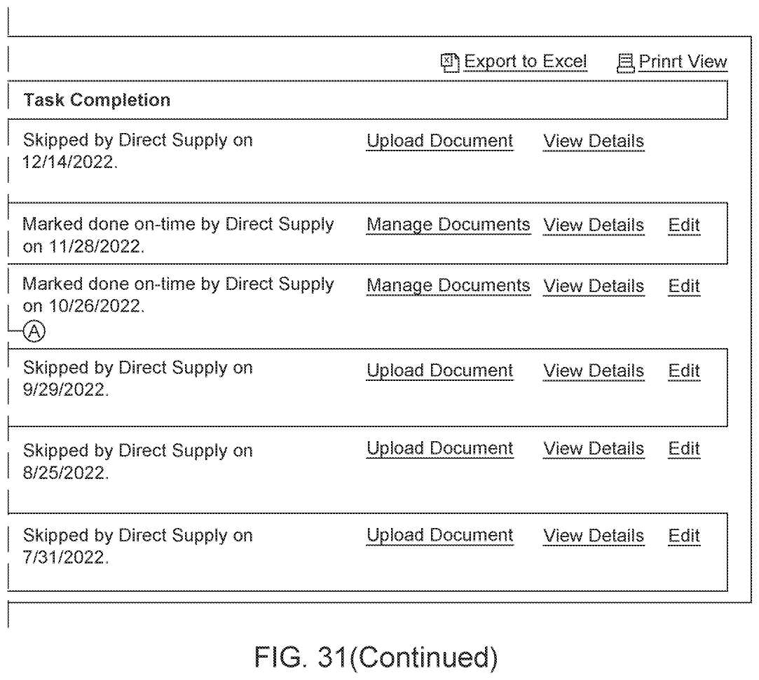

FIG. 31 shows an example task list user interface 3100 that can be used by facility personnel or surveyors to assess compliance gaps for a facility. The document generation system 202 can cause the task list user interface 3100 to be presented to a user via the computing device 330, for example. Via the task list user interface 3100, the user can view a variety of tasks that may be required for completion for compliance purposes (e.g., to address compliance gaps). Via the task list user interface 3100, the user can view details associated with each task such as a due date, a description, a completion status, and other information associated with the task. The user can also upload documents (e.g., logging documents including equipment testing details and results) via the task list user interface 3100. A surveyor can also view the task list user interface 3100 to view different documents associated with a given compliance inspection for a facility in order to evaluate the compliance of the facility with one or more regulations.

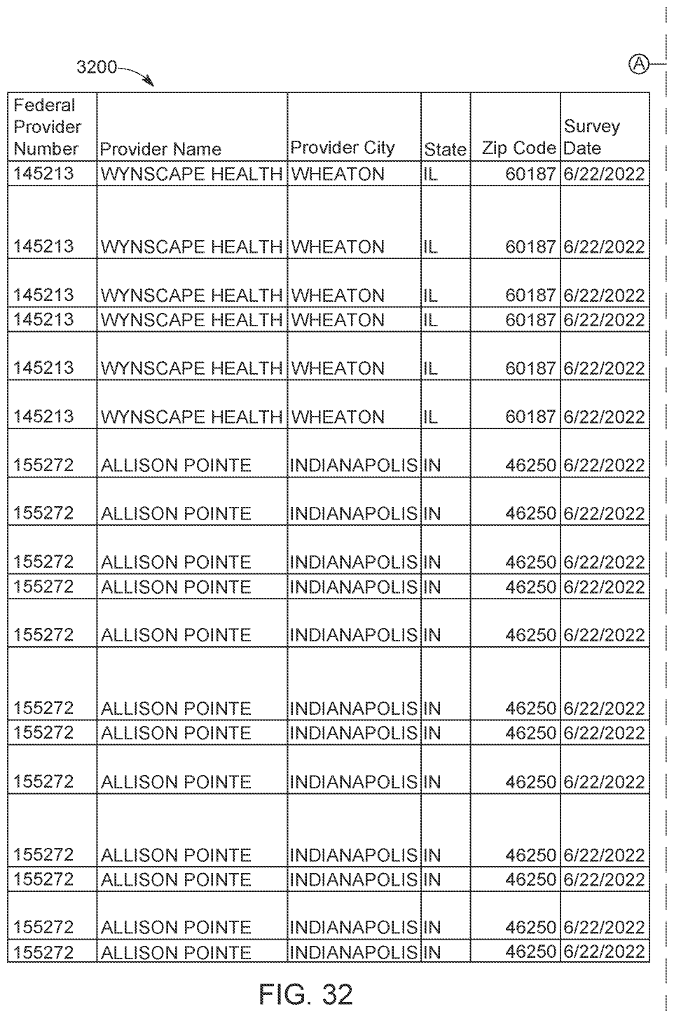

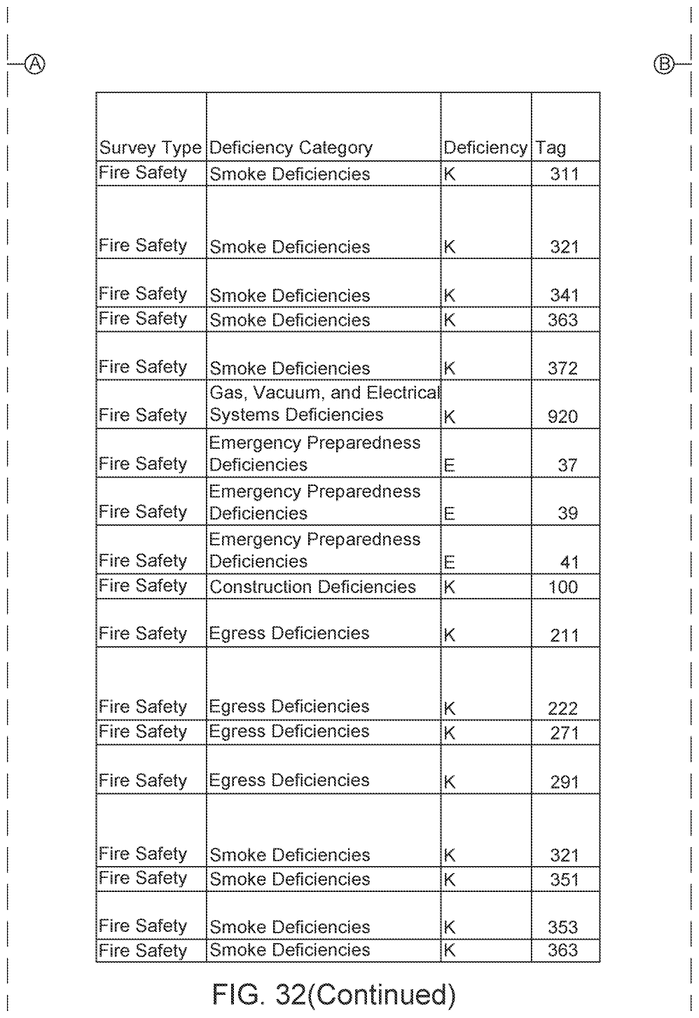

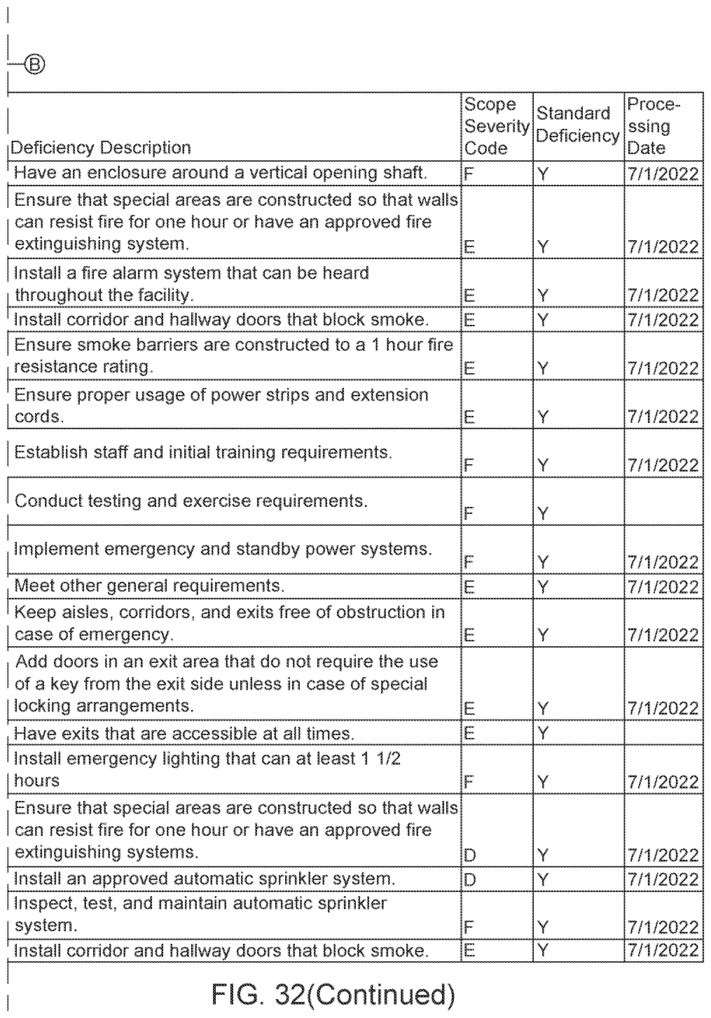

FIG. 32 shows an example citation report 3200 that details different citations issued by a regulatory entity. The document generation system 202 can generate the citation report 3200 using data retrieved from the citations database 216 and cause the citation report 3200 to be presented on a user interface to a user via the computing device 330, for example. The citation report 3200 provides an example of public citation data that can be accessed by the document generation system 202 and stored in the citations database 216. The user can view a variety of information via the citation report 3200, and the document generation system 202 can utilize a variety of information via the citation report 3200, including facility, location, survey information, deficiency descriptions, citation dates and codes, severity codes, and other citation information. In the specific example shown in FIG. 32, the citation report 3200 details citations issued by the Centers for Medicare & Medicaid Services (CMS). As described above, citation data such as the citation report 3200 can be used by the document generation system 202 to identify citation trends and proactively facilitate facility compliance based on the citation trends to reduce citation risk for the facility.

FIG. 33 shows another example citation report 3300 that details a specific citation issued by a regulatory entity. The document generation system 202 can generate the citation report 3300 using data retrieved from the citations database 216 and cause the citation report 3300 to be presented on a user interface to a user via the computing device 330, for example. The user can upload the citation report 3300 to the document generation system 202 such that the citation report 3300 can be accessed and managed electronically. Via the citation report 3300, users can view specific details associated with a given citation issued by the regulatory entity. For example, as shown in FIG. 33, the citation report 3300 not only provides a detailed explanation of a deficiency identified by a surveyor pertaining to a Post Indicator Valve (PIV), but it also provides a K-Tag. and a plan of correction for following to address the deficiency pertaining to the PIV. After uploading the citation report 3300, the user can enter the plan of correction in manually via a user interface, or the document generation system 202 can generate a recommended plan of correction based on an analysis of the citation report 330. The document generation system 202 can then add details associated with the plan of correction to the citation report 3300, or otherwise associated data associated with the plan of correction to the citation report 3300 within the document generation system 202. Responsive to receiving the citation report 3300, the maintenance management system 204 can also generate corresponding tasks or work orders. Detailed reports such as the citation report 3300 can be used by facility personnel to gain insight into why citations might be issued and what steps they can take to avoid receiving similar citations.

Another interactive report that can be generated by the document generation system 202 and/or the maintenance management system 204 and presented to a user via a user interface can present the most common citations that have recently been issued based on an aggregate of citation data from the citations database 216. The most common citations can be displayed, prioritized, and/or filtered based on various factors including type of facility, region, severity, recency, AHJ, etc. The user can also filter based on a specific facility to get insight into citations for each facility in an organization. The report can display a graphical visualization of the trends (e.g., a line chart) for each citation to see the change in number of occurrences of the citation over time. The report can provide recommendations and/or guidance for each citation based in part on surveyor notes (e.g., the “Summary Statement of Deficiencies” from the example citation report 3300) from the aggregated citations (and associated rules and regulations) to provide insight into why the citation might be issued and what steps they can take to avoid receiving similar citations (e.g., using a statistical or language model (large language model, etc.) to process surveyor citation notes and associated rules and regulations).

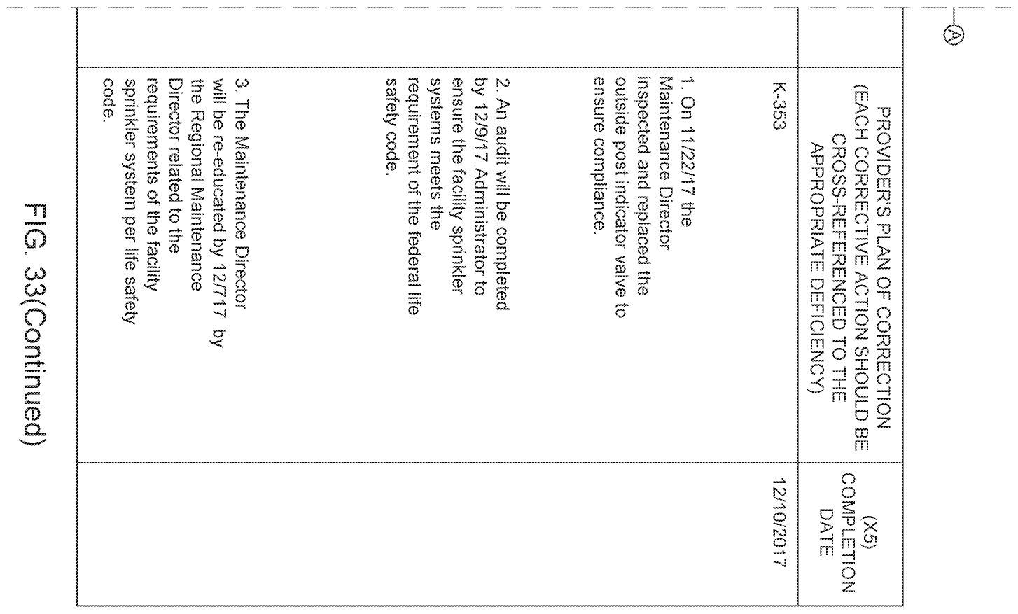

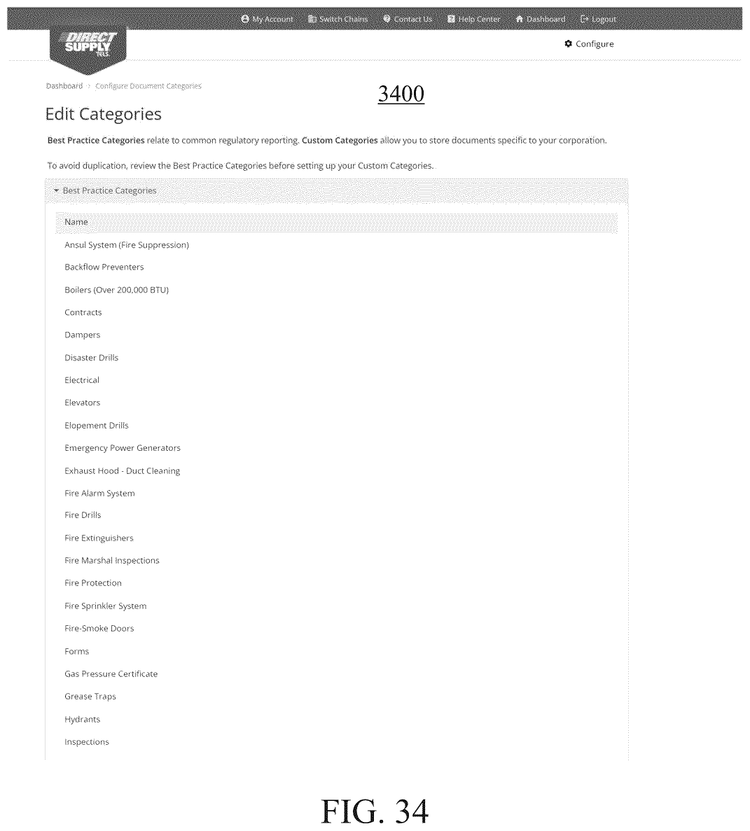

FIG. 34 shows an example best practice categories user interface 3400 that can be used by facility personnel to configure best practice categories. The document generation system 202 and/or the maintenance management system 204 can cause the best practice categories user interface 3400 to be presented to a user via the computing device 330, for example. Via the best practice categories user interface 3400, the user can view a standard set of best practice categories associated with a given type of facility or organization. The standard set of best practice categories in some examples are not editable by the user, but instead are included in each implementation of document generation system 202 and/or the maintenance management system 204 to provide a baseline level of best practice functionality. The standard best practice categories can represent different categories of documents related to common regulatory reporting requirements. Data associated with the standard best practice categories can be maintained in the best practices database 218, for example.

FIG. 35 shows another example best practice categories user interface 3500 that can be used by facility personnel to configure best practice categories. The document generation system 202 and/or the maintenance management system 204 can cause the best practice categories user interface 3500 to be presented to a user via the computing device 330, for example. Via the best practice categories user interface 3500, the user can add, edit, and delete custom best practice categories. For example, as shown, the user can configure custom best practice categories for an air quality initiative, for building floor plans, for corporate training materials, and/or for emergency preparedness. Depending on the type of facility, location of the facility, compliance trends for a facility or organization, and/or other possible factors, the ability to configure custom best practices can provide more dynamic and configurable functionality of the document generation system 202 and/or the maintenance management system 204. The custom best practice categories can represent different categories of documents related to more particular (e.g., facility or organization specific) regulatory reporting requirements than the standard best practice categories. The custom best practice categories can be configured to pull in documentation from multiple sources, such as detailed above, to generate custom compliance documentation. Data associated with custom best practice categories can be maintained in the best practices database 218, for example.

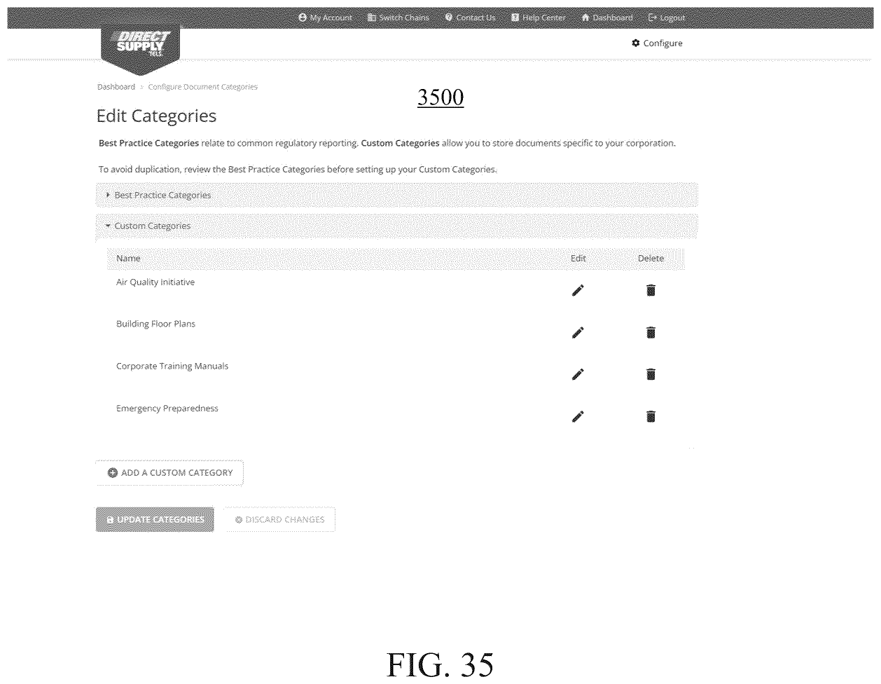

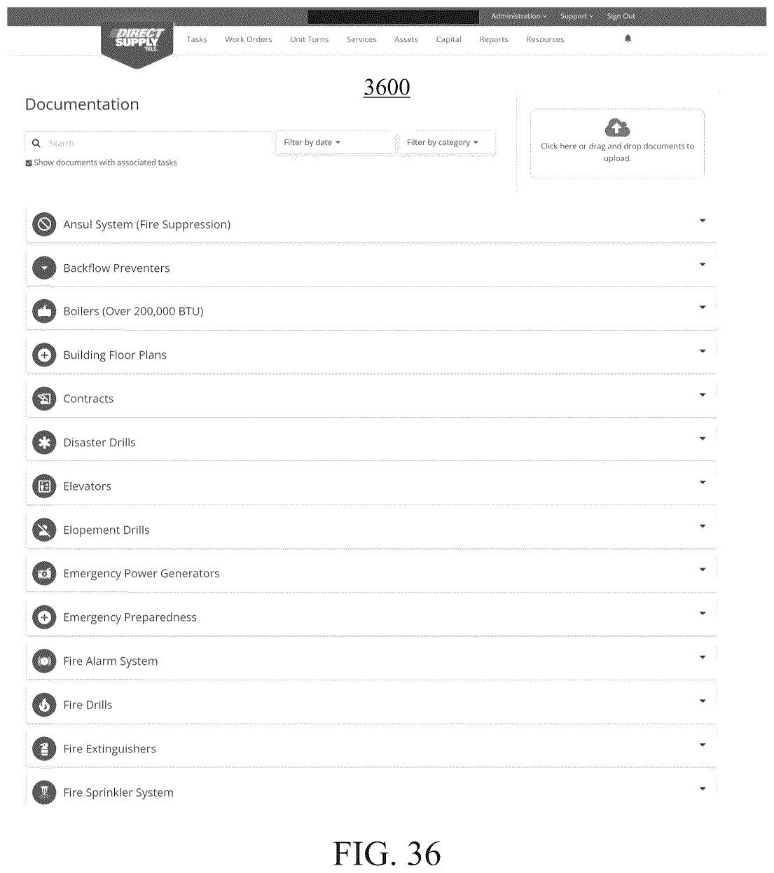

FIG. 36 shows an example compliance documentation overview user interface 3600 that can be used by facility personnel to view and manage compliance documents. The document generation system 202 and/or the maintenance management system 204 can cause the compliance documentation overview user interface 3600 to be presented to a user via the computing device 330, for example. Via the compliance documentation overview user interface 3600, the user can view historical compliance documentation in a variety of categories for a given facility, group of facilities, and/or organization. For example, the user can view compliance documentation related to elevators, emergency power generators, fire drills, etc. As shown, each category of compliance documentation can be presented as a selectable user interface element (e.g., a drop down list) via the compliance documentation overview user interface 3600. Moreover, via the compliance documentation overview user interface 3600, the user can also search (e.g., via text input) for compliance documents, filter compliance documents (e.g., by date, by category, etc.), and upload compliance documents for maintaining electronically.

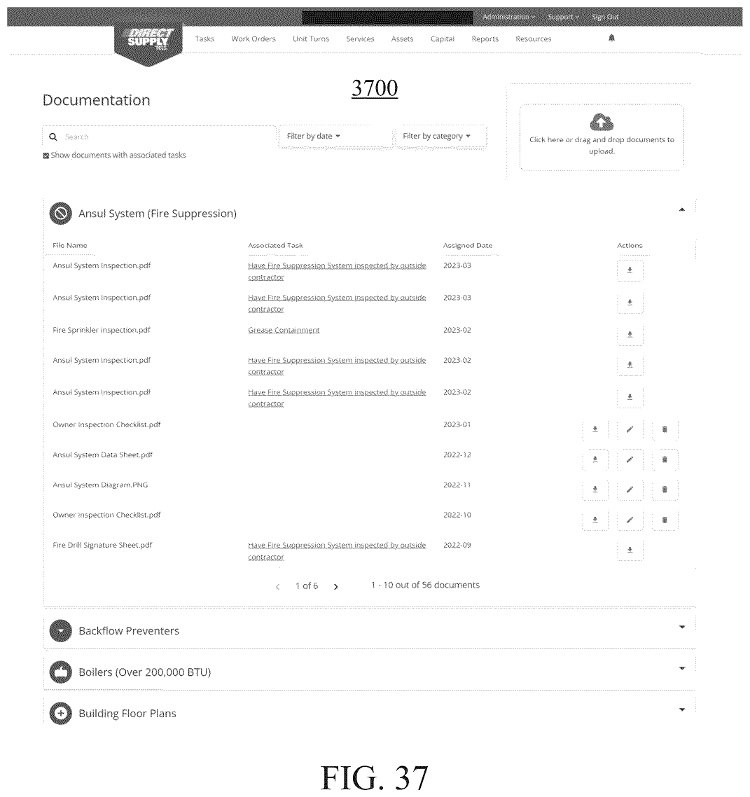

FIG. 37 shows another example compliance documentation overview user interface 3700 that can be used by facility personnel to view and manage compliance documents. The document generation system 202 and/or the maintenance management system 204 can cause the compliance documentation overview user interface 3700 to be presented to a user via the computing device 330, for example. Specifically, the compliance documentation overview user interface 3700 shows example functionality when the user selects a particular category of compliance documentation. In this case, as shown, the user has selected the fire suppression category. As a result of selecting the fire suppression category, the user can see that 56 compliance documents related to fire suppression are stored electronically. Each document can include a file name, an associated task, and an assigned date. Moreover, via the compliance documentation overview user interface 3700, the user can perform actions associated with different compliance documents related to fire suppression via individual selectable user interface elements. For example, the user can download, edit, and/or delete individual documents via the selectable user interface elements.

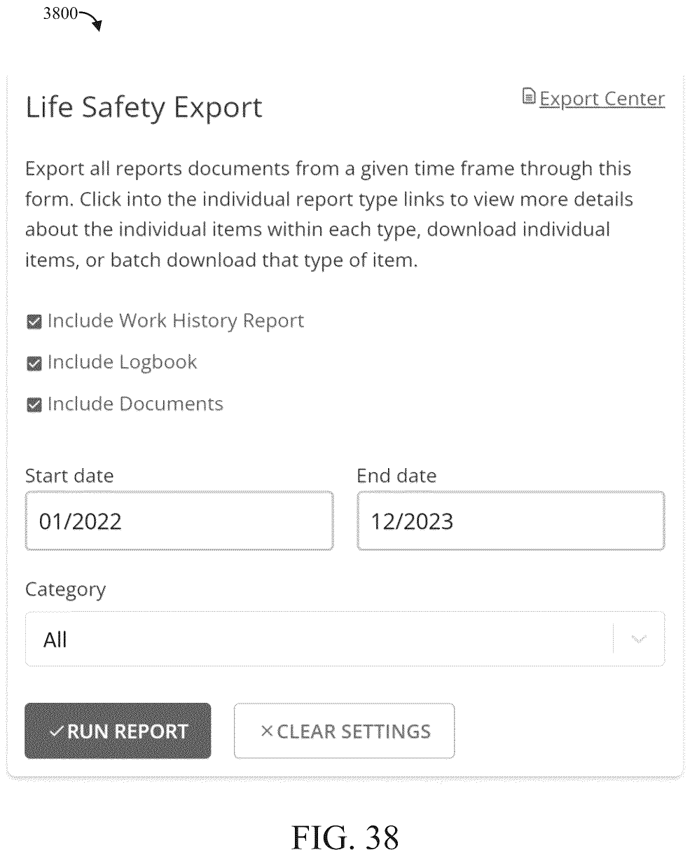

FIG. 38 shows an example mega pull user interface 3800 that can be used by facility personnel to grab all documentation and other inputs related to compliance parameters specified by the user. The document generation system 202 can cause the mega pull user interface 3800 to be presented to a user via the computing device 330, for example. Via the mega pull user interface 3800, the user can specify various parameters related to a specific compliance “mega pull”. For example, as shown, the user initiates a life safety export that pulls all report documents for a specified time frame. The mega pull can return work history reports, logbook reports, compliance documents, and/or other inputs or documents in all categories related to life safety with the click of a single button. This functionality provided by the document generation system 202 can allow users to efficiently and thoroughly access all electronically stored documents related to specified parameters via a simple interface to facilitate compliance practices.

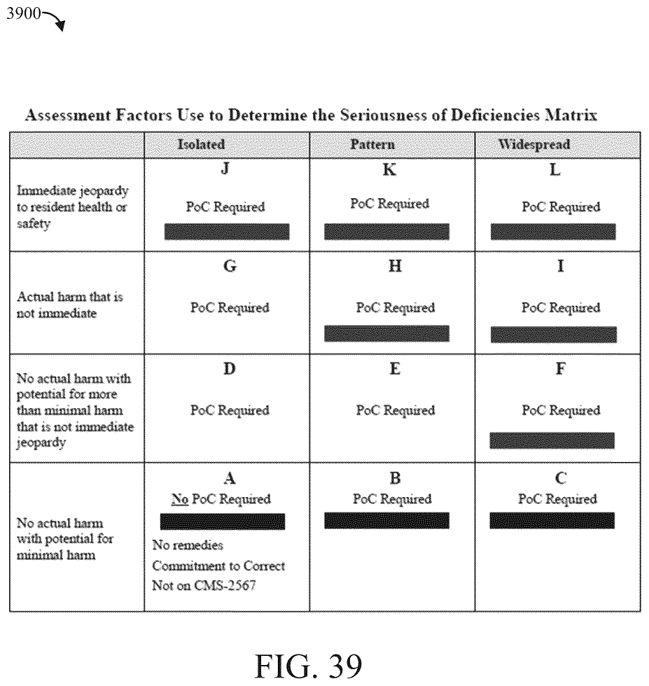

FIG. 39 shows an example severity matrix 3900 that can be used to determine the severity of compliance gaps and/or violations for a facility or organization. The severity matrix 3900 is associated specifically with CMS code and regulations. However, the severity matrix 3900 provides an example indicating how severity scores can be generated by the document generation system 202 and/or the maintenance management system 204 to prioritize tasks and/or work orders for completion. As noted, when the document generation system 202 and/or the maintenance management system 204 identify compliance gaps, the compliance gaps can be scored according to severity based on factors including citation risk, a continuum of service, a cost, and/or a past-due time period associated with the compliance gap. In some examples, as reflected in the severity matrix 3900, the scores can be indicative of whether compliance gaps are isolated gaps, part of a pattern of gaps, or part of a widespread phenomenon of gaps (e.g., across an entire organization). Further, the scores can be indicative of whether the gaps cause immediate jeopardy to resident health or safety, actual harm that is not immediate, no actual harm but potential for more than minimal harm that is not in immediate jeopardy, or no actual harm with only the potential for minimal harm.

Although the invention has been described and illustrated in the foregoing illustrative examples, it is understood that the present disclosure has been made only by way of example, and that numerous changes in the details of implementation of the invention can be made without departing from the spirit and scope of the invention, which is limited only by the claims that follow. Features of the disclosure can be combined and rearranged in various ways.

1. A non-transitory computer-readable storage medium having instructions stored thereon that, when executed by at least one processor, cause the at least one processor to implement operations comprising:
causing a user interface to be presented to a user via a user device;
receiving a request to perform a compliance inspection for a healthcare facility from the user via the user device;
retrieving first data for the compliance inspection from a first source associated with a first entity, the retrieved first data comprising work orders that were completed at the healthcare facility within a first time period;
retrieving second data for the compliance inspection from a second source different from the first source and associated with a second entity different from the first entity, the retrieved second data comprising maintenance requests that were submitted for the healthcare facility within a second time period;
retrieving third data for the compliance inspection from a third source different from the first source and the second source and associated with a third entity different from the first entity and the second entity, the retrieved third data comprising alerts generated by nurse call devices in the healthcare facility;
identifying a compliance gap for the healthcare facility by evaluating the retrieved first data, the retrieved second data, and the retrieved third data using compliance documentation logic;
identifying both a first task for completion and a second task for completion in order to address the compliance gap for the healthcare facility;
applying both the first task and the second task as input to a machine learning model to generate a priority ranking of the first task and the second task based on an output of the machine learning model;
causing the user interface to present the first task and the second task to the user via the user device in accordance with the priority ranking;
receiving a user input associated with at least one of the first task or the second task from the user via the user device;
generating compliance documentation for the compliance inspection in a format such that the compliance documentation can be appropriately provided to an authority having jurisdiction over the compliance inspection to document compliance of the healthcare facility based on the retrieved first data, the retrieved second data, the retrieved third data, and the user input; and
causing the user interface to provide the compliance documentation for the compliance inspection to the user via the user device.

2. The computer-readable medium of claim 1, wherein the compliance inspection comprises a Joint Commission survey, a state surveyor survey, an insurance broker survey, or a Centers for Medicare and Medicaid Services survey.

3. The computer-readable medium of claim 1, wherein generating the compliance documentation for the compliance inspection comprises populating a documentation template associated with the authority having jurisdiction over the compliance inspection using the retrieved first data, the retrieved second data, the retrieved third data, and the user input.

4. The computer-readable medium of claim 1, the operations further comprising retrieving fourth data from a fourth source different from the first source, the second source, and the third source and associated with a fourth entity different from the first entity, the second entity, and the third entity, the retrieved fourth data comprising historical healthcare facility citation data associated with a fourth time period, wherein:
identifying the compliance gap for the healthcare facility comprises identifying the compliance gap for the healthcare facility by evaluating the retrieved fourth data using the compliance documentation logic; and
generating the compliance documentation for the compliance inspection comprises generating the compliance documentation for the compliance inspection based on the retrieved fourth data.

5. The computer-readable medium of claim 4, wherein retrieving the data from the fourth source comprises at least one of:
retrieving the fourth data from a public citation database; or
retrieving the fourth data as an upload from the user via the user device.

6. The computer-readable medium of claim 4, the operations further comprising retrieving fifth data comprising sensor data associated with equipment in the healthcare facility, wherein:
identifying the compliance gap for the healthcare facility comprises identifying the compliance gap for the healthcare facility by evaluating the retrieved fifth data using the compliance documentation logic; and
generating the compliance documentation for the compliance inspection comprises generating the compliance documentation for the compliance inspection based on the retrieved fifth data.

7. The computer-readable medium of claim 1, wherein causing the user interface to present the first task and the second task comprises causing the user interface to present a mock survey report to the user via the user device, the mock survey report mimicking the compliance inspection and comprising an explanation of how to complete the first task and the second task.

8. The computer-readable medium of claim 1, wherein identifying the compliance gap for the healthcare facility by evaluating the retrieved first data, the retrieved second data, and the retrieved third data using the compliance documentation logic comprises identifying the compliance gap for the healthcare facility by evaluating the retrieved first data, the retrieved second data, and the retrieved third data using rules specific to the compliance inspection.

9. The computer-readable medium of claim 4, wherein the first time period, the second time period, the third time period, and the fourth time period are equal time periods.

10. The computer-readable medium of claim 1, wherein:
causing the user interface to present the first task and the second to the user via the user device comprises indicating that a product needs to be purchased to address the compliance gap for the healthcare facility; and
the user input associated with at least one of the first task or the second task from the user via the user device comprises receiving a purchase order for the product.

11. The computer-readable medium of claim 1, wherein:
causing the user interface to present the first task and the second to the user via the user device comprises indicating that a maintenance task needs to be performed to address the compliance gap for the healthcare facility; and
receiving the user input associated with at least one of the first task or the second task from the user via the user device comprises receiving a work order for completing the maintenance task.

12. The computer-readable medium of claim 1, wherein:
the output of the machine learning model comprises a first score for the first task and a second score for the second task;
the first score is indicative of a severity level of the first task and is based on at least one of a citation risk, a continuum of service, a cost, or a past-due time period associated with the first task;
the second score is indicative of a severity level of the second task and is based on at least one of a citation risk, a continuum of service, a cost, or a past-due time period associated with the second task; and
the priority ranking of the first task and the second task is based on the first score and the second score.

13. The computer-readable medium of claim 12, wherein the machine learning model comprises a probabilistic neural network.

14. The computer-readable medium of claim 4, the operations further comprising causing the user interface to present the retrieved fourth data comprising the historical healthcare facility citation data associated with the fourth time period to the user via the user device.

15. The computer-readable medium of claim 12, the operations further comprising causing the user interface to present a graphical visual representation based on the first score and the second score to the user via the user device.

16. A computer-implemented method, comprising:
causing a user interface to be presented to a user via a user device;
receiving a request to perform a compliance inspection for a healthcare facility from the user via the user device;
retrieving first data for the compliance inspection from a first source associated with a first entity, the retrieved first data comprising work orders related to life safety incidents that were completed at the healthcare facility within a first time period;
retrieving second data for the compliance inspection from a second source different from the first source and associated with a second entity different from the first entity, the retrieved second data comprising maintenance requests submitted by residents of the healthcare facility within a second time period;
retrieving third data for the compliance inspection from a third source different from the first source and the second source and associated with a third entity different from the first entity and the second entity, the retrieved third data comprising alerts generated by nurse call devices in the healthcare facility within a third time period;
identifying a compliance gap for the healthcare facility by evaluating the retrieved first data, the retrieved second data, and the retrieved third data using compliance documentation logic;
identifying both a first task for completion and a second task for completion in order to address the compliance gap for the healthcare facility;
applying both the first task and the second task as input to a machine learning model to generate a priority ranking of the first task and the second task based on an output of the machine learning model;
causing the user interface to present the first task and the second task to the user via the user device in accordance with the priority ranking;
receiving a user input associated with at least one of the first task or the second task from the user via the user device;
generating compliance documentation for the compliance inspection in a format such that the compliance documentation can be appropriately provided to an authority having jurisdiction over the compliance inspection to document compliance of the healthcare facility based on the retrieved first data, the retrieved second data, the retrieved third data, and the user input; and
causing the user interface to provide the compliance documentation for the compliance inspection to the user via the user device.

17.-20. (canceled)

21. The method of claim 16, wherein:
the compliance inspection comprises a Joint Commission survey, a state surveyor survey, an insurance broker survey, or a Centers for Medicare and Medicaid Services survey; and
generating the compliance documentation for the compliance inspection comprises populating a documentation template associated with the authority having jurisdiction over the compliance inspection using the retrieved first data, the retrieved second data, the retrieved third data, and the user input.

22. The method of claim 16, further comprising:
retrieving fourth data from a fourth source different from the first source, the second source, and the third source and associated with a fourth entity different from the first entity, the second entity, and the third entity, the retrieved fourth data comprising historical healthcare facility citation data associated with a fourth time period, wherein:
identifying the compliance gap for the healthcare facility comprises identifying the compliance gap for the healthcare facility by evaluating the retrieved fourth data using the compliance documentation logic; and
generating the compliance documentation for the compliance inspection comprises generating the compliance documentation for the compliance inspection based on the retrieved fourth data; and
retrieving fifth data comprising sensor data associated with equipment in the healthcare facility, wherein:
identifying the compliance gap for the healthcare facility comprises identifying the compliance gap for the healthcare facility by evaluating the retrieved fifth data using the compliance documentation logic; and
generating the compliance documentation for the compliance inspection comprises generating the compliance documentation for the compliance inspection based on the retrieved fifth data.

23. The method of claim 16, wherein:
the machine learning model comprises a probabilistic neural network; and
identifying the compliance gap for the healthcare facility by evaluating the retrieved first data, the retrieved second data, and the retrieved third data using the compliance documentation logic comprises identifying the compliance gap for the healthcare facility by evaluating the retrieved first data, the retrieved second data, and the retrieved third data using rules specific to the compliance inspection.

24. (canceled)

25. A system, comprising:
memory comprising machine-readable instructions; and
processing circuitry configured to execute the machine-readable instructions to:
cause a user interface to be presented to a user via a user device;
receive a request to perform a compliance inspection for a healthcare facility from the user via the user device;
retrieve first data for the compliance inspection from a first source associated with a first entity, the retrieved first data comprising work orders that were completed at the healthcare facility within a first time period;
retrieve second data for the compliance inspection from a second source different from the first source and associated with a second entity different from the first entity, the retrieved second data comprising maintenance requests that were submitted for the healthcare facility within a second time period;
retrieve third data for the compliance inspection from a third source different from the first source and the second source and associated with a third entity different from the first entity and the second entity, the retrieved third data comprising alerts generated by nurse call devices in the healthcare facility;
identify a compliance gap for the healthcare facility by evaluating the retrieved first data, the retrieved second data, and the retrieved third data using compliance documentation logic;
identify both a first task for completion and a second task for completion in order to address the compliance gap for the healthcare facility;
apply both the first task and the second task as input to a machine learning model to generate a priority ranking of the first task and the second task based on an output of the machine learning model;
cause the user interface to present the first task and the second task to the user via the user device in accordance with the priority ranking;
receive a user input associated with at least one of the first task or the second task from the user via the user device;
generate compliance documentation for the compliance inspection in a format such that the compliance documentation can be appropriately provided to an authority having jurisdiction over the compliance inspection to document compliance of the healthcare facility based on the retrieved first data, the retrieved second data, the retrieved third data, and the user input; and
cause the user interface to provide the compliance documentation for the compliance inspection to the user via the user device.
